(19) United States
(12) Patent Application Publication
(10) Pub. No.: US 2020/0086616 A1
(43) Pub. Date: Mar. 19, 2020

(54) MULTI-LAYERED FILM , METHOD FOR THE PRODUCTION AND USE THEREOF

(71) Applicant: BASF SE, Ludwigshafen am Rhein (DE)

(72) Inventors: Markus Meise, Ludwigshafen (DE); Yannick Fuchs, Ludwigshafen (DE); Helmut Witteler, Ludwigshafen (DE); Alejandra Garcia Marcos, Ludwigshafen (DE); Juergen Detering, Ludwigshafen (DE); Benjamin Schmidt-Hansberg, Ludwigshafen (DE)

(21) Appl. No.: 16/469,984

(22) PCT Filed: Dec. 15, 2017
(86) PCT No.: PCT/EP2017/083127

§ 371 Date: Jun. 14, 2019

(30) Foreign Application Priority Data
Dec. 16, 2016 (EP) 16204778.1
Sep. 6, 2017 (EP) 17189675.6

(51) Int. Cl. B32B 27/30; B32B 23/20; B32B 23/22; B32B 27/28

(52) U.S. Cl. CPC B32B 27/306; B32B 23/20; C11D 17/042; B32B 27/308; B32B 27/285; B32B 23/22

(57) ABSTRACT

Described herein is a multilayer film including at least one layer including a polymer composition obtainable by free-radical polymerization of a monomer composition including at least one monomer A) selected from α,β-ethylenically unsaturated mono- and dicarboxylic acids, salts of α,β-ethylenically unsaturated mono- and dicarboxylic acids, anhydrides of α,β-ethylenically unsaturated mono- and dicarboxylic acids and mixtures thereof, where the free-radical polymerization is effected in the presence of at least one polyether component. Also described herein is a process for producing the multilayer film, methods of using the multilayer film and a sheath or coating for a washing composition, cleaning composition or dishwashing composition portion including the multilayer film, and to washing compositions, cleaning compositions or dishwashing compositions including the multilayer film.

### FIELD OF INVENTION

The present invention relates to a multilayer film comprising at least one layer comprising or consisting of a polymer composition obtainable by free-radical polymerization of a monomer composition comprising at least one monomer A) selected from α,β-ethylenically unsaturated mono- and dicarboxylic acids, salts of α,β-ethylenically unsaturated mono- and dicarboxylic acids, anhydrides of α,β-ethylenically unsaturated mono- and dicarboxylic acids and mixtures thereof, wherein the free-radical polymerization is effected in the presence of at least one polyether component. The invention further relates to a process for producing such a multilayer film, to various uses of such a multilayer film and specifically to a sheath or coating for a washing composition, cleaning composition or dishwashing detergent portion comprising or consisting of such a multilayer film, and to washing compositions, cleaning compositions or dishwashing compositions comprising such a multilayer film.

### BACKGROUND

It is known that water-soluble films of polyvinyl alcohol can be used for packaging of washing and cleaning compositions in liquid, gel and solid form as portions. The polyvinyl alcohol film dissolves at the start of the washing and cleaning process and releases the washing and cleaning compositions, and so they are able to display their effect. The advantages of the washing and cleaning compositions packaged as portions (called single dose units or mono dose units) for the consumer are manifold. These include the avoidance of incorrect dosages, ease of handling, and the fact that the consumer does not come into physical contact with the constituents of the washing and cleaning compositions. These additionally also include aesthetic aspects which lead to a preference for the washing and cleaning compositions packaged as portions. Current dosage forms can comprise a large number of separately formulated active ingredients and auxiliaries which are released individually in the cleaning process. Such multichamber systems permit, for example, the separation of incompatible constituents and hence the creation of new formulation concepts. The proportion of the polyvinyl alcohol film in the total weight of the washing or cleaning composition portion (single dose unit) is between 2% and 20% by weight, according to the application.

One disadvantage of the polyvinyl alcohol films is that they merely serve as packaging material and make no contribution at all to the washing and cleaning performance. There is quite generally a need for polymer films which do not just release particular constituents but themselves make an active contribution. Specifically, there is a need for washing- and cleaning-active polymer films.

Lev Bromberg describes, in the Journal of Physical Chemistry B (1998), 102, 11, 1956-1963, a material with thermoreversible gel formation, the production of which involves polymerizing acrylic acid in the presence of a PEO-PPO-PEO block copolymer. The reaction proceeds in the absence of external solvents in order to achieve a high proportion of branching and crosslinking in the resultant products. These are neither water-soluble nor transparent. Possible fields of use mentioned for these polymers are only very generally pharmacy and food supplements (p. 1956, left-hand column, “Introduction”).

Lev Bromberg describes, in Ind. Eng. Chem. Res. 1998, 37, 4267-4274, polyether-modified polyacrylic acids, specifically by polymerization of partly neutralized acrylic acid in the presence of a PEO-PPO-PEO block copolymer.

WO 2005/012378 describes aqueous dispersions of water-soluble polymers of anionic monomers and the use thereof as thickeners for aqueous systems. For preparation thereof, anionic monomers are polymerized in the presence of two water-soluble polymers from different classes, which can also include polyalkylene glycols. Example 4 (page 19, lines 14-27) relates to the polymerization of acrylic acid in the presence of two different polypropylene glycols and of maltodextrin. The dispersions are used inter alia in personal care products, and in washing and cleaning compositions. There is no description of use in the form of films.

WO 2015/000969 describes the use of a polymer composition in gel form, obtainable by a process in which
a) a monomer composition M1) is provided, consisting of
   A) at least one α,β-ethylenically unsaturated acid and
   B) 0% to 0.1% by weight, based on the total weight of the monomer composition M1), of crosslinking monomers having two or more than two polymerizable α,β-ethylenically unsaturated double bonds per molecule,
b) the monomer composition M1) provided in step a) is subjected to a free-radical polymerization in the presence of at least one polyether component PE) selected from polyetherols having a number-average molecular weight of at least 200 g/mol and the mono- and di(C₁-C₆-alkyl) ethers thereof, surfactants containing polyether groups, and mixtures thereof, in formulations for machine dishwashing. Again, there is no description of use in the form of films.

WO 2015/000971 describes the use of a polymer composition in gel form as described in WO 2015/000969 for further uses, but not in the form of films.

WO 2015/000970 describes a process for producing a solid polymer composition, especially in the form of a film or in the form of a solid coating on a substrate or in particle form, in which
a) a monomer composition M1) is provided, comprising
   A) at least one α,β-ethylenically unsaturated carboxylic acid, and
   B) less than 0.1% by weight, based on the total weight of the monomer composition M1), of crosslinking monomers having two or more than two polymerizable α,β-ethylenically unsaturated double bonds per molecule, and
b) the monomer composition M1) provided in step a) is subjected to a free-radical polymerization in the presence of at least one polyether component PE) selected from polyetherols having a number-average molecular weight of at least 200 g/mol and the mono- and di(C₁-C₆-alkyl) ethers thereof, surfactants containing polyether groups, and mixtures thereof.

WO 01/00781 describes an active ingredient portion pack comprising at least one washing-, cleaning- or dishwashing-active preparation and an envelope fully or partly enveloping the washing-, cleaning- or dishwashing-active preparation, in which the envelope is soluble under washing, cleaning or dishwashing conditions and comprises at least one individual component of the washing-, cleaning- or dishwashing-active preparation in bound form. It is not stated that the material of the envelope itself actively participates in the washing or cleaning operation.

Unpublished European patent application 16160745.2 relates to a monolaminar washing- and cleaning-active polymer film, comprising or consisting of a polymer composition P1) obtainable by free-radical polymerization of a monomer composition M1) comprising at least one monomer A) selected from α,β-ethylenically unsaturated carboxylic acids, salts of α,β-ethylenically unsaturated carboxylic acids and mixtures thereof, in the presence of at least one (C₈-C₁₈-alkyl)polyoxyalkylene ether having an average of 3 to 12 alkylene oxide units per molecule. Also described are a process for producing such a washing- and cleaning-active polymer film, the use of such a polymer film and a sheath or coating for a washing or cleaning composition portion comprising or consisting of such a polymer film. There is no description of multilaminar polymer films.

US 2011/0301070 describes a water-soluble strip comprising a carrier in film form, at least one active ingredient and at least one agent selected from heat-generating agents and breakdown accelerators. The carrier in film form comprises a water-soluble polymer which makes the carrier capable of dissolving in water and in so doing releasing the active ingredient(s). The active ingredients and agents may be applied to or incorporated into the carrier in film form. Suitable water-soluble polymers mentioned are a multitude of different acrylate polymers, polyvinyl alcohols and polysaccharides. The water-soluble strip may be fully or partly provided with a removable protective coating in order to protect it from oxygen and/or water prior to use thereof.

EP 0 957 158 A1 describes a sheetlike article for washing, comprising a thin layer of a phosphate-free, surfactant-containing detergent composition having water-soluble sheets on both surfaces. The water-soluble sheets may comprise water-soluble films or textiles composed of water-soluble polymer fibers. Suitable water-soluble polymers mentioned include polyvinyl alcohols, polyvinylpyrrolidones, pullulan, polyacrylamides, poly(meth)acrylic acids, polyethylene oxides, carboxymethyl cellulose and hydroxyalkyl celluloses.

It is known that multilayer films having a layer construction composed of at least two film laminas can be provided.

WO 2010/069553 describes a multilayer film comprising an at least flushable thermoplastic layer construction composed of
A) at least one layer which can at least be broken up by the action of water and is resistant to cold water or can be dissolved relatively slowly therein, based on at least one at least partly hydrolyzed polyvinyl acetate, and
B) at least one cold water-soluble layer based on at least one at least partly hydrolyzed polyvinyl acetate and at least one water solubility-enhancing substance selected from the group comprising biodegradable polymers, surfactants, inorganic pigments and fillers.

A flushable layer construction is understood to mean that resulting packages do not cause blockages in drains in the event of flushing with water, for example a toilet flush. They serve as protective packaging for a wide variety of different goods, such as washing compositions or dishwashing compositions packaged in individual portions (for example in the form of tabs), and for hygiene articles such as tampons or sanitary napkins which are used together with the flushable packaging. After the removal of the packaging for use of these articles, the packaging can be disposed of by simply flushing it away with the aid of a toilet flush.

U.S. Pat. No. 7,727,946 describes a process for producing functionalized films for cleaning products, wherein a water-soluble film bears a coating of a composition that exerts a particular function. For this purpose, an aqueous solution of a functional material is applied stepwise on at least one side of the water-soluble film, in order to produce a multilayer coating on the film. For this purpose, each layer applied is allowed to at least partly dry before the next layer is applied. Each layer may comprise different functional materials with cleaning properties, barrier properties and/or solubility-modifying properties. In addition, the aqueous solution comprises an agent that temporarily reduces the solubility of the water-soluble film, such that it is wetted but does not dissolve or swell. The individual layers are preferably applied by a printing method such as flexographic printing. Suitable film-forming polymers mentioned are polyvinyl alcohols, polyvinylpyrrolidones, polyalkylene oxides, polyacrylamides, polyacrylic acids, cellulose, cellulose ethers, cellulose esters, cellulose amides, polyvinyl acetates, polycarboxylic acids and salts thereof, polyamino acids, polyamides, polyacrylamides, maleic/acrylic acid copolymers, polysaccharides and mixtures thereof. Particular preference is given to using polyvinyl alcohol films commercially available under the Monosol M8630 name. Agents used that temporarily reduce the solubility of the water-soluble film are salts such as sodium sulfate, sodium citrate, etc. There is no description of application of the functional materials together with film-forming polymers. What is described, however, is application of a further film-forming polymer, for example a polyvinyl alcohol, after the application of the last layer of the functional materials.

It is an object of the present invention to provide a multilayer film having at least one functional layer, especially at least one layer having dispersing, film-inhibiting, emulsifying and/or surfactant properties. This functional layer should simultaneously be water-soluble. The other layers should stabilize this functional layer and/or have functional properties of their own. For applications in which the water solubility of the multilayer film is of critical importance, it should be water-soluble under the use conditions intended.

For use in washing, cleaning and dishwashing applications, the multilayer film should have at least one of the following properties:
At least one layer of the multilayer film is to include a film-forming polymer composition which has dispersing, film-inhibiting, emulsifying and/or surfactant properties and hence contributes to the washing and cleaning performance.
Said layer is to be compatible with a maximum number of different constituents of washing, cleaning and dishwashing compositions.
Said layer is to be suitable for production of storage-stable formulations. The multilayer film is to have adequate stability both with respect to external effects, for example air or air humidity, and with respect to internal effects, for example the embedded or ensheathed constituents. Furthermore, the constituents embedded into the multilayer film and/or ensheathed by the multilayer film are also to be stabilized against any loss of their properties.
It is to be possible for at least one layer of the multilayer film to comprise at least one constituent which is released in the course of the washing, cleaning or dishwashing operation. This constituent preferably comprises water-soluble or water-dispersible constituents. This release is preferably to be effected in a controlled manner and especially in a particular phase of the washing or cleaning operation.
The multilayer film of the invention is also to be suitable as a sheath or part of the sheath of a washing composition portion, cleaning composition portion or dishwashing composition portion. It is to be possible for the ensheathed constituents to be released in the washing, cleaning or dishwashing operation. This release is preferably also to be effected in a controlled manner and especially in a particular phase of the washing or cleaning operation.
The multilayer films are to be suitable for production of a multitude of different formulations. It is firstly to be possible for the multilayer films as such already to constitute the end product. In addition, it is to be possible for the multilayer film to be an integral constituent of a complex formulation. This may comprise, for example, bags such as pouches (liquid tabs) or compressed shaped bodies such as tablets (“tabs”), blocks, briquettes, or multichamber systems, etc.

It has now been found that, surprisingly, it is possible to provide multilayer films having advantageous physicochemical properties and/or having use properties tailored to the respective end use when they comprise at least one layer comprising or consisting of a polymer composition obtainable by free-radical polymerization of a monomer composition comprising at least one monomer selected from α,β-ethylenically unsaturated mono- and dicarboxylic acids, salts of α,β-ethylenically unsaturated mono- and dicarboxylic acids, anhydrides of α,β-ethylenically unsaturated mono- and dicarboxylic acids and mixtures thereof, wherein the free-radical polymerization is effected in the presence of at least one polyether component.

### SUMMARY OF THE INVENTION

The invention firstly provides a multilayer film comprising at least one layer comprising or consisting of a polymer composition P1) obtainable by free-radical polymerization of a monomer composition M1) comprising at least one monomer A) selected from α,β-ethylenically unsaturated mono- and dicarboxylic acids, salts of α,β-ethylenically unsaturated mono- and dicarboxylic acids, anhydrides of α,β-ethylenically unsaturated mono- and dicarboxylic acids and mixtures thereof, in the presence of at least one polyether component PE) selected from polyetherols having a number-average molecular weight of at least 200 g/mol, mono- and di(C₁-C₆-alkyl) ethers of such polyetherols, surfactants containing polyether groups, and mixtures thereof.

In a preferred embodiment, the multilayer film is produced by a process in which at least one free-flowing composition capable of film formation is applied to a carrier material, wherein the carrier material and/or the at least one free-flowing composition comprises or consists of a polymer composition P1) as defined above and hereinafter.

The invention further provides a process for producing a multilayer film as defined above and hereinafter, in which
a1) a first free-flowing composition capable of film formation is applied to a carrier material to obtain a first layer,
a2) the first layer applied to the carrier material is optionally subjected to an increase in viscosity,
a3) a second free-flowing composition capable of film formation is applied to the first layer obtained in step a1) or in step a2) to obtain a second layer,
a4) the second layer is optionally subjected to an increase in viscosity,
a5) step a3) is optionally repeated with a further composition capable of film formation to obtain a further layer and step a4) is optionally then repeated, it being possible to repeat steps a3) and a4) once or more than once,
a6) the layers applied to the carrier material are optionally subjected to a further increase in viscosity,
a7) the multilayer film obtained is optionally detached from the carrier material,

with the proviso that the free-flowing compositions each comprise a component which is capable of film formation and is independently selected from at least one polymer composition P1), at least one polymer P2) or a mixture thereof, and with the proviso that at least one of the free-flowing compositions and/or the carrier material comprises or consists of a polymer composition P1) as defined above and hereinafter.

The multilayer film can also be produced by a lamination method. Laminating involves bonding two or more layers of the multilayer film to one another over their area. If the multilayer film is produced exclusively by lamination, all layers of the multilayer film are bonded to one another over their area. The lamination can be effected successively (layer by layer), or laminates already consisting of two or more layers are bonded to one another.

The multilayer film can also be produced by a wet-on-wet application method. In addition, the multilayer film can be produced using combinations of the aforementioned production methods.

A polymer composition P1) as defined above and hereinafter is preferably produced by
A) providing a monomer composition M1) comprising at least one monomer A) selected from α,β-ethylenically unsaturated mono- and dicarboxylic acids, salts of α,β-ethylenically unsaturated mono- and dicarboxylic acids, anhydrides of α,β-ethylenically unsaturated mono- and dicarboxylic acids and mixtures thereof,
B) subjecting the monomer composition M1) provided in step A) to a free-radical polymerization in the presence of at least one polyether component PE) selected from polyetherols having a number-average molecular weight of at least 200 g/mol, mono- and di(C₁-C₆-alkyl) ethers thereof, surfactants containing polyether groups and mixtures thereof, optionally in the presence of at least one additive.

If the polymer composition obtained in step B) comprises anhydride functions, these can if desired be subjected to a partial or complete hydrolysis, and/or, if the polymer composition obtained in step B) comprises acid functions, these can if desired be subjected to partial or complete neutralization.

The invention further provides for the use of a multilayer film as defined above and hereinafter or obtainable by a process as defined above and hereinafter as a washing and cleaning composition,
for at least partial coating or ensheathing of washing and cleaning compositions,
as a dishwashing detergent or as a rinse aid,
for at least partial coating or ensheathing of dishwashing detergents or for at least partial coating or ensheathing of rinse aids,
as hygiene products,
for at least partial coating or ensheathing of hygiene products,
as disinfectants,
for at least partial coating or ensheathing of disinfectants,
for at least partial coating or ensheathing of personal care compositions,
for at least partial coating or ensheathing of personal cleansing compositions,
for at least partial coating or ensheathing of cosmetic compositions,
as pharmaceutical compositions,
for at least partial coating or ensheathing of pharmaceutical compositions,
as crop protection compositions,
for at least partial coating or ensheathing of crop protection compositions,
in bait traps,
for at least partial coating or ensheathing of bait traps,
as food or animal feed packaging,
as wetting agents,
for at least partial coating or ensheathing of wetting agents,
as packaging for textiles,
as lamination films,
in composite systems (laminates) such as composite glass.

A specific embodiment of the invention is the use of a multilayer film as defined above and hereinafter, or obtainable by a process as defined above and hereinafter, as washing composition or as cleaning composition or as dishwashing composition.

A further specific embodiment of the invention is the use of a multilayer film as defined above and hereinafter, or obtainable by a process as defined above and hereinafter, for at least partial ensheathing of a liquid or solid washing, cleaning or dishwashing composition.

The invention further provides a sheath or coating for a washing composition portion, cleaning composition portion or dishwashing composition portion, comprising or consisting of a multilayer film as defined above and hereinafter, or obtainable by a process as defined above and hereinafter.

The invention further provides a washing or cleaning composition comprising:
A) at least one sheath and/or coating comprising or consisting of a multilayer film as defined above and hereinafter or obtainable by a process as defined above and hereinafter,
B) at least one surfactant,
C) optionally at least one builder,
D) optionally at least one bleach system,
E) optionally at least one further additive, preferably selected from enzymes, enzyme stabilizers, bases, corrosion inhibitors, defoamers and foam inhibitors, dyes, fragrances, fillers, tableting aids, disintegrants, thickeners, solubilizers, organic solvents, electrolytes, pH modifiers, perfume carriers, bitter substances, fluorescers, hydrotropes, antiredeposition agents, optical brighteners, graying inhibitors, antishrink agents, anticrease agents, dye transfer inhibitors, antimicrobial active ingredients, antioxidants, anti-yellowing agents, corrosion inhibitors, antistats, ironing aids, hydrophobizing and impregnating agents, antiswell and antislip agents and UV absorbers, and
F) optionally water.

The invention further provides a dishwashing composition comprising:
Ga) at least one sheath and/or coating comprising or consisting of a multilayer film of the invention,
Gb) optionally at least one complexing agent,
Gc) at least one builder and/or cobuilder,
Gd) at least one nonionic surfactant,
Ge) optionally at least one component selected from bleaches, bleach activators and bleach catalysts,
Gf) optionally at least one enzyme,
Gg) optionally at least one further additive, preferably selected from anionic or zwitterionic surfactants, alkali carriers, polymeric dispersants, corrosion inhibitors, defoamers and foam inhibitors, dyes, fragrances, bitter substances, fillers, tablet disintegrants, organic solvents, tableting aids, disintegrants, thickeners and solubilizers,
Gh) optionally water.

### DETAILED DESCRIPTION OF THE INVENTION

A “multilayer film” in the context of the invention is understood to mean a film composite where at least two films are permanently and fully bonded over a significant portion of their area. This is understood to mean that at least two films are permanently and fully bonded over at least 50% of their area. When two films of different size are bonded to one another, at least the film having the smaller area is permanently and fully bonded over at least 50% of its area. Thus, the multilayer films of the invention differ from known films for washing and cleaning composition portions where an individual film or 2 or more films are joined to one another by at least one weld seam. The latter films are permanently and fully bonded to one another over at most 10% of their area.

The term “multilayer film” in the context of the present invention refers to a self-supporting flat structure having at least two film layers. The maximum thickness of the multilayer films of the invention is preferably at most 30 mm, more preferably at most 20 mm, especially at most 15 mm. It will be apparent that the maximum thickness of the multilayer films of the invention depends on their field of use. Multilayer films for ensheathing or coating for a washing composition portion, cleaning composition portion or dishwashing composition portion preferably have a thickness of not more than 1500 μm, more preferably not more than 1000 μm. Multilayer films which themselves serve as washing compositions or as cleaning compositions or as dishwashing compositions preferably have a thickness of not more than 30 mm, more preferably not more than 20 mm.

Moreover, the thickness of the multilayer films of the invention is small in relation to the length and width. Preferably, the thickness of the multilayer films is smaller by a factor of at least 2, more preferably of at least 5 and especially of at least 10 than the length of the greatest longitudinal axis. In a specific embodiment, the thickness of the multilayer films is smaller by a factor of at least 20, more specifically at least 50, even more specifically at least 100 and very specifically at least 500 than the length of the greatest longitudinal axis. In principle, the upper value for the greatest longitudinal extent of the multilayer films of the invention is uncritical. The multilayer films of the invention can be produced, for example, in the form of film rolls, where the greatest length may even be in the region of 100 m or higher.

The multilayer films of the invention have an essentially two-dimensional extent. The length and/or width of the film is generally at least 5 mm and preferably at least 10 mm. The maximum length and/or width of the film is generally uncritical and may be in the millimeter, centimeter or meter range according to the field of application.

The multilayer films of the invention and those produced by the process of the invention are suitable as such for use as washing, cleaning and dishwashing compositions. For this purpose, individual components of a washing, cleaning or dishwashing composition or else a complete washing, cleaning or dishwashing composition may be formulated in the form of a multilayer film. A washing, cleaning or dishwashing composition in the form of a multilayer film dissolves at the start and/or in the course of the respective use (for example in the washing or rinse water), thus releases the constituents of the washing, cleaning and dishwashing composition and, in dissolved form, because of the dispersing, film-inhibiting, emulsifying and surfactant properties of the polymer composition P1) present and of any further active layers, contributes considerably to the washing and cleaning performance.

The multilayer films of the invention or those produced by the process of the invention are also suitable for packaging of washing, cleaning and dishwashing compositions in liquid, gel and solid form as portions. They dissolve at the start and/or in the course of the respective use (for example in the washing or rinse water), thus release the constituents of the washing, cleaning and dishwashing composition and, in dissolved form, because of the polymer composition P1) present and any further active layers, contribute considerably to the washing and cleaning performance. In the field of washing and cleaning compositions, the multilayer films serve to achieve dispersing, film-inhibiting, emulsifying and surfactant properties. In the field of dishwashing compositions and especially of automatic dishwashing (ADW), the multilayer films additionally serve to improve the rinse aid performance and the drying process.

In the context of the present invention, the terms “washing composition portion”, “cleaning composition portion” and “dishwashing composition portion” are understood to mean an amount of a washing composition or cleaning composition or dishwashing composition sufficient for a washing, cleaning or dishwashing operation that takes place in an aqueous phase. This may, for example, be a machine washing operation as conducted with commercial washing machines. This may, for example, also be a machine dishwashing operation as conducted with commercial machine dishwashers and referred to as “automatic dishwashing” (ADW). According to the invention, this term is also understood to mean an active ingredient portion for a manual washing operation or a manually conducted cleaning or dishwashing operation (as conducted, for example, in a handwash basin, a sink or a bowl). The multilayer films of the invention are preferably used for production of active ingredient portions for machine washing, cleaning or dishwashing operations.

In the context of this application, some compounds which can be derived either from acrylic acid or from methacrylic acid or from mixtures of the two are referred to by insertion of the “(meth)” syllable into the compound derived from acrylic acid.

The organic radicals of the variables mentioned above and below constitute an individual enumeration of individual group members. The prefix Cₙ-Cₘ denotes the possible number of carbon atoms in the respective group.

If the term “alkyl” is used without a prefix (Cₙ-Cₘ), it represents a linear or (over and above 3 carbon atoms) branched saturated aliphatic radical having generally 1 to 40 carbon atoms (“C₁-C₄₀-alkyl”), preferably 1 to 30 carbon atoms (“C₁-C₃₀-alkyl”).

In the context of the present invention, C₁-C₄-alkyl is a linear or branched alkyl radical having 1 to 4 carbon atoms. Examples of C₁-C₄-alkyls are methyl, ethyl, n-propyl, isopropyl, n-butyl, sec-butyl, isobutyl and tert-butyl.

C₁-C₇-alkyl is a linear or branched alkyl radical having 1 to 7 carbon atoms. Examples of C₁-C₇-alkyl are, in addition to those mentioned for C₁-C₄-alkyl, pentyl, 1-methylbutyl, 2-methylbutyl, 3-methylbutyl, 2,2-dimethylpropyl, 1-ethylpropyl, 1,1-dimethylpropyl, 1,2-dimethylpropyl, hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, heptyl and the constitutional isomers thereof.

C₁-C₈-alkyl is a linear or branched alkyl radical having 1 to 8 carbon atoms. Examples of C₁-C₈-alkyl are, in addition to those mentioned for C₁-C₇-alkyl, octyl, 2-ethylhexyl and the constitutional isomers thereof.

C₁-C₁₀-alkyl is a linear or branched alkyl radical having 1 to 10 carbon atoms. Examples of C₁-C₁₀-alkyl are, in addition to those mentioned for C₁-C₈-alkyl, nonyl, decyl, 2-propylheptyl and the constitutional isomers thereof.

C₁-C₂₀-alkyl is a linear or branched alkyl radical having 1 to 20 carbon atoms. Examples of C₁-C₂₀-alkyl are, in addition to those mentioned for C₁-C₁₀-alkyl, undecyl, dodecyl, tridecyl, tetradecyl, pentadecyl, hexadecyl, heptadecyl, octadecyl, nonadecyl, eicosyl and the constitutional isomers thereof.

C₁-C₃₀-alkyl is a linear or branched alkyl radical having 1 to 30 carbon atoms. Examples of C₁-C₃₀-alkyl are, in addition to those mentioned for C₁-C₂₀-alkyl, heneicosyl, docosyl, tricosyl, tetracosyl, pentacosyl, hexacosyl, heptacosyl, octacosyl, nonacosyl, triacontyl and the constitutional isomers thereof.

C₁-C₄₀-alkyl is a linear or branched alkyl radical having 1 to 40 carbon atoms. Examples of C₁-C₄₀-alkyl are, in addition to those mentioned for C₁-C₃₀-alkyl, the higher homologs having 31 to 40 carbon atoms. Examples of C₈-C₂₂-alkyl are octyl, 2-ethylhexyl and the constitutional isomers thereof.

C₈-C₁₈-alkyl is a linear or branched alkyl radical having 8 to 18 carbon atoms. Suitable C₈-C₁₈-alkyls are octyl, 2-ethylhexyl, nonyl, decyl, 2-propylheptyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl and the constitutional isomers thereof. In a preferred embodiment, they are predominantly linear C₈-C₁₈-alkyl radicals, as also occur in natural or synthetic fatty alcohols, and oxo process alcohols.

C₁₂-C₁₈-alkyl is a linear or branched alkyl radical having 12 to 18 carbon atoms. Suitable C₁₂-C₁₈-alkyls are dodecyl, tridecyl, tetradecyl, pentadecyl, hexadecyl, heptadecyl, octadecyl, nonadecyl, eicosyl, heneicosyl, docosyl, tricosyl, tetracosyl and the constitutional isomers thereof. In a preferred embodiment, they are predominantly linear C₁₂-C₁₈-alkyl radicals, as also occur in natural or synthetic fatty alcohols, and oxo process alcohols.

In the context of the present application, the expression C₉-C₁₁ alcohols represents a mixture comprising alcohols having 9 carbon atoms and alcohols having 11 carbon atoms. C₁₂-C₁₄ alcohols are a mixture comprising alcohols having 12 carbon atoms and alcohols having 14 carbon atoms. C₁₃-C₁₅ alcohols are a mixture comprising alcohols having 13 carbon atoms and alcohols having 15 carbon atoms. C₁₂-C₁₈ alcohols are a mixture comprising alcohols having 12 carbon atoms, alcohols having 14 carbon atoms, alcohols having 16 carbon atoms and alcohols having 18 carbon atoms.

If the term “alkenyl” is used without a prefix (Cₙ-Cₘ), it represents a linear or branched monounsaturated (i.e. comprising one C—C double bond) aliphatic radical having generally 2 to 40 carbon atoms (“C₂-C₄₀-alkenyl”), preferably 2 to 30 carbon atoms (“C₂-C₃₀-alkenyl”).

Examples of C₂-C₃-alkenyl are ethenyl, 1-propenyl, 2-propenyl or 1-methylethenyl. Examples of C₂-C₄-alkenyl are, in addition to those mentioned for C₂-C₃-alkenyl, 1-butenyl, 2-butenyl, 3-butenyl, 1-methyl-1-propenyl, 2-methyl-1-propenyl, 1-methyl-2-propenyl or 2-methyl-2-propenyl. Examples of C₂-C₆-alkenyl are, in addition to those mentioned for C₂-C₄-alkenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, 1-ethyl-2-methyl-2-propenyl and the like. Examples of C₂-C₁₀-alkenyl are, in addition to those mentioned for C₂-C₆-alkenyl, 1-heptenyl, 2-heptenyl, 3-heptenyl, 1-octenyl, 2-octenyl, 3-octenyl, 4-octenyl, 1-nonenyl, 2-nonenyl, 3-nonenyl, 4-nonenyl, 1-decenyl, 2-decenyl, 3-decenyl, 4-decenyl, 5-decenyl and the like.

If the term “cycloalkyl” is used without a prefix (Cₙ-Cₘ), it represents a saturated monocyclic cycloaliphatic radical having generally 3 to 10 carbon atoms (“C₃-C₁₀-cycloalkyl”), preferably 3 to 8 carbon atoms (“C₃-C₈-cycloalkyl”), and of course does not have any heteroatoms as ring members (i.e. all ring members are carbon atoms).

Examples of C₃-C₄-cycloalkyl are cyclopropyl and cyclobutyl. Examples of C₃-C₅-cycloalkyl are cyclopropyl, cyclobutyl and cyclopentyl. Examples of C₃-C₆-cycloalkyl are cyclopropyl, cyclobutyl, cyclopentyl and cyclohexyl. Examples of C₃-C₇-cycloalkyl are cyclopropyl, cyclobutyl, cyclopentyl, cyclohexyl and cycloheptyl. Examples of C₃-C₈-cycloalkyl are cyclopropyl, cyclobutyl, cyclopentyl, cyclohexyl, cycloheptyl and cyclooctyl. Examples of C₃-C₁₀-cycloalkyl are cyclopropyl, cyclobutyl, cyclopentyl, cyclohexyl, cycloheptyl, cyclooctyl, cyclononyl and cyclodecyl.

“Aryl” is a mono-, bi- or polycyclic carbocyclic aromatic radical without heteroatoms as ring members. A monocyclic aromatic radical is phenyl. In bicyclic aryl radicals, two aromatic rings are fused to one another; in other words, they share two adjacent carbon atoms as ring members. Examples of bicyclic aryl groups are 1- and 2-naphthyl. In polycyclic aryl groups, three or more rings are fused. Examples of polycyclic aryl groups are phenanthrenyl, anthracenyl, tetracenyl, 1H-benzo[a]phenalenyl, pyrenyl and the like. In the context of the present application, the term “aryl” also encompasses bi- or polycyclic radicals in which not all rings are aromatic; it is a prerequisite that at least one ring is aromatic. Examples of these are indanyl, indenyl, tetralinyl, 6,7,8,9-tetra-hydro-5H-benzo[7]annulenyl, fluorenyl, 9,10-dihydroanthracenyl, 9,10-dihydro-phenanthrenyl, 1H-benzo[a]phenalenyl and the like. The aryl group has generally 6 to 30, especially 6 to 20 and specifically 6 to 10 carbon atoms as ring members.

If the term “heterocycloalkyl” is used without a prefix (Cₙ-Cₘ) and without specification of the ring heteroatoms, it represents a saturated monocyclic heterocyclic radical having generally 3 to 8 ring members and at least one heteroatom and/or heteroatom-containing group, preferably 1, 2, 3 or 4 heteroatoms and/or heteroatom-containing groups, as ring members. The heteroatom and the heteroatom-containing group are selected from N, O, S, NO, SO and SO₂.

Examples of these are oxiran-2-yl, thiiran-2-yl, aziridin-1-yl, aziridin-2-yl, oxetan-2-yl, oxetan-3-yl, thietan-2-yl, thietan-3-yl, 1-oxothietan-2-yl, 1-oxothietan-3-yl, 1,1-dioxothietan-2-yl, 1,1-dioxothietan-3-yl, azetidin-1-yl, azetidin-2-yl, azetidin-3-yl, tetrahydrofuran-2-yl, tetrahydrofuran-3-yl, tetrahydrothien-2-yl, tetrahydrothien-3-yl, 1-oxotetrahydrothien-2-yl, 1,1-dioxotetrahydrothien-2-yl, 1-oxotetrahydrothien-3-yl, 1,1-dioxotetrahydrothien-3-yl, pyrrolidin-1-yl, pyrrolidin-2-yl, pyrrolidin-3-yl, pyrazolidin-1-yl, pyrazolidin-3-yl, pyrazolidin-4-yl, pyrazolidin-5-yl, imidazolidin-1-yl, imidazolidin-2-yl, imidazolidin-4-yl, oxazolidin-2-yl, oxazolidin-3-yl, oxazolidin-4-yl, oxazolidin-5-yl, isoxazolidin-2-yl, isoxazolidin-3-yl, isoxazolidin-4-yl, isoxazolidin-5-yl, thiazolidin-2-yl, thiazolidin-3-yl, thiazolidin-4-yl, thiazolidin-5-yl, isothiazolidin-2-yl, isothiazolidin-3-yl, isothiazolidin-4-yl, isothiazolidin-5-yl, 1,2,4-oxadiazolidin-2-yl, 1,2,4-oxadiazolidin-3-yl, 1,2,4-oxadiazolidin-4-yl, 1,2,4-oxadiazolidin-5-yl, 1,2,4-thiadiazolidin-2-yl, 1,2,4-thiadiazolidin-3-yl, 1,2,4-thiadiazolidin-4-yl, 1,2,4-thiadiazolidin-5-yl, 1,2,4-triazolidin-1-yl, 1,2,4-triazolidin-3-yl, 1,2,4-triazolidin-4-yl, 1,3,4-oxadiazolidin-2-yl, 1,3,4-oxadiazolidin-3-yl, 1,3,4-thiadiazolidin-2-yl, 1,3,4-thiadiazolidin-3-yl, 1,3,4-triazolidin-1-yl, 1,3,4-triazolidin-2-yl, 1,3,4-triazolidin-3-yl, tetrahydropyran-2-yl, tetrahydropyran-3-yl, tetrahydropyran-4-yl, 1,3-dioxan-2-yl, 1,3-dioxan-4-yl, 1,3-dioxan-5-yl, 1,4-dioxan-2-yl, piperidin-1-yl, piperidin-2-yl, piperidin-3-yl, piperidin-4-yl, hexahydropyridazin-1-yl, hexahydropyridazin-3-yl, hexahydropyridazin-4-yl, hexahydropyrimidin-1-yl, hexahydropyrimidin-2-yl, hexahydropyrimidin-4-yl, hexahydropyrimidin-5-yl, piperazin-1-yl, piperazin-2-yl, 1,3,5-hexahydrotriazin-1-yl, 1,3,5-hexahydrotriazin-2-yl, 1,2,4-hexahydrotriazin-1-yl, 1,2,4-hexahydrotriazin-2-yl, 1,2,4-hexahydrotriazin-3-yl, 1,2,4-hexahydrotriazin-4-yl, 1,2,4-hexahydrotriazin-5-yl, 1,2,4-hexahydrotriazin-6-yl, morpholin-2-yl, morpholin-3-yl, morpholin-4-yl, thiomorpholin-2-yl, thiomorpholin-3-yl, thiomorpholin-4-yl, 1-oxothiomorpholin-2-yl, 1-oxothiomorpholin-3-yl, 1-oxothio-morpholin-4-yl, 1,1-dioxothiomorpholin-2-yl, 1,1-dioxothiomorpholin-3-yl, 1,1-dioxothiomorpholin-4-yl, azepan-1-, -2-, -3- or -4-yl, oxepan-2-, -3-, -4- or -5-yl, hexahydro-1,3-diazepinyl, hexahydro-1,4-diazepinyl, hexahydro-1,3-oxazepinyl, hexahydro-1,4-oxazepinyl, hexahydro-1,3-dioxepinyl, hexahydro-1,4-dioxepinyl, oxocanyl, thiocanyl, azocanyl, [1,3]diazocanyl, [1,4]diazocanyl, [1,5]diazocanyl, [1,5]oxazocanyl and the like.

If the term “heteroaryl” or “hetaryl” is used without a prefix (Cₙ-Cₘ) and without specification of the ring heteroatoms, it represents an aromatic monocyclic heterocyclic radical having 5 or 6 ring members and at least one heteroatom and/or heteroatom-containing group, preferably 1, 2, 3 or 4 heteroatoms and/or heteroatom-containing groups, as ring members. The heteroatom and the heteroatom-containing group are selected from N, O, S, NO, SO and SO₂.

Examples of these are 2-furyl, 3-furyl, 2-thienyl, 3-thienyl, 1-pyrrolyl, 2-pyrrolyl, 3-pyrrolyl, 1-pyrazolyl, 3-pyrazolyl, 4-pyrazolyl, 5-pyrazolyl, 1-imidazolyl, 2-imidazolyl, 4-imidazolyl, 5-imidazolyl, 2-oxazolyl, 4-oxazolyl, 5-oxazolyl, 3-isoxazolyl, 4-isoxazolyl, 5-isoxazolyl, 2-thiazolyl, 4-thiazolyl, 5-thiazolyl, 3-isothiazolyl, 4-isothiazolyl, 5-isothiazolyl, 1,3,4-triazol-1-yl, 1,3,4-triazol-2-yl, 1,3,4-triazol-3-yl, 1,2,3-triazol-1-yl, 1,2,3-triazol-2-yl, 1,2,3-triazol-4-yl, 1,2,5-oxadiazol-3-yl, 1,2,3-oxadiazol-4-yl, 1,2,3-oxadiazol-5-yl, 1,3,4-oxadiazol-2-yl, 1,2,5-thiadiazol-3-yl, 1,2,3-thiadiazol-4-yl, 1,2,3-thiadiazol-5-yl, 1,3,4-thiadiazol-2-yl, 2-pyridinyl, 3-pyridinyl, 4-pyridinyl, 1-oxopyridin-2-yl, 1-oxo-pyridin-3-yl, 1-oxopyridin-4-yl, 3-pyridazinyl, 4-pyridazinyl, 2-pyrimidinyl, 4-pyrimidinyl, 5-pyrimidinyl, 2-pyrazinyl, 1,3,5-triazin-2-yl, 1,2,4-triazin-3-yl, 1,2,4-triazin-5-yl, 1,2,3,4-tetrazin-1-yl, 1,2,3,4-tetrazin-2-yl, 1,2,3,4-tetrazin-5-yl and the like.

Monoolefins are alkenes; in other words, they are linear or branched aliphatic monounsaturated hydrocarbons having only one C—C double bond. If the term is used without a prefix (Cₙ-Cₘ), it represents a linear or branched monounsaturated (i.e. comprising one C—C double bond) aliphatic hydrocarbon having generally 2 to 40 carbon atoms (“C₂-C₄₀ monoolefin” or “C₂-C₄₀-alkene”), preferably 2 to 30 carbon atoms (“C₂-C₃₀ monoolefin” or “C₂-C₃-alkene”), especially 2 to 10 carbon atoms (“C₂-C₁₀ monoolefin” or “C₂-C₃₀-alkene”). Examples of C₂-C₁₀ monoolefins are ethene, propene, but-1-ene, but-2-ene, isobutene, pent-1-ene, pent-2-ene, 2-methyl-but-1-ene, 2-methyl-but-2-ene, 3-methyl-but-1-ene, 3-methyl-but-2-ene, 2,2-dimethylprop-1-ene, hex-1-ene, hex-2-ene, hex-3-ene, hept-1-ene, hept-2-ene, hept-3-ene, oct-1-ene, oct-2-ene, oct-3-ene, oct-4-ene, non-1-ene, non-2-ene, non-3-ene, non-4-ene, dec-1-ene, dec-2-ene, dec-3-ene, dec-4-ene, dec-5-ene and the positional isomers thereof.

Nonaromatic hydrocarbons having at least two conjugated double bonds refer to both aliphatic and cycloaliphatic unsaturated hydrocarbons having at least two conjugated double bonds. The cycloaliphatic unsaturated hydrocarbons having at least two conjugated double bonds are either those which do not comprise the maximum number of conjugated C—C double bonds defined by the ring size or those which do comprise the maximum number of conjugated C—C double bonds defined by the ring size but do not satisfy the Hückel rule, whether because the molecule is homoaromatic, antiaromatic or a nonaromatic polyene.

Aliphatic hydrocarbons having at least two conjugated double bonds generally comprise 4 to 20 carbon atoms. Examples of aliphatic hydrocarbons having at least two conjugated double bonds are 1,3-butadiene, 1,3-pentadiene, 1,3-hexadiene, 2,4-hexadiene, 1,3,5-hexatriene, 1,3-heptadiene, 2,4-heptadiene, 1,3,4-heptatriene, 1,3-octadiene, 2,4-octadiene, 3,5-octadiene, 1,3,5-octatriene, 2,4,6-octatriene, 1,3,5,7-octatetraene and the like.

Cycloaliphatic hydrocarbons having at least two conjugated double bonds generally comprise 4 to 20 carbon atoms as ring members. Examples are 1,3-cyclopentadiene, 1,3-cyclohexadiene, 1,3-cycloheptadiene, 1,3,5-cycloheptatriene, 1,3-cyclooctadiene, 1,3,5-cyclooctatriene, 1,3,5,7-cyclooctatetraene and the like.

Alkanols are monohydroxyalkanes, i.e. compounds R—OH in which R is a linear or branched alkyl radical as defined above. If the term is used without a prefix (Cₙ-Cₘ), it represents a C₁-C₃₀-alkanol. Examples of C₁-C₃-alkanols are methanol, ethanol, n-propanol and isopropanol. Examples of C₁-C₄-alkanols are, in addition to those mentioned for the C₁-C₃-alkanols, n-butanol, sec-butanol, isobutanol and tert-butanol. Examples of C₁-C₂₀-alkanols are, in addition to those mentioned for the C₁-C₄-alkanols, pentanol, hexanol, heptanol, octanol, 2-ethylhexanol, nonanol, decanol, 2-propylheptanol, undecanol, lauryl alcohol, tridecanol, myristyl alcohol, pentadecanol, palmityl alcohol, heptadecanol, stearyl alcohol, nonadecanol, eicosanol and the positional and constitutional isomers thereof. Examples of C₁-C₃₀-alkanols are, in addition to those mentioned for C₁-C₂₀-alkanols, the higher homologs having 21 to 30 carbon atoms and the positional and constitutional isomers thereof.

Alkanediols are dihydroxyalkanes, i.e. alkanes in which two hydrogen atoms have been replaced by OH groups, where at least two carbon atoms must be between the two hydroxyl groups (i.e. hydrates are not encompassed by this term). If the term is used without a prefix (Cₙ-Cₘ), it represents a C₂-C₃₀-alkanediol. Examples of C₂-C₃-alkanediols are ethylene glycol (ethane-1,2-diol), propane-1,2-diol and propane-1,3-diol. Examples of C₂-C₄-alkanediols are, in addition to those mentioned for the C₂-C₃-alkanediols, butane-1,2-diol, butane-1,3-diol and butane-1,4-diol. Examples of C₂-C₆-alkanediols are, in addition to those mentioned for the C₂-C₄-alkanediols, pentane-1,5-diol and hexane-1,6-diol. Examples of C₂-C₂₀-alkanediols are, in addition to those mentioned for the C₂-C₆-alkanediols, heptane-1,7-diol, octane-1,8-diol, nonane-1,9-diol, decane-1,10-diol, undecane-1,11-diol, dodecane-1,12-diol, tridecane-1,13-diol, tetradecane-1,14-diol, pentadecane-1,15-diol, hexadecane-1,16-diol, heptadecane-1,17-diol, octadecane-1,18-diol, nonadecane-1,19-diol, eicosane-1,20-diol. Examples of C₂-C₃₀-alkanediols are, in addition to those mentioned for C₂-C₂₀-alkanediols, the higher homologs having 21 to 30 carbon atoms.

In the context of the present application, the expression C₉-C₁₁ alcohols represents a mixture comprising alcohols having 9 carbon atoms and alcohols having 11 carbon atoms. C₁₂-C₁₄ alcohols are a mixture comprising alcohols having 12 carbon atoms and alcohols having 14 carbon atoms. C₁₃-C₁₅ alcohols are a mixture comprising alcohols having 13 carbon atoms and alcohols having 15 carbon atoms. C₁₂-C₁₈ alcohols are a mixture comprising alcohols having 12 carbon atoms, alcohols having 14 carbon atoms, alcohols having 16 carbon atoms and alcohols having 18 carbon atoms.

Polymer Composition P1)

The polymer composition P1) is prepared by free-radical polymerization of the monomer composition M1) in the presence of at least one polyether component PE). This affords specific polymer compositions P1) having advantageous properties. Without being bound to a theory, hydrogen bonds are able to form between the growing polymer and the polyether component, and these influence the properties of the resultant polymer composition. Thus, polymer compositions P1) having a high content of the polyether component can be attained; these cannot be prepared by mixing the separately prepared polymer with the polyether component. Free-radical polymer degradation advantageously does not take place here.

For production of the multilayer films of the invention, preference is given to using polymer compositions P1) having a low glass transition temperature TG. Preferably, the polymer compositions P1) used for production of the multilayer films of the invention have a glass transition temperature TG in the range from 0 to 80° C., preferably from 0 to 60° C., especially from 0 to 30° C.

The glass transition temperatures (Tg) described in the context of this application can be determined by means of differential scanning calorimetry (DSC).

In a preferred embodiment, the polymer compositions P1) used for production of the washing- and cleaning-active polymer films of the invention take the form of a transparent film.

Monomer Composition M1)

Monomer A)

The monomer composition M1) used for production of the polymer composition P1) comprises at least one monomer A) selected from α,β-ethylenically unsaturated mono- and dicarboxylic acids, salts of α,β-ethylenically unsaturated mono- and dicarboxylic acids, anhydrides of α,β-ethylenically unsaturated mono- and dicarboxylic acids and mixtures thereof.

In a specific embodiment, the monomer composition M1) consists solely of α,β-ethylenically unsaturated carboxylic acids, salts of α,β-ethylenically unsaturated carboxylic acids and mixtures thereof.

The α,β-ethylenically unsaturated carboxylic acid is preferably selected from acrylic acid, methacrylic acid, ethacrylic acid, maleic acid, fumaric acid, itaconic acid, α-chloroacrylic acid, crotonic acid, citraconic acid, mesaconic acid, glutaconic acid and aconitic acid. Suitable salts of the aforementioned acids are especially the sodium, potassium and ammonium salts, and the salts with amines. The monomers A) can be used as such or as mixtures with one another. The stated proportions by weight all refer to the acid form.

Preferably, the at least one α,β-ethylenically unsaturated carboxylic acid is used for polymerization in non-neutralized form. If the α,β-ethylenically unsaturated carboxylic acids are used for polymerization in partly neutralized form, the acid groups are neutralized preferably to an extent of at most 50 mol %, particularly preferably to an extent of at most 30 mol %. The partial or full neutralization can also be effected during the polymerization or after the polymerization has ended.

Suitable bases for neutralization of the α,β-ethylenically unsaturated carboxylic acids, and also the unsaturated sulfonic acids and phosphonic acids mentioned hereinafter, are alkali metal hydroxides such as NaOH and KOH, alkaline earth metal hydroxides such as Ca(OH)₂ and Mg(OH)₂, ammonia and amine bases. Preferred amines are alkanolamines such as ethanolamine, diethanolamine and triethanolamine. If desired, partial or full neutralization of the acid groups may also follow after the polymerization.

More preferably, monomer A) is selected from acrylic acid, methacrylic acid, maleic acid, fumaric acid, itaconic acid, salts of the aforementioned carboxylic acids and mixtures thereof.

More particularly, monomer A) is selected from acrylic acid, methacrylic acid, salts of acrylic acid, salts of methacrylic acid and mixtures thereof.

In a specific embodiment, exclusively acrylic acid is used as monomer A).

Monomer A) is used preferably in an amount of 50% to 100% by weight, more preferably 60% to 100% by weight, based on the total weight of the monomer composition M1).

In a preferred embodiment, the monomer composition M1) consists to an extent of at least 50% by weight, preferably to an extent of at least 80% by weight and especially to an extent of at least 90% by weight, based on the total weight of the monomer composition M1), of acrylic acid and/or acrylic acid salts.

Monomer B)

The monomer composition M1) may, in addition to the monomers A), comprise at least one monomer B) selected from unsaturated sulfonic acids, salts of unsaturated sulfonic acids, unsaturated phosphonic acid, salts of unsaturated phosphonic acids and mixtures thereof.

Monomer B) is preferably selected from 2-acrylamido-2-methylpropanesulfonic acid, vinylsulfonic acid, allylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, styrenesulfonic acid, vinylphosphonic acid, allylphosphonic acid, salts of the aforementioned acids and mixtures thereof.

A preferred monomer B) is 2-acrylamido-2-methylpropanesulfonic acid.

Suitable salts of the aforementioned acids are especially the sodium, potassium and ammonium salts, and the salts with amines. The monomers B) can be used as such or as mixtures with one another. The stated proportions by weight all refer to the acid form.

Preferably, the monomer composition M1) in that case consists to an extent of at least 50% by weight, more preferably to an extent of at least 80% by weight and especially to an extent of at least 90% by weight, based on the total weight of the monomer composition M1), of monomers A) and B). When the monomer composition M1) comprises at least one monomer B), it is preferably used in an amount of 0.1% to 50% by weight, more preferably 1% to 25% by weight, based on the total weight of the monomer composition M1).

Monomers C)

The monomer composition M1) may additionally comprise at least one further monomer other than the monomers containing acid groups and salts thereof (=monomer C).

The monomer composition M1) may thus have the following monomer compositions: A) or A)+B) or A)+C) or A)+B)+C).

Preferably, the monomer composition M1) additionally comprises at least one monomer C) selected from
C1) nitrogen heterocycles having a free-radically polymerizable α,β-ethylenically unsaturated double bond,
C2) compounds of the general formulae (I.a) and (I.b)

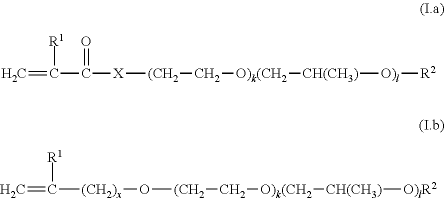

in which
the sequence of the alkylene oxide units is arbitrary,
x is 0, 1 or 2,
k and l are independently an integer from 0 to 100, where the sum of k and l is at least 2, preferably at least 5,
R¹ is hydrogen or C₁-C₈-alkyl,
R² is hydrogen, C₁-C₃₀-alkyl, C₂-C₃₀-alkenyl or C₅-C₈-cycloalkyl, and
X is O or a group of the formula NR³ in which R³ is H, alkyl, alkenyl, cycloalkyl, heterocycloalkyl, aryl or hetaryl;
C3) vinylaromatics,
C4) unsaturated hydrocarbons selected from C₂-C₁₀ monoolefins and nonaromatic hydrocarbons having at least two conjugated double bonds,
C5) esters of α,β-ethylenically unsaturated mono- and dicarboxylic acids with C₁-C₃₀-alkanols,
C6) compounds having one free-radically polymerizable α,β-ethylenically unsaturated double bond and at least one cationogenic and/or cationic group per molecule,
C7) esters of vinyl alcohol or allyl alcohol with C₁-C₃₀-monocarboxylic acids,
C8) esters of α,β-ethylenically unsaturated mono- and dicarboxylic acids with C₂-C₃₀-alkanediols, amides of α,β-ethylenically unsaturated mono- and dicarboxylic acids with C₂-C₃₀ amino alcohols having a primary or secondary amino group,
C9) monomers containing amide groups other than I.a), C6) and C8);
C10) α,β-ethylenically unsaturated nitriles,
C11) vinyl halides, vinylidene halides,
C12) ethylenically unsaturated monomers having urea groups, and mixtures of two or more than two of the aforementioned monomers C1) to C12).

Monomer C1)

Preferred nitrogen heterocycles with a free-radically polymerizable α,β-ethylenically unsaturated double bond C1) are selected from N-vinylimidazole (1-vinylimidazole), vinyl- and allyl-substituted nitrogen heterocycles other than N-vinylimidazole, and mixtures thereof.

The amine nitrogens of the aforementioned compounds can be used to produce charged cationic groups either by protonation with acids or by quaternization with alkylating agents. Suitable monomers C1) are also the compounds obtained by protonation or quaternization of 1-vinylimidazole and different vinyl- and allyl-substituted nitrogen heterocycles. Acids suitable for the protonation are, for example, carboxylic acids such as lactic acid or mineral acids such as phosphoric acid, sulfuric acid and hydrochloric acid. Alkylating agents suitable for quaternization are C₁-C₄-alkyl halides or diC₁-C₄-alkyl) sulfates, such as ethyl chloride, ethyl bromide, methyl chloride, methyl bromide, dimethyl sulfate and diethyl sulfate. A protonation or quaternization may generally either precede or follow the polymerization. Preferably, a protonation or quaternization follows the polymerization. Examples of such charged monomers C1) are quaternized vinylimidazoles, especially 3-methyl-1-vinylimidazolium chloride, methosulfate and ethosulfate.

Preferred monomers C1) are also vinyl- and allyl-substituted nitrogen heterocycles other than vinylimidazoles, selected from 2-vinylpyridine, 4-vinylpyridine, 2-allylpyridine, 4-allylpyridine, 2-vinylpiperidine, 4-vinylpiperidine and the salts thereof obtained by protonation or by quaternization.

More particularly, the monomer composition M1) comprises at least one comonomer C1) selected from 1-vinylimidazole, 2-vinylpyridine, 4-vinylpyridine, 2-allylpyridine, 4-allylpyridine and the salts thereof obtained by protonation or by quaternization. Specifically, the monomer composition M1) comprises 1-vinylimidazole as comonomer C1).

Monomer C2)

The monomer composition M1) may additionally comprise at least one monomer C2) selected from compounds of the general formulae (I.a) and (I.b), as defined above.

In the formulae I.a) and I.b), k is preferably an integer from 1 to 500, more preferably 2 to 400, especially 3 to 250. Preferably, l is an integer from 0 to 100.

Preferably, R¹ in the formula I.a) is hydrogen, methyl, ethyl, n-propyl, isopropyl, n-butyl, sec-butyl, tert-butyl, n-pentyl or n-hexyl, especially hydrogen, methyl or ethyl.

Preferably, R² in the formulae I.a) and I.b) is n-octyl, 1,1,3,3-tetramethylbutyl, ethylhexyl, n-nonyl, n-decyl, n-undecyl, tridecyl, myristyl, pentadecyl, palmityl, heptadecyl, octadecyl, nonadecyl, arachinyl, behenyl, lignoceryl, cerotinyl, melissyl, palmitoleyl, oleyl, linoleyl, linolenyl, stearyl, lauryl.

Preferably, X in the formula I.a) is O or NH, especially O.

More preferably, the monomer composition M1) comprises at least one monomer C2) selected from compounds of the general formulae (I.a1) and (I.b1)

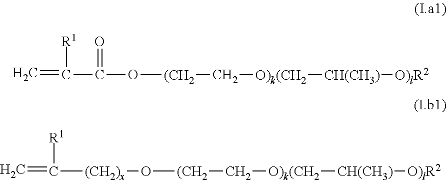

in which
the sequence of the alkylene oxide units is arbitrary,
x is 0, 1 or 2,
k and l are independently an integer from 0 to 100, where the sum of k and l is at least 2, preferably at least 5,
R¹ is hydrogen or methyl,
R² is hydrogen, C₁-C₄-alkyl.

In the formulae I.a1) and I.b1), k is preferably an integer from 1 to 100, more preferably 2 to 50, especially 3 to 30. Preferably, l is an integer from 0 to 50.

Preferably, R² in the formulae I.a1) and I.b1) is hydrogen, methyl, ethyl, n-propyl, isopropyl, n-butyl, sec-butyl or tert-butyl.

In the formula I.b1), x is preferably 1 or 2.

Suitable polyether acrylates I.a) or I.a1) are, for example, the polycondensation products of the aforementioned α,β-ethylenically unsaturated mono- and/or dicarboxylic acids and the acid chlorides, acid amides and acid anhydrides thereof with polyetherols. Suitable polyetherols can be prepared easily by reacting ethylene oxide, propylene 1,2-oxide and/or epichlorohydrin with a starter molecule such as water or a short-chain alcohol R²—OH. The alkylene oxides can be used individually, alternately in succession, or as a mixture. The polyether acrylates I.a1) can be used alone or in mixtures to prepare the polymers used in accordance with the invention.

Suitable allyl alcohol alkoxylates I.b) or I.b1) are, for example, the etherification products of allyl chloride with appropriate polyetherols. Suitable polyetherols can be prepared easily by reacting ethylene oxide, propylene 1,2-oxide and/or epichlorohydrin with a starter alcohol R²—OH. The alkylene oxides can be used individually, alternately in succession, or as a mixture. The allyl alcohol alkoxylates I.b) can be used alone or in mixtures to prepare the polymers used in accordance with the invention.

Monomers C2) used are especially methyl diglycol acrylate, methyl diglycol methacrylate, ethyl diglycol acrylate or ethyl diglycol methacrylate. Preference is given to ethyl diglycol acrylate.

Monomer C3)

The monomer composition M1) may additionally comprise at least one monomer C3) selected from vinylaromatics. Preferred vinylaromatics C3) are styrene, 2-methylstyrene, 4-methylstyrene, 2-(n-butyl)styrene, 4-(n-butyl)styrene, 4-(n-decyl)styrene and mixtures thereof. Particular preference is given to styrene and 2-methylstyrene, especially styrene.

Monomer C4)

The monomer composition M1) may additionally comprise at least one unsaturated hydrocarbon C4) selected from C₂-C₁₀ monoolefins and nonaromatic hydrocarbons having at least two conjugated double bonds.

Examples of C₂-C₁₀ monoolefins are ethene, propene, but-1-ene, but-2-ene, isobutene, pent-1-ene, pent-2-ene, 2-methyl-but-1-ene, 2-methyl-but-2-ene, 3-methyl-but-1-ene, 3-methyl-but-2-ene, 2,2-dimethylprop-1-ene, hex-1-ene, hex-2-ene, hex-3-ene, hept-1-ene, hept-2-ene, hept-3-ene, oct-1-ene, oct-2-ene, oct-3-ene, oct-4-ene, non-1-ene, non-2-ene, non-3-ene, non-4-ene, dec-1-ene, dec-2-ene, dec-3-ene, dec-4-ene, dec-5-ene and the positional isomers thereof, and also unsaturatedly terminated oligomers and polymers of the abovementioned olefins, especially of the α-olefins (ethene, propene, but-1-ene, pent-1-ene, hex-1-ene, hept-1-ene, oct-1-ene, non-1-ene, dec-1-ene).

Nonaromatic hydrocarbons having at least two conjugated double bonds refer to both aliphatic and cycloaliphatic unsaturated hydrocarbons having at least two conjugated double bonds. The cycloaliphatic unsaturated hydrocarbons having at least two conjugated double bonds are either those which do not comprise the maximum number of conjugated C—C double bonds defined by the ring size or those which do comprise the maximum number of conjugated C—C double bonds defined by the ring size but do not satisfy the Hückel rule, whether because the molecule is homoaromatic, antiaromatic or a nonaromatic polyene.

Aliphatic hydrocarbons having at least two conjugated double bonds generally comprise 4 to 20 carbon atoms. Examples of aliphatic hydrocarbons having at least two conjugated double bonds are 1,3-butadiene, 1,3-pentadiene, isoprene, 1,3-hexadiene, 2,4-hexadiene, 1,3,5-hexatriene, 1,3-heptadiene, 2,4-heptadiene, 1,3,4-heptatriene, 1,3-octadiene, 2,4-octadiene, 3,5-octadiene, 1,3,5-octatriene, 2,4,6-octatriene, 1,3,5,7-octatetraene and the like.

Cycloaliphatic hydrocarbons having at least two conjugated double bonds generally comprise 4 to 20 carbon atoms as ring members. Examples are 1,3-cyclopentadiene, 1,3-cyclohexadiene, 1,3-cycloheptadiene, 1,3,5-cycloheptatriene, 1,3-cyclooctadiene, 1,3,5-cyclooctatriene, 1,3,5,7-cyclooctatetraene and the like.

Preferred monomers C4) are ethene, propene, butene, isobutene, diisobutene, isoprene, 1,3-butadiene and mixtures thereof.

Monomer C5)

The monomer composition M1) may additionally comprise at least one monomer C5) selected from esters of α,β-ethylenically unsaturated mono- and dicarboxylic acids with C₁-C₃₀-alkanols.

Suitable esters of α,β-ethylenically unsaturated mono- and dicarboxylic acids with C₁-C₃₀-alkanols are, for example, methyl (meth)acrylate, methyl ethacrylate, ethyl (meth)acrylate, ethyl ethacrylate, n-propyl (meth)acrylate, isopropyl (meth)acrylate, n-butyl (meth)acrylate, tert-butyl (meth)acrylate, tert-butyl ethacrylate, n-pentyl (meth)acrylate, n-hexyl (meth)acrylate, n-heptyl (meth)acrylate, n-octyl (meth)acrylate, 1,1,3,3-tetramethylbutyl (meth)acrylate, ethylhexyl (meth)acrylate, n-nonyl (meth)acrylate, n-decyl (meth)acrylate, n-undecyl (meth)acrylate, tridecyl (meth)acrylate, myristyl (meth)acrylate, pentadecyl (meth)acrylate, palmityl (meth)acrylate, heptadecyl (meth)acrylate, nonadecyl (meth)acrylate, arachinyl (meth)acrylate, behenyl (meth)acrylate, lignoceryl (meth)acrylate, cerotinyl (meth)acrylate, melissyl (meth)acrylate, palmitoleyl (meth)acrylate, oleyl (meth)acrylate, linoleyl (meth)acrylate, linolenyl (meth)acrylate, stearyl (meth)acrylate, lauryl (meth)acrylate and mixtures thereof.

Monomer C6)

The monomer composition M1) may additionally comprise at least one monomer C6) selected from compounds having a free-radically polymerizable α,β-ethylenically unsaturated double bond and at least one cationogenic and/or cationic group per molecule.

The cationogenic and/or cationic groups of the monomers C6) are preferably nitrogen-containing groups such as primary, secondary and tertiary amino groups, and quaternary ammonium groups. Preferably, the nitrogen-containing groups are tertiary amino groups or quaternary ammonium groups. Charged cationic groups can be produced from the amine nitrogens either by protonation or by quaternization with acids or alkylating agents. Examples of these include carboxylic acids such as lactic acid, or mineral acids such as phosphoric acid, sulfuric acid and hydrochloric acid, and examples of alkylating agents include C₁-C₄-alkyl halides or sulfates, such as ethyl chloride, ethyl bromide, methyl chloride, methyl bromide, dimethyl sulfate and diethyl sulfate. A protonation or quaternization may generally either precede or follow the polymerization.

Preferably, the monomers C6) are selected from esters of α,β-ethylenically unsaturated mono- and dicarboxylic acids with amino alcohols which may be mono- or dialkylated on the amine nitrogen, amides of α,β-ethylenically unsaturated mono- and dicarboxylic acids with diamines having at least one primary or secondary amino group, N,N-diallylamine, N,N-diallyl-N-alkylamines and derivatives thereof, and mixtures thereof.

The esters of α,β-ethylenically unsaturated mono- and dicarboxylic acids with amino alcohols which may be mono- or dialkylated on the amine nitrogen preferably derive from C₂-C₁₂ amino alcohols mono- or di-C₁-C₈-alkylated on the amine nitrogen. Suitable acid components of these esters are, for example, acrylic acid, methacrylic acid, fumaric acid, maleic acid, itaconic acid, crotonic acid, maleic anhydride, monobutyl maleate and mixtures thereof. The acid components used are preferably acrylic acid, methacrylic acid and mixtures thereof.

Preferred monomers C6) are N-methylaminoethyl (meth)acrylate, N-ethylaminoethyl (meth)acrylate, N-(n-propyl)aminoethyl (meth)acrylate, N-(tert-butyl)aminoethyl (meth)acrylate, N,N-dimethylaminomethyl (meth)acrylate, N,N-dimethylaminoethyl (meth)acrylate, N,N-diethylaminomethyl (meth)acrylate, N,N-diethylaminoethyl (meth)acrylate, N,N-dimethylaminopropyl (meth)acrylate, N,N-diethylaminopropyl (meth)acrylate and N,N-dimethylaminocyclohexyl (meth)acrylate.

Suitable monomers C6) are additionally the amides of the aforementioned α,β-ethylenically unsaturated mono- and dicarboxylic acids with diamines having at least one primary or secondary amino group. Preference is given to diamines having one tertiary amino group and one primary or secondary amino group.

Examples of preferred monomers C6) are N-[tert-butylaminoethyl](meth)acrylamide, N-[2-(dimethylamino)ethyl]acrylamide, N-[2-(dimethylamino)ethyl]methacrylamide, N-[3-(dimethylamino)propyl]acrylamide, N-[3-(dimethylamino)propyl]methacrylamide, N-[4-(dimethylamino)butyl]acrylamide, N-[4-(dimethylamino)butyl]methacrylamide, N-[2-(diethylamino)ethyl]acrylamide, N-[4-(dimethylamino)cyclohexyl]acrylamide and N-[4-(dimethylamino)cyclohexyl]methacrylamide.

Monomer C7)

The monomer composition M1) may additionally comprise at least one monomer C7) selected from esters of vinyl alcohol or allyl alcohol with C₁-C₃₀ monocarboxylic acids.

Suitable esters of vinyl alcohol with C₁-C₃₀-monocarboxylic acids are, for example, the esters of vinyl alcohol with C₁-C₃₀ monocarboxylic acids such as acetic acid, propionic acid, n-butanoic acid, 2-methylpropanoic acid, n-pentanoic acid, 2,2-dimethylpropanoic acid, n-hexanoic acid, n-heptanoic acid, n-octanoic acid, 2,2,4,4-tetramethylpentanoic acid, 2-ethylhexanoic acid, n-nonanoic acid, n-decanoic acid, n-undecanoic acid, tridecanoic acid, myristic acid, pentadecanoic acid, palmitic acid, heptadecanoic acid, octadecanoic acid, nonadecanoic acid, arachic acid, behenic acid, lignoceric acid, cerotic acid, melissic acid, palmitoleic acid, oleic acid, linoleic acid, linolenic acid, stearic acid, lauric acid.

Monomer C8)

The monomer composition M1) may additionally comprise at least one monomer C8) selected from esters of α,β-ethylenically unsaturated mono- and dicarboxylic acids with C₂-C₃₀-alkanediols and amides of α,β-ethylenically unsaturated mono- and dicarboxylic acids with C₂-C₃₀ amino alcohols having a primary or secondary amino group.

Suitable esters of α,β-ethylenically unsaturated mono- and dicarboxylic acids with C₂-C₃₀-alkanediols are 2-hydroxyethyl acrylate, 2-hydroxyethyl methacrylate, 2-hydroxyethyl ethacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate, 4-hydroxybutyl acrylate, 4-hydroxybutyl methacrylate, 6-hydroxyhexyl acrylate, 6-hydroxyhexyl methacrylate, 3-hydroxy-2-ethylhexyl acrylate, 3-hydroxy-2-ethylhexyl methacrylate, etc.

Suitable amides of α,β-ethylenically unsaturated mono- and dicarboxylic acids with C₂-C₃₀-amino alcohols having a primary or secondary amino group are 2-hydroxyethylacrylamide, 2-hydroxyethylmethacrylamide, 2-hydroxyethylethacrylamide, 2-hydroxypropylacrylamide, 2-hydroxypropylmethacrylamide, 3-hydroxypropylacrylamide, 3-hydroxypropylmethacrylamide, 3-hydroxybutylacrylamide, 3-hydroxybutylmethacrylamide, 4-hydroxybutylacrylamide, 4-hydroxybutylmethacrylamide, 6-hydroxyhexylacrylamide, 6-hydroxyhexylmethacrylamide, 3-hydroxy-2-ethylhexylacrylamide and 3-hydroxy-2-ethylhexylmethacrylamide.

Monomer C9)

The monomer composition M1) may additionally comprise at least one monomer C9) selected from monomers containing amide groups other than I.a, C6) and C8).

Suitable monomers C9) containing amide groups are compounds of the general formula (V)

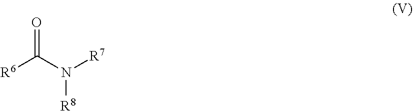

where

one of the R⁶ to R⁸ radicals is a group of the formula CH₂═CR⁹— where R⁹═H or C₁-C₄-alkyl and the other R⁶ to R⁸ radicals are each independently H, alkyl, cycloalkyl, heterocycloalkyl, aryl or hetaryl,

where R⁶ and R⁷, together with the amide group to which they are bonded, can also be a lactam having 5 to 8 ring atoms,

where R⁷ and R⁸, together with the nitrogen atom to which they are bonded, can also be a five- to seven-membered heterocycle.

Preferably, the monomers C9) are selected from primary amides of α,β-ethylenically unsaturated monocarboxylic acids, N-vinylamides of saturated monocarboxylic acids, N-vinyllactams, N-alkyl- and N,N-dialkylamides of α,β-ethylenically unsaturated monocarboxylic acids and mixtures thereof.

Preferred monomers C9) are N-vinyllactams and derivatives thereof which may have, for example, one or more C₁-C₆-alkyl substituents such as methyl, ethyl, n-propyl, isopropyl, n-butyl, sec-butyl, tert-butyl, etc. These include, for example, N-vinyl-pyrrolidone, N-vinylpiperidone, N-vinylcaprolactam, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl-7-ethyl-2-caprolactam, etc.

Particular preference is given to using N-vinylpyrrolidone and/or N-vinylcaprolactam.

Suitable monomers C9) are also acrylamide and methacrylamide.

Suitable N-alkyl- and N,N-dialkylamides of α,β-ethylenically unsaturated monocarboxylic acids are, for example, methyl(meth)acrylamide, methylethacrylamide, ethyl(meth)acrylamide, ethylethacrylamide, n-propyl(meth)acrylamide, isopropyl(meth)acrylamide, n-butyl(meth)acrylamide, tert-butyl(meth)acrylamide, tert-butylethacrylamide, n-pentyl(meth)acrylamide, n-hexyl(meth)acrylamide, n-heptyl(meth)acrylamide, n-octyl(meth)acrylamide, 1,1,3,3-tetramethylbutyl(meth)acrylamide, ethylhexyl(meth)acrylamide, n-nonyl(meth)acrylamide, n-decyl(meth)acrylamide, n-undecyl(meth)acrylamide, tridecyl(meth)acrylamide, myristyl(meth)acrylamide, pentadecyl(meth)acrylamide, palmityl(meth)acrylamide, heptadecyl(meth)acrylamide, nonadecyl(meth)acrylamide, arachinyl(meth)acrylamide, behenyl(meth)acrylamide, lignoceryl(meth)acrylamide, cerotyl(meth)acrylamide, melissyl(meth)acrylamide, palmitoleyl(meth)acrylamide, oleyl(meth)acrylamide, linoleyl(meth)acrylamide, linolenyl(meth)acrylamide, stearyl(meth)acrylamide, lauryl(meth)acrylamide, N-methyl-N-(n-octyl)(meth)acrylamide, N,N-di(n-octyl)(meth)acrylamide and mixtures thereof.

Open-chain N-vinylamide compounds suitable as monomers C9) are, for example, N-vinylformamide, N-vinyl-N-methylformamide, N-vinylacetamide, N-vinyl-N-methylacetamide, N-vinyl-N-ethylacetamide, N-vinylpropionamide, N-vinyl-N-methylpropionamide, N-vinylbutyramide and mixtures thereof. Preference is given to using N-vinylformamide.

Monomer C10)

The monomer composition M1) may additionally comprise at least one monomer C10) selected from α,β-ethylenically unsaturated nitriles.

Suitable α,β-ethylenically unsaturated nitriles are acrylonitrile or methacrylonitrile.

Monomer C11)

The monomer composition M1) may additionally comprise at least one monomer C11) selected from vinyl halides and vinylidene halides.

Suitable vinyl halides and vinylidene halides are vinyl chloride, vinylidene chloride, vinyl fluoride, vinylidene fluoride and mixtures thereof.

Monomer C12)

The monomer composition M1) may additionally comprise at least one monomer C12) selected from ethylenically unsaturated monomers having urea groups.

Suitable monomers C12) having urea groups are N-vinylurea, N-allylurea or derivatives of imidazolidin-2-one. These include N-vinyl- and N-allylimidazolidin-2-one, N-vinyloxy-ethylimidazolidin-2-one, N-(2-(meth)acrylamidoethyl)imidazolidin-2-one, N-(2-(meth) acryloyloxyethyl)imidazolidin-2-one (i.e. 2-ureido(meth)acrylate), N-[2-((meth) acryloyloxyacetamido)ethyl]imidazolidin-2-one, etc.

In a particular embodiment, the monomer composition M1) comprises acrylic acid and optionally at least one comonomer selected from α,β-ethylenically unsaturated mono- and dicarboxylic acids other than acrylic acid, salts, anhydrides, esters and amides of such α,β-ethylenically unsaturated mono- and dicarboxylic acids other than acrylic acid, olefinically unsaturated sulfonic acids, salts of olefinically unsaturated sulfonic acids, nitrogen heterocycles having a free-radically polymerizable α,β-ethylenically unsaturated double bond, C₂-C₁₀ monoolefins, nonaromatic hydrocarbons having at least two conjugated double bonds, vinyl aromatics, N-vinyllactams and mixtures thereof.

In a specific embodiment, the monomer composition M1) comprises acrylic acid and optionally at least one comonomer selected from isobutene, diisobutene, methacrylic acid, 2-acrylamido-2-methylpropanesulfonic acid, maleic acid, maleic anhydride, itaconic acid, N-vinylpyrrolidone, N-vinylcaprolactam, N-vinylimidazole, styrene and mixtures thereof.

In a very specific embodiment, the monomer composition M1) comprises acrylic acid and optionally at least one comonomer selected from methacrylic acid, 2-acrylamido-2-methylpropanesulfonic acid and mixtures thereof.

More particularly, the monomer composition M1) consists to an extent of at least 80% by weight, preferably to an extent of at least 90% by weight and especially to an extent of at least 95% by weight, based on the total weight of the monomer composition M1), of acrylic acid.

The monomer composition M1) may comprise each of the further monomers C1) to
C12) preferably in an amount of 0% to 30% by weight, more preferably 0% to 20% by weight and especially 0% to 10% by weight, based on the total weight of the monomer composition M1). When the monomer composition M1) comprises at least one monomer selected from C1) to C12), it does so in each case preferably in an amount of 0.1% to 30% by weight, more preferably 1% to 20% by weight and especially 1.5% to 10% by weight, based on the total weight of the monomer composition M1).

In a specific embodiment, the monomer composition M1) does not comprise any further comonomers except for the monomers A) and B).

Even more specifically, the monomer composition M1) does not comprise any further comonomers apart from acrylic acid.

The polymer composition P1) comprises essentially uncrosslinked polymers. The monomer composition M1) used for production of the polymer composition P1) of the invention thus especially does not comprise any added crosslinking monomers. In the context of the invention, crosslinking monomers are compounds having two or more than two polymerizable ethylenically unsaturated double bonds per molecule.

Preferably, the monomer composition M1), based on the total weight, comprises less than 0.1% by weight, more preferably less than 0.05% by weight and especially less than 0.001% by weight of crosslinking monomers having two or more than two free-radically polymerizable α,β-ethylenically unsaturated double bonds per molecule.

In a specific embodiment, the monomer composition M1) does not comprise any crosslinking monomers having two or more than two polymerizable α,β-ethylenically unsaturated double bonds per molecule.

Polyether Component PE)

Suitable polyether components PE) are polyetherols having a number-average molecular weight of at least 200 g/mol and the mono- and di(C₁-C₆-alkyl) ethers thereof.

Suitable polyetherols and the mono- and di(C₁-C₆-alkyl) ethers thereof may be linear or branched, preferably linear. Suitable polyetherols and the mono- and di(C₁-C₆-alkyl) ethers thereof generally have a number-average molecular weight in the range from about 200 to 100 000 g/mol, preferably 300 to 50 000 g/mol and more preferably 500 to 40 000 g/mol. Suitable polyetherols are, for example, water-soluble or water-dispersible nonionic polymers having repeat alkylene oxide units. Preferably, the proportion of repeat alkylene oxide units is at least 30% by weight, based on the total weight of the compound. Suitable polyetherols are polyalkylene glycols, such as polyethylene glycols, polypropylene glycols, polytetrahydrofurans and alkylene oxide copolymers. Suitable alkylene oxides for preparation of alkylene oxide copolymers are, for example, ethylene oxide, propylene oxide, epichlorohydrin, 1,2- and 2,3-butylene oxide. Suitable examples are copolymers of ethylene oxide and propylene oxide, copolymers of ethylene oxide and butylene oxide, and copolymers of ethylene oxide, propylene oxide and at least one butylene oxide. The alkylene oxide copolymers may comprise the copolymerized alkylene oxide units in randomly distributed form or in the form of blocks. Preferably, the proportion of repeat units derived from ethylene oxide in the ethylene oxide/propylene oxide copolymers is 40% to 99% by weight. Particularly preferred polyether components PE) are ethylene oxide homopolymers and ethylene oxide/propylene oxide copolymers.

Suitable polyether components PE) are additionally the mono- and diC₁-C₂-alkyl) ethers of the above-described polyetherols. Preference is given to polyalkylene glycol monomethyl ethers and polyalkylene glycol dimethyl ethers.

Suitable polyether components PE) are additionally surfactants containing polyether groups. In general, nonionic and ionic surfactants having at least one nonpolar group and at least one polar group and comprising a polyether group are suitable.

The surfactants PE) containing polyether groups are preferably selected from alkyl polyoxyalkylene ethers, aryl polyoxyalkylene ethers, alkylaryl polyoxyalkylene ethers, alkoxylated animal and/or vegetable fats and/or oils, fatty amine alkoxylates, fatty acid amide alkoxylates, fatty acid diethanolamide alkoxylates, polyoxyethylene sorbitan fatty acid esters, alkyl polyether sulfates, aryl polyether sulfates, alkylaryl polyether sulfates, alkyl polyether sulfonates, aryl polyether sulfonates, alkylaryl polyether sulfonates, alkyl polyether phosphates, aryl polyether phosphates, alkylaryl polyether phosphates, glyceryl ether sulfonates, glyceryl ether sulfates, monoglyceride (ether) sulfates, fatty acid amide ether sulfates, polyoxyalkylene sorbitan fatty acid esters and mixtures thereof.

The preferred nonionic surfactants PE) containing polyether groups include, for example:
alkyl polyoxyalkylene ethers which derive from low molecular weight C₃-C₆ alcohols or from C₇-C₃₀ fatty alcohols. The ether component here may be derived from ethylene oxide units, propylene oxide units, 1,2-butylene oxide units, 1,4-butylene oxide units and random copolymers and block copolymers thereof.
Suitable nonionic surfactants comprise, inter alia, surfactants of the general formula (VI)

R¹⁰—O—(CH₂CH₂O)ₓ—(CHR¹¹CH₂O)_{y}—R¹² (VI)
in which R¹⁰ is a linear or branched alkyl radical having 6 to 22 carbon atoms,
R¹¹ and R¹² are each independently hydrogen or a linear or branched alkyl radical having 1 to 10 carbon atoms or H, where R¹² is preferably methyl, and
x and y are each independently 0 to 300. Preferably, x=1 to 100 and y=0 to 30.
These especially also include fatty alcohol alkoxylates and oxo alcohol alkoxylates, such as isotridecyl alcohol polyoxyethylene ethers and oleyl alcohol polyoxyethylene ethers.
surfactants containing hydroxyl groups of the general formula (VII)

R¹³—O—(CH₂CH₂O)ₛ—(CH₂CH₂CH₂O)ₜ—(CH₂CH₂CH₂CH₂O)ᵤ—(CH₂CHR¹⁴O)ᵥ—CH₂CH(OH)R¹⁵ (VII)
where
the sequence of the alkylene oxide units in the compounds of the formula (VII) is arbitrary,
s, t, u and v are each independently an integer from 0 to 500, where the sum of s, t, u and v is >0,
R¹³ and R¹⁵ are each independently a straight-chain or branched saturated C₁-C₄₀-alkyl radical or a mono- or polyunsaturated C₂-C₄₀-alkenyl radical, and
R¹⁴ is selected from methyl, ethyl, n-propyl, isopropyl and n-butyl.

In the compounds of the general formula (VII), the sum of s, t, u and v is preferably a value of 10 to 300, more preferably of 15 to 200 and especially of 20 to 150.

Preferably, t and u are each 0. In that case, the sum of s and v is preferably a value of 10 to 300, more preferably of 15 to 200 and especially of 20 to 150.

In the compounds of the general formula (VII), R¹³ and R¹⁵ are preferably independently a straight-chain or branched saturated C₂-C₃₀-alkyl radical. At the same time, R¹³ and R¹⁵ may also be mixtures of different alkyl radicals.

In the compounds of the general formula (VII), R¹⁴ is preferably methyl or ethyl, especially methyl.

A preferred embodiment is surfactants containing hydroxyl groups of the general formula (VII.1)

R¹³—O—(CH₂CH₂O)ₛ—(CH₂CH(CH₃)O)ᵥ—CH₂CH(OH)R¹⁵ (VII.1)
where
the sequence of the —(CH₂CH₂O)— and the (CH₂CH(CH₃)O)— units is arbitrary,
s and v are each independently an integer from 0 to 500, where the sum of s and v is >0, and
R¹³ and R¹⁵ are independently a straight-chain saturated C₁-C₃₀-alkyl radical or a branched saturated C₃-C₃₀-alkyl radical or a mono- or polyunsaturated C₂-C₃₀-alkenyl radical.

In the compounds of the general formula (VII.1), the sum of s and v is preferably a value of 10 to 300, more preferably of 15 to 200 and especially of 20 to 150.

The group of these nonionic surfactants includes, for example, hydroxy mixed ethers of the general formula (C₆₋₂₂-alkyl)-CH(OH)CH₂O-(EO)₂₀₋₁₂₀-(C₂₋₂₆-alkyl).
alcohol polyoxyalkylene esters of the general formula (VIII)

R¹⁶—O—(CH₂CH₂O)ₚ—(CH₂CHR¹⁷O)_{q}—C(═O)R¹⁸ (VIII)
where
the sequence of the alkylene oxide units in the compounds of the formula (VIII) is arbitrary,
p and q are each independently an integer from 0 to 500, where the sum of p and q is >0,
R¹⁶ and R¹⁸ are each independently a straight-chain or branched saturated C₁-C₄₀-alkyl radical or a mono- or polyunsaturated C₂-C₄₀-alkenyl radical, and
R¹⁷ is selected from methyl, ethyl, n-propyl, isopropyl and n-butyl.

In the compounds of the general formula (VIII), the sum of p and q is preferably a value of 10 to 300, more preferably of 15 to 200 and especially of 20 to 150.

In the compounds of the general formula (VIII), R¹⁶ and R¹⁸ are preferably each independently a straight-chain or branched saturated C₄-C₃₀-alkyl radical. At the same time, R¹⁶ and R¹⁸ may also be mixtures of different alkyl radicals.

In the compounds of the general formula (VIII), R¹⁷ is preferably methyl or ethyl, especially methyl.

These include, for example, lauryl alcohol polyoxyethylene acetate.
alkylaryl alcohol polyoxyethylene ethers, e.g. octylphenol polyoxyethylene ethers,
alkoxylated animal and/or vegetable fats and/or oils, for example corn oil ethoxylates, castor oil ethoxylates, tallow fat ethoxylates,
alkylphenol alkoxylates, for example ethoxylated isooctyl-, octyl- or nonylphenol, tributylphenol polyoxyethylene ether,
fatty amine alkoxylates, fatty acid amide and fatty acid diethanolamide alkoxylates, especially ethoxylates thereof,
polyoxyalkylene sorbitan fatty acid esters.

One example of an alkyl polyether sulfate is sodium dodecyl poly(oxyethylene) sulfate (sodium lauryl ether sulfate, SLES). A preferred commercially available modified fatty alcohol polyglycol ether is a polyethylene oxide CₓH₂ₓ₊₁/C_{y}H_{2y+1}-terminated at either end and having a free OH group and x, y=6-14.

Polymer P2)

The multilayer film of the invention comprises at least one layer comprising or consisting of a polymer composition P1). Preferably, the multilayer film of the invention comprises at least one further layer comprising or consisting of at least one polymer P2) other than the polymers present in the polymer composition P1).

In a preferred embodiment, the individual layers of the multilayer films of the invention are water-soluble or water-dispersible. According to the field of use of the multilayer films of the invention, it may be advantageous for the individual layers to have a particular solubility in water. For example, it may be desirable for different layers to have different solubility in water. It may also be desirable, for example, for an outer surface layer to have a lesser degree of water solubility in order to prevent blocking and/or partial dissolution in the event of high air humidity and/or high contact moisture (e.g. hand moisture). Alternatively, it may also be desirable for an outer surface layer to have high water solubility in order to rapidly release an active ingredient present therein or ensheathed therewith on contact with water. Such a film may then have water-insoluble outer packaging to prevent unwanted contact with water.

According to the field of use of the multilayer films of the invention, it may also be advantageous for the individual layers to have a temperature-dependent solubility in water.

The multilayer film of the invention preferably comprises at least one further layer comprising or consisting of at least one polymer P2) selected from
natural and modified polysaccharides,
homo- and copolymers comprising repeat units which derive from vinyl alcohol, vinyl esters, alkoxylated vinyl alcohols or mixtures thereof,
homo- and copolymers comprising at least one copolymerized monomer selected from N-vinylpyrrolidone, N-vinylcaprolactam, N-vinylimidazole, 2-vinylpyridine, 4-vinylpyridine, salts of the three latter monomers, vinylpyridine N-oxide, N-carboxymethyl-4-vinylpyridium halides and mixtures thereof,
homo- and copolymers of acrylic acid and/or methacrylic acid, especially copolymers comprising at least one copolymerized acrylic monomer selected from acrylic acid, acrylic salts and mixtures thereof, and at least one copolymerized maleic monomer selected from maleic acid, maleic anhydride, maleic salts and mixtures thereof,
copolymers comprising at least one copolymerized (meth)acrylic monomer selected from acrylic acid, methacrylic acid, salts thereof and mixtures thereof and at least one copoylmerized hydrophobic monomer selected from C₁-C₈-alkyl esters of (meth)acrylic acid, C₂-C₁₀ olefins, styrene and α-methylstyrene, copolymers comprising at least one copolymerized maleic monomer selected from maleic acid, maleic anhydride, maleic salts and mixtures thereof and at least one copolymerized C₂-C₈ olefin,
homo- and copolymers of acrylamide and/or methacrylamide,
polyamino acids,
water-soluble or water-dispersible polyamides,
polyalkylene glycols, mono- or diethers of polyalkylene glycols, and
mixtures thereof.

The multilayer film of the invention more preferably comprises at least one further layer comprising or consisting of at least one polymer P2) selected from
cellulose ethers and cellulose esters,
homo- and copolymers comprising repeat units which derive from vinyl alcohol, vinyl esters, alkoxylated vinyl alcohols or mixtures thereof,
polymers selected from polyvinylpyrrolidone homopolymers, polyvinylimidazole homopolymers, copolymers comprising copolymerized vinylpyrrolidone and vinylimidazole, polyvinylpyridine N-oxide, poly-N-carboxymethyl-4-vinylpyridium halides,
mixtures thereof.

The multilayer film of the invention especially comprises at least one further layer comprising or consisting of at least one polymer P2) selected from cellulose derivatives, preferably carboxyalkyl celluloses and salts thereof, sulfoalkyl celluloses and salts thereof, acidic sulfuric ester salts of cellulose, alkyl celluloses, hydroxyalkyl celluloses, hydroxyalkyl alkyl celluloses and mixtures of two or more of these cellulose derivatives.

Polysaccharides suitable as polymers P2) are natural polysaccharides, for example cellulose, hemicellulose, xyloglucan, glycogen, starch (amylose and amylopectin), dextran, pectins, inulin, xanthan, chitin, callose, and thermally, hydrolytically or enzymatically degraded starch, e.g. maltodextrin etc.

Preferred modified polysaccharides are, for example, cellulose ethers, cellulose esters, cellulose amides, etc.

Cellulose ethers are derivatives of cellulose which arise through partial or complete substitution of the hydrogen atoms in the hydroxyl groups of the cellulose. Cellulose ethers from the reaction of cellulose with more than one etherifying agent are also referred to as cellulose mixed ethers.

Preferred cellulose ethers are selected from alkyl celluloses, hydroxyalkyl celluloses, hydroxyalkyl alkyl celluloses, carboxyalkyl celluloses and salts thereof, carboxyalkyl alkyl celluloses and salts thereof, carboxyalkyl hydroxyalkyl celluloses and salts thereof, carboxyalkyl hydroxyalkyl alkyl celluloses and salts, sulfoalkyl celluloses and salts thereof.

Preferred carboxyalkyl radicals are the carboxymethyl radical and the carboxyethyl radical. A particularly preferred carboxyalkyl radical is the carboxymethyl radical. Preferred sulfoalkyl radicals are the sulfomethyl radical and the sulfoethyl radical. A particularly preferred sulfoalkyl radical is the sulfomethyl radical. Preferred salts are the sodium, potassium, calcium and ammonium salts.

Particularly preferred cellulose ethers are selected from carboxymethyl cellulose, carboxyethyl cellulose, methyl cellulose, ethyl cellulose, n-propyl cellulose, ethyl methyl cellulose, hydroxyethyl cellulose, hydroxypropyl cellulose, hydroxybutyl cellulose, hydroxyethyl methyl cellulose, hydroxypropyl methyl cellulose, hydroxyethyl ethyl cellulose, hydroxypropyl ethyl cellulose, carboxymethyl methyl cellulose, carboxymethyl ethyl cellulose, carboxymethyl hydroxyethyl cellulose, carboxymethyl hydroxyethyl methyl cellulose, carboxymethyl hydroxyethyl ethyl cellulose, sulfomethyl cellulose and sulfoethyl cellulose. The carboxyalkyl radicals and the sulfoalkyl radicals may also be in salt form.

Cellulose esters are derivatives of cellulose which form as a result of esterification of the hydroxyl groups with acids. Preference is given to the sulfuric esters of cellulose. In a specific embodiment, the sulfuric acid is subjected only to a partial esterification, such that the resulting sulfuric esters still have free acid groups or salts thereof. Particular preference is given to using acidic sulfuric ester salts of cellulose. These are notable for their graying-inhibiting effect.

Preferred modified polysaccharides are selected from methyl cellulose, ethyl cellulose, propyl cellulose, methyl/ethyl cellulose, ethyl/propyl cellulose, carboxymethyl cellulose, salts of carboxymethyl cellulose, hydroxyethyl cellulose, hydroxypropyl cellulose, hydroxyethyl methyl cellulose, hydroxyethyl ethyl cellulose, hydroxypropyl methyl cellulose, hydroxypropyl ethyl cellulose, etc.

In a further preferred embodiment, the polymers P2) are selected from homo- and copolymers comprising repeat units which derive from vinyl alcohol, vinyl esters, alkoxylated vinyl alcohols or mixtures thereof.

Suitable vinyl esters (vinyl acylates) are generally the esters of vinyl alcohol with C₁-C₁₅ carboxylic acids, preferably C₁-C₈ carboxylic acids, more preferably C₁-C₄ carboxylic acids. Preferred vinyl acylates are vinyl acetate, vinyl n-propionate, vinyl n-butyrate, vinyl 2-ethylhexanoate, vinyl laurate, etc. Particular preference is given to vinyl acetate.

Partly or fully hydrolyzed polyvinyl acetates (PVAs) are generally referred to as “polyvinyl alcohol (PVOH)”. Partly hydrolyzed polyvinyl acetates are obtained by incomplete hydrolysis of polyvinyl acetates, meaning that the partly hydrolyzed polymer has both ester groups and hydroxyl groups. The hydrolysis of the polyvinyl acetates can be effected in a manner known per se under alkaline or acidic conditions, i.e. with addition of acid or base.

The performance properties of polyvinyl alcohols are determined by factors including the polymerization level and the hydrolysis level (level of hydrolysis). With rising hydrolysis level, the water solubility decreases. Polyvinyl alcohols having hydrolysis levels up to about 90 mol % are generally soluble in cold water. Polyvinyl alcohols having hydrolysis levels of about 90 to about 99.9 mol % are generally no longer soluble in cold water but are soluble in hot water.

Polyvinyl alcohols suitable as polymers P2) preferably have a hydrolysis level of 50 to 99.9 mol %, more preferably of 70 to 99 mol %, especially of 80 to 98 mol %.

Polyvinyl alcohols suitable as polymers P2) preferably have a weight-average molecular weight of 10 000 to 300 000 g/mol, more preferably of 15 000 to 250 000 g/mol.

Polyvinyl alcohols suitable as polymers P2) preferably have a viscosity of 2 to 120 mPa·s, more preferably of 7 to 70 mPa·s and especially of 15 to 60 mPa·s, measured to DIN 53015 on a 4% solution in water.

In a further preferred embodiment, the polymers P2) are selected from homo- and copolymers comprising at least one copolymerized monomer selected from N-vinylpyrrolidone, N-vinylcaprolactam, N-vinylimidazole, 2-vinylpyridine, 4-vinylpyridine, salts of the three latter monomers, vinylpyridine N-oxide, N-carboxymethyl-4-vinylpyridium halides and mixtures thereof.

N-Vinylimidazole, 2-vinylpyridine and 4-vinylpyridine can be converted to the corresponding salts by protonation or quaternization. Suitable acids are, for example, mineral acids such as sulfuric acid, hydrochloric acid and phosphoric acid, and carboxylic acids. Alkylating agents suitable for quaternization are C₁-C₄-alkyl halides or C₁-C₄-alkyl sulfates, such as ethyl chloride, ethyl bromide, methyl chloride, methyl bromide, dimethyl sulfate and diethyl sulfate.

Preference is given to polyvinylpyrrolidone homopolymers and copolymers comprising copolymerized N-vinylpyrrolidone and another different copolymerized ethylenically unsaturated monomer. Suitable N-vinylpyrrolidone copolymers are quite generally uncharged, anionic, cationic and amphoteric polymers.

Particularly preferred N-vinylpyrrolidone copolymers are selected from

copolymers of N-vinylpyrrolidone and vinyl acetate,

copolymers of N-vinylpyrrolidone and vinyl propionate,

copolymers of N-vinylpyrrolidone, vinyl acetate and vinyl propionate,

copolymers of N-vinylpyrrolidone and vinyl acrylate,

copolymers of N-vinylpyrrolidone, ethyl methacrylate and methacrylic acid,

copolymers of N-vinylpyrrolidone and N-vinylimidazole and the derivatives thereof obtained by protonation and/or quaternization,

copolymers of N-vinylpyrrolidone and dimethylaminoethyl methacrylate and the derivatives thereof obtained by protonation and/or quaternization,

copolymers of N-vinylpyrrolidone, N-vinylcaprolactam and N-vinylimidazole and the derivatives thereof obtained by protonation and/or quaternization.

In a further preferred embodiment, the polymers P2) are selected from homo- and copolymers of acrylic acid and/or methacrylic acid.

In a first specific embodiment of the homo- and copolymers of acrylic acid and/or methacrylic acid, the polymer P2) used is an acrylic acid homopolymer. Acrylic acid homopolymers P2) preferably have a number-average molecular weight in the range from 800 to 70 000 g/mol, more preferably 900 to 50 000 g/mol, particularly 1000 to 20 000 g/mol and especially 1000 to 10 000 g/mol. In this context, the term “acrylic acid homopolymer” also encompasses polymers in which the carboxylic acid groups are in partly or fully neutralized form. These include acrylic acid homopolymers in which the carboxylic acid groups are present partly or completely in the form of alkali metal salts or ammonium salts. Preference is given to acrylic acid homopolymers in which the carboxylic acid groups are protonated or are partly or completely in the form of sodium salts. Homopolymers of acrylic acid particularly suitable as polymers P2) are the Sokalan® PA brands from BASF SE.

In a second specific embodiment of the homo- and copolymers of acrylic acid and/or methacrylic acid, polymer P2) used is a copolymer comprising at least one copolymerized acrylic acid monomer selected from acrylic acid, acrylic salts and mixtures thereof and at least one copolymerized maleic monomer selected from maleic acid, maleic anhydride, maleic salts and mixtures thereof. These preferably have a number-average molecular weight in the range from 2500 to 150 000 g/mol, more preferably 2800 to 70 000 g/mol, particularly 2900 to 50 000 g/mol and especially 3000 to 30 000 g/mol. Also included here are copolymers in which the carboxylic acid groups are in partly or fully neutralized form. For this purpose, it is either possible to use monomers in salt form for polymerization or for the resulting copolymer to be subjected to partial or complete neutralization. Preference is given to copolymers in which the carboxylic acid groups are protonated or are partly or completely in the form of alkali metal salts or ammonium salts. Preferred alkali metal salts are sodium or potassium salts, especially the sodium salts.

Preferred polymers P2) are copolymers of maleic acid (or maleic monomers) and acrylic acid (or acrylic monomers) in a weight ratio of 10:90 to 95:5, more preferably those in a weight ratio of 30:70 to 90:10.

Preferred polymers P2) are also terpolymers of maleic acid (or maleic monomers), acrylic acid (or acrylic monomers) and a vinyl ester of a C₁-C₃ carboxylic acid in a weight ratio of 10 (maleic acid):90 (acrylic acid+vinyl ester) to 95 (maleic acid):10 (acrylic acid+vinyl ester). The weight ratio of acrylic acid to vinyl ester is preferably within a range from 30:70 to 70:30.

Particularly suitable polymers P2) based on acrylic monomers and maleic monomers are the corresponding Sokalan® CP brands from BASF SE.

In a third specific embodiment of the homo- and copolymers of acrylic acid and/or methacrylic acid, polymer P2) used is a copolymer comprising at least one (meth)acrylic acid monomer selected from (meth)acrylic acid, (meth)acrylic salts and mixtures thereof and at least one hydrophobic monomer. The hydrophobic monomer is especially selected from C₁-C₈-alkyl esters of (meth)acrylic acid, for example the methyl, ethyl, n- and isopropyl, n-butyl and 2-ethylhexyl esters of (meth)acrylic acid and C₂-C₁₀ olefins, for example ethene, propene, 1,2-butene, isobutene, diisobutene, styrene and α-methylstyrene.

In a further preferred embodiment, the polymer P2) used is a copolymer of at least one maleic monomer selected from maleic acid, maleic anhydride, maleic salts and mixtures thereof with at least one C₂-C₈ olefin. Also suitable are copolymers comprising at least one copolymerized maleic monomer selected from maleic acid, maleic anhydride, maleic salts and mixtures thereof, at least one copolymerized C₂-C₈ olefin and at least one other different copolymerized comonomer.

Particular preference is given to copolymers comprising at least one copolymerized maleic monomer selected from maleic acid, maleic anhydride, maleic salts and mixtures thereof and at least one copolymerized C₂-C₈ olefin as the sole monomers. These preferably have a number-average molecular weight in the range from 3000 to 150 000 g/mol, more preferably 5000 to 70 000 g/mol, particularly 8000 to 50 000 g/mol and especially 10 000 to 30 000 g/mol. Also included here are copolymers in which the carboxylic acid groups are in partly or fully neutralized form. For this purpose, it is either possible to use maleic salts for polymerization or for the resulting copolymer to be subjected to partial or complete neutralization. Preference is given to copolymers in which the carboxylic acid groups are protonated or are partly or completely in the form of alkali metal salts or ammonium salts. Preferred alkali metal salts are sodium or potassium salts, especially the sodium salts.

A specific embodiment is copolymers of maleic acid with C₂-C₈ olefins in a molar ratio of 40:60 to 80:20, particular preference being given to copolymers of maleic acid with ethylene, propylene, isobutene, diisobutene or styrene. Particularly suitable compounds which contain carboxylic acid groups and are based on olefins and maleic acid are likewise the corresponding Sokalan® CP brands from BASF SE.

A further preferred embodiment is that of copolymers comprising at least one copolymerized maleic monomer selected from maleic acid, maleic anhydride, maleic salts and mixtures thereof, at least one copolymerized C₂-C₈ olefin and at least one copolymerized acrylic monomer selected from acrylic acid, acrylic salts and mixtures thereof.

A further preferred embodiment is that of copolymers comprising at least one copolymerized maleic monomer selected from maleic acid, maleic anhydride, maleic salts and mixtures thereof, at least one copolymerized C₂-C₈ olefin and at least one copolymerized ester of (meth)acrylic acid. In that case, the ester of (meth)acrylic acid is especially selected from C₁-C₈-alkyl esters of (meth)acrylic acid, for example the methyl, ethyl, n- and isopropyl, n-butyl and 2-ethylhexyl esters of (meth)acrylic acid.

In a further preferred embodiment, the polymers P2) are selected from homo- and copolymers comprising at least one copolymerized monomer selected from acrylamide, methacrylamide and mixtures thereof. These polymers P2) are preferably water-soluble or water-dispersible. These polymers P2) are especially water-soluble.

In a specific embodiment, the polymers P2) are selected from homopolymers of acrylamide or methacrylamide.

In a further specific embodiment, the polymers P2) are selected from copolymers of acrylamide and/or methacrylamide. These comprise at least one copolymerized comonomer selected from hydrophilic monomers (A1) other than acrylamide and methacrylamide, monoethylenically unsaturated amphiphilic monomers (A2) and further ethylenically unsaturated monomers (A3).

Suitable hydrophilic monoethylenically unsaturated monomers (A1) are uncharged monomers such as N-methyl(meth)acrylamide, N,N′-dimethyl(meth)acrylamide or N-methylol(meth)acrylamide, monomers comprising hydroxyl and/or ether groups, for example hydroxyethyl (meth)acrylate, hydroxypropyl (meth)acrylate, allyl alcohol, hydroxyvinyl ethyl ether, hydroxyvinyl propyl ether, hydroxyvinyl butyl ether, polyethylene glycol (meth)acrylate, N-vinylformamide, N-vinylacetamide, N-vinyl-pyrrolidone or N-vinylcaprolactam, and vinyl esters, for example vinyl formate or vinyl acetate. After polymerization, N-vinyl derivatives may be hydrolyzed to vinylamine units, and vinyl esters to vinyl alcohol units. Suitable hydrophilic monoethylenically unsaturated monomers (A1) are also monomers comprising at least one acidic group or salts thereof. These include acrylic acid, methacrylic acid, crotonic acid, itaconic acid, maleic acid, fumaric acid, vinylsulfonic acid, allylsulfonic acid, 2-acrylamido-2-methylpropanesulfonic acid, 2-methacrylamido-2-methylpropanesulfonic acid, 2-acryl-amidobutanesulfonic acid, 3-acrylamido-3-methylbutanesulfonic acid, 2-acrylamido-2,4,4-trimethylpentanesulfonic acid, vinylphosphonic acid, allylphosphonic acid, N-(meth)acrylamidoalkylphosphonic acids, (meth)acryloyloxyalkylphosphonic acids and salts and mixtures thereof. The further monoethylenically unsaturated hydrophilic monomers may be hydrophilic cationic monomers. Suitable cationic monomers (A1c) especially include monomers having ammonium groups, especially ammonium derivatives of N-(w-aminoalkyl)(meth)acrylamides or w-aminoalkyl (meth)acrylates.

The amphiphilic monomers (A2) are monoethylenically unsaturated monomers having at least one hydrophilic group and at least one, preferably terminal, hydrophobic group.

The monomers (A3) may, for example, be monoethylenically unsaturated monomers which have a more hydrophobic character than the hydrophilic monomers (A1) and are accordingly water-soluble only to a minor degree. Examples of such monomers include N-alkyl- and N,N′-dialkyl(meth)acrylamides, where the number of carbon atoms in the alkyl radicals together is at least 3, preferably at least 4. Examples of such monomers include N-butyl(meth)acrylamide, N-cyclohexyl(meth)acrylamide or N-benzyl(meth)acrylamide.

In a further preferred embodiment, the polymers P2) are selected from polyamino acids. Suitable polyamino acids are in principle compounds comprising at least one copolymerized amino acid such as aspartic acid, glutamic acid, lysine, glycine, etc. The polyamino acids also include the derivatives obtainable by polymer-analogous reaction, such as esterification, amidation, etc. Preferred polyamino acids are polyaspartic acid, polyaspartic acid derivatives, polyglutamic acid, polyglutamic acid derivatives and mixtures thereof.

Polyaspartic acid can be prepared, for example, by alkaline hydrolysis of polysuccinimide (PSI, anhydropolyaspartic acid). Polysuccinimide can be prepared by thermal condensation of aspartic acid or from ammonia and maleic acid. Polyaspartic acid can be used, for example, as a biodegradable complexing agent and cobuilder in washing and cleaning compositions.

Polyamino acids having surfactant properties can be obtained by at least partly converting the free carboxylic acid groups of polyaspartic acid or polyglutamic acid to N-alkylamides and/or to esters. Polyaspartamides can also be prepared by reaction of polysuccinimide with amines. For preparation of hydroxylethylaspartamides, the ring opening of polysuccinimide can be conducted with ethanolamine. DE 37 00 128 A and EP 0 458 079 A describe the subsequent esterification of such hydroxyethyl derivatives with carboxylic acid derivatives. Copolymeric polyaspartic esters are obtainable as described in DE 195 45 678 A by condensation of monoalkyl esters of maleic or fumaric acid with addition of ammonia. DE 195 45 678 A further states that copolymeric polyaspartic esters are obtainable by reaction of polysuccinimide with alcohols, optionally followed by hydrolysis. According to the esterification level and hydrophobicity of the alcohol component, polyaspartic esters, aside from their biodegradability, are notable for excellent properties as stabilizers for O/W and W/O emulsions, as a foam-stabilizing and foam-boosting cosurfactant in washing and cleaning compositions, and as a complexing agent for metal cations.

In a further preferred embodiment, the polymers P2) are selected from polyalkylene glycols and mono- or diethers of polyalkylene glycols. Preferred polyalkylene glycols have a number—average molecular weight in the range from 1000 to 4 000 000 g/mol, more preferably from 1500 to 1 000 000 g/mol.

Suitable polyalkylene glycols and the mono- and diethers thereof may be linear or branched, preferably linear. Suitable polyalkylene glycols are, for example, water-soluble or water-dispersible nonionic polymers having repeat alkylene oxide units. Preferably, the proportion of repeat alkylene oxide units is at least 30% by weight, preferably at least 50% by weight and especially at least 75% by weight, based on the total weight of the compound. Suitable polyalkylene glycols are polyethylene glycols, polypropylene glycols, polytetrahydrofurans and alkylene oxide copolymers. Suitable alkylene oxides for preparation of alkylene oxide copolymers are, for example, ethylene oxide, propylene oxide, epichlorohydrin, 1,2- and 2,3-butylene oxide. Suitable examples are copolymers of ethylene oxide and propylene oxide, copolymers of ethylene oxide and butylene oxide, and copolymers of ethylene oxide, propylene oxide and at least one butylene oxide. The alkylene oxide copolymers may comprise the copolymerized alkylene oxide units in randomly distributed form or in the form of blocks. Preferably, the proportion of repeat units derived from ethylene oxide in the ethylene oxide/propylene oxide copolymers is 40% to 99% by weight. Particular preference is given to ethylene oxide homopolymers and ethylene oxide/propylene oxide copolymers.

Suitable mono- and diethers of polyalkylene glycols are the mono-(C₁-C₁₈-alkyl) ethers and di-(C₁-C₁₈-alkyl) ethers. Preferred mono- and diethers of polyalkylene glycols are the mono-(C₁-C₆-alkyl) ethers and di-(C₁-C₆-alkyl) ethers. Especially preferred are the mono-(C₁-C₂-alkyl) ethers and di-(C₁-C₂-alkyl) ethers. Especially preferred are polyalkylene glycol monomethyl ethers and polyalkylene glycol dimethyl ethers.

Polymer mixtures are suitable, for example, for adjusting the mechanical properties and/or the dissolution properties of the multilayer films of the invention. The polymers used in the polymer mixture may differ in terms of their chemical composition and/or in terms of their physicochemical properties.

In a specific embodiment, the multilayer film of the invention comprises at least one layer comprising a mixture of 2 or more polymers. Suitable mixtures may comprise 2 or more different polymer compositions P1) or at least one polymer composition P1) and at least one polymer P2) or 2 or more different polymers P2).

In a first embodiment, a polymer mixture comprising 2 or more polymers which differ in terms of their chemical composition is used. In a second embodiment, a polymer mixture comprising 2 or more polymers which differ in terms of their molecular weight is used. According to this second embodiment, for example, a polymer mixture comprising at least two polymers P2) comprising repeat units which derive from vinyl alcohol is used.

Characterization of the Multilayer Film

The multilayer film of the invention consists preferably of 2 to 20 layers, more preferably 2 to 15 layers and especially 2 to 10 layers. These specifically include multilayer films consisting of 2, 3, 4, 5, 6, 7 or 8 layers. All these layers may be of different composition, or two or more than two of the layers may have the same composition. The composition of the individual layers depends on the field of use of the multilayer film of the invention.

Preferably, the multilayer films of the invention have a total polymer weight (i.e. of all the components P1) and P2) present) per layer in the range from 0.1 to 100 mg/cm² of film, more preferably of 1 to 80 mg/cm² of film.

As explained above, the layer thickness of the multilayer films of the invention is variable within wide ranges and is dependent on the field of use of the multilayer films of the invention.

Preferably, the multilayer films of the invention for ensheathing or coating a washing, cleaning or dishwashing composition have a layer thickness per layer in the range from 0.5 to 500 μm, preferably from 1 to 250 μm.

Preferably, two-layer films of the invention for ensheathing or coating a washing, cleaning or dishwashing composition have a total layer thickness in the range from 1 to 1000 μm, preferably from 2 to 750 μm.

Preferably, three-layer films of the invention for ensheathing or coating a washing, cleaning or dishwashing composition have a total layer thickness in the range from 1.5 to 1500 μm, preferably from 2 to 1250 μm.

As explained above, multilayer films which themselves serve as washing compositions or as cleaning compositions or as dishwashing compositions preferably have a thickness of not more than 30 mm, more preferably not more than 25 mm.

The multilayer films of the invention feature good mechanical properties. These are shown, for example, in tensile tests on film strips of the multilayer films as described in standards EN ISO 527-1 and ASTM D882-12. EN ISO 527-1 (current ISO version February 2012) is a European standard for plastics for determination of the tensile properties, which are ascertained by a tensile test with a tensile tester. For these tests, it is possible to use a standard apparatus, for example a universal tester from Zwick GmbH, model TMTC-FR2.5TN.D09. To achieve homogeneous test conditions, the multilayer films can first be subjected to storage for several days in equilibrium with the ambient humidity (35-40% relative humidity at 20-25° C.).

Tensile strength is a material property which states the maximum mechanical tensile stress that the material withstands before breaking/tearing. Preferably, the multilayer films of the invention have a tensile strength in the range from 3 to 40 N/mm².

Elongation is a dimensionless parameter which is reported in percent. Preferably, the multilayer films of the invention have an elongation of 20% to 500%.

Production of the Multilayer Films

The multilayer films of the invention comprise at least one layer comprising or consisting of a polymer composition P1).

Preferably, the polymer composition P1) is produced by
A) providing a monomer composition M1) comprising at least one monomer A) selected from α,β-ethylenically unsaturated mono- and dicarboxylic acids, salts of α,β-ethylenically unsaturated mono- and dicarboxylic acids, anhydrides of α,β-ethylenically unsaturated mono- and dicarboxylic acids and mixtures thereof,
B) subjecting the monomer composition M1) provided in step A) to a free-radical polymerization in the presence of at least one polyether component PE) selected from polyetherols having a number-average molecular weight of at least 200 g/mol, mono- and di(C₁-C₆-alkyl) ethers thereof, surfactants containing polyether groups and mixtures thereof, optionally in the presence of at least one additive.

With regard to the monomer composition provided in step A), reference is made in full to the aforementioned suitable and preferred monomers A) and the optional comonomers B) and C).

The free-radical polymerization of the monomer composition M1) in step B) is preferably conducted by the feed method. This generally involves metering at least the monomers in liquid form into the reaction mixture. Monomers which are liquid under the metering conditions can be fed into the reaction mixture without addition of a solvent S1); otherwise, the monomers are used as a solution in a suitable solvent S1). It is of course also possible to use monomers that are in solid form.

The free-radical polymerization for production of the polymer composition P1) can be effected in the presence of a solvent S1) selected from water, C₁-C₆-alkanols, polyols other than PE) and the mono- and dialkyl ethers and mixtures thereof. Suitable polyols and the mono- and dialkyl ethers thereof also include alkylene glycol mono(C₁-C₄-alkyl) ethers, alkylene glycol diC₁-C₄-alkyl) ethers, oligoalkylene glycols and mono(C₁-C₄-alkyl) ethers and diC₁-C₄-alkyl) ethers thereof.

The solvent S1) is preferably selected from water, methanol, ethanol, n-propanol, isopropanol, n-butanol, ethylene glycol, ethylene glycol mono(C₁-C₄-alkyl) ethers, ethylene glycol diC₁-C₄-alkyl) ethers, 1,2-propylene glycol, 1,2-propylene glycol mono(C₁-C₄-alkyl) ethers, 1,2-propylene glycol diC₁-C₄-alkyl) ethers, glycerol, polyglycerols, oligoalkylene glycols having a number-average molecular weight of less than 1000 g/mol and mixtures thereof.

Suitable oligoethylene glycols are commercially available under the CTFA names PEG-6, PEG-8, PEG-12, PEG-6-32, PEG-20, PEG-150, PEG-200, PEG-400, PEG-7M, PEG-12M and PEG-115M. These specifically include the Pluriol E® brands from BASF SE. Suitable alkyl polyalkylene glycols are the corresponding Pluriol A . . . E® brands from BASF SE.

The solvent S1) is more preferably selected from water, ethanol, n-propanol, isopropanol, ethylene glycol, diethylene glycol, triethylene glycol, 1,2-propylene glycol, 1,2-dipropylene glycol and mixtures thereof.

In a specific embodiment, the solvent S1) used is selected from water and a mixture of water and at least one solvent S1) other than water, selected from ethanol, n-propanol, isopropanol, ethylene glycol, diethylene glycol, triethylene glycol, 1,2-propylene glycol, 1,2-dipropylene glycol and mixtures thereof.

In a specific embodiment, the free-radical polymerization in step B) is effected in the presence of a solvent S1) consisting to an extent of at least 50% by weight, preferably to an extent of at least 75% by weight and especially to an extent of at least 90% by weight, based on the total weight of the solvent S1), of water. More particularly, the free-radical polymerization in step B) is effected in the presence of a solvent S1) consisting entirely of water.

Preferably, the free-radical polymerization in step B) is effected in feed mode, in which case feeds comprising at least one α,β-ethylenically unsaturated carboxylic acid do not comprise any solvent S1).

The metering rates of the monomer feed(s) and any further feeds (initiator, chain transfer agent, etc.) are preferably selected such that the polymerization is maintained with the desired conversion rate. The addition of the individual feeds here may be continuous, periodical, with constant or changing metering rate, essentially simultaneous or at different times. Preferably, the addition of all the feeds to the reaction mixture is continuous.

Preferably, for the free-radical polymerization, the monomer composition M1) and the polyether component PE) are used in a weight ratio of 0.5:1 to 5:1, more preferably of 0.7:1 to 3:1.

If the polymer composition P1) is produced using a solvent S1), the weight ratio of the polyether component PE) to the component S1) is preferably in the range from 0.1:1 to 5:1, more preferably from 0.5:1 to 3:1.

Preferably, the free-radical polymerization in step B) is effected at a temperature in the range from 20 to 95° C., more preferably from 30 to 90° C., especially from 40 to 80° C.

The free-radical polymerization in step B) can be effected in the presence of at least one additive. Suitable additives are, for example, corrosion inhibitors, defoamers and foam inhibitors, dyes, fragrances, bitter substances, thickeners, solubilizers, organic solvents, electrolytes, antimicrobial active ingredients, antioxidants, UV absorbers and mixtures thereof.

Preferably, the free-radical polymerization in step B) of the process comprises
B1) providing an initial charge comprising at least a portion of the polyether component PE), optionally at least a portion of the chain transfer agent CTA) and, if the polymerization is effected in the presence of a solvent S1), optionally at least a portion of S1);
B2) adding the monomer composition M1) in one or more feed(s) and adding a feed comprising the free-radical initiator FRI), dissolved in a portion of at least one polyether component PE) and/or of the solvent S1), and optionally adding a feed comprising the amount of the chain transfer agent CTA) which is not used in the initial charge;
B3) optional post-polymerization of the reaction mixture obtained in step B2).

Typically, the initial charge is heated to the polymerization temperature before the feeds are added while stirring.

Preferably, the individual reactants are added simultaneously in separate feeds, the flow rates of the feeds generally being kept very substantially constant over the period of addition.

Preferably, the amount of polyether component PE) in the initial charge (step B1)) is 30% to 100% by weight, more preferably 65% to 100% by weight and especially 80% to 100% by weight, based on the total weight of the polyether component PE) used for polymerization.

Preferably, the content of solvent S1) in the initial charge is not more than 70% by weight, based on the total weight of the feedstocks in the initial charge. Preferably, the content of solvent in the initial charge is not more than 40% by weight, especially not more than 35% by weight, based on the total weight of the feedstocks in the initial charge. The amount of solvent generally changes only by a few percent by weight over the entire course of the process. Typically, solvents S1) having a boiling point at standard pressure (1 bar) of below 240° C. are used.

In a specific variant, the initial charge does not comprise any solvent. The solvent is not added until step B2), via at least one of the feeds. In a very specific variant, no solvent is included in the initial charge and no solvent is added over the entire course of the process.

In a further specific variant, the solvent is initially charged in its entirety.

In a further specific variant, the initial charge does not comprise any chain transfer agent. If a chain transfer agent is used, this is not added until step B2), via at least one of the feeds.

The feeds are added in step B2) over a period of time which is advantageously selected such that the heat of reaction that arises in the course of the exothermic polymerization reaction can be removed without any great technical complexity, for example without the use of a reflux condenser. Typically, the feeds are added over a period of 1 to 10 hours. Preferably, the feeds are added over a period of 2 to 8 hours, more preferably over 2 to 6 hours.

In an alternative embodiment, the free-radical polymerization in step B) of the process is continuous. In that case, the monomer composition M1), the polyether component PE), at least one initiator, optionally at least one chain transfer agent CTA) and optionally at least one solvent S1) are added to the reactor in the form of one liquid stream or preferably at least two liquid streams. In general, the stream comprising the initiator generally does not comprise the chain transfer agent as well. If at least two liquid streams are used, these are typically mixed to obtain the reaction mixture. The polymerization can be effected in one stage or in two or more than two, i.e. in 2, 3, 4, 5 or more, stages. In a suitable embodiment, in the case of a multistage polymerization, at least one additional stream is mixed in between at least two of the polymerization stages. This may be a monomer-containing stream, initiator-containing stream, solvent-containing stream, chain transfer agent-containing stream, a mixture thereof and/or any other stream of matter.

During the free-radical polymerization, the optionally used solvent and/or any condensation products that form are generally not removed. In other words, during the polymerization, there is typically only very minor mass transfer with the surroundings, if any, within the scope of the technical options.

The polymerization can generally be effected at ambient pressure or reduced or elevated pressure. Preferably, the polymerization is conducted at ambient pressure.

The polymerization is generally effected at constant temperature, but it can also be varied during the polymerization if required. Preferably, the polymerization temperature is kept very substantially constant over the entire reaction period, i.e. steps B2) and B3). According to the feedstocks which are used in the process of the invention, the polymerization temperature varies typically within the range from 20 to 95° C. Preferably, the polymerization temperature varies within the range from 30 to 90° C. and especially within the range from 40 to 80° C. If the polymerization is not conducted under elevated pressure and at least one optional solvent S1) has been added to the reaction mixture, the solvent or solvent mixture determines the maximum reaction temperature by virtue of the corresponding boiling temperatures.

The polymerization can be effected in the absence or presence of an inert gas. Typically, the polymerization is conducted in the presence of an inert gas. Inert gas is generally understood to mean a gas which, under the given reaction conditions, does not enter into any reaction with the reactants, reagents or solvents involved in the reaction or the products which form.

If the polymerization is conducted in the presence of a solvent, it is selected from the solvents S1) described above.

For preparation of the polymers, the monomers can be polymerized with the aid of free radical-forming initiators, also referred to hereinafter as free-radical initiators or initiators. Useful free-radical initiators for the free-radical polymerization are in principle all free-radical initiators which are essentially soluble in the reaction medium as exists at the time when they are added and have sufficient activity to initiate the polymerization at the given reaction temperatures. It is possible to introduce one individual free-radical initiator or a combination of at least two free-radical initiators into the process of the invention. In the latter case, the at least two free-radical initiators can be used in a mixture or preferably separately, simultaneously or successively, for example at different times in the course of the reaction.

Free-radical initiators which may be used for the free-radical polymerization are the peroxo and/or azo compounds customary for the purpose, for example hydrogen peroxide, alkali metal or ammonium peroxodisulfates (for example sodium peroxodisulfate), diacetyl peroxide, dibenzoyl peroxide, succinyl peroxide, di-tert-butyl peroxide, tert-butyl peroxybenzoate, tert-butyl peroxypivalate, tert-butyl peroxyneodecanoate, tert-butyl peroxy-2-ethylhexanoate, tert-butyl peroxymaleate, cumene hydroperoxide, diisopropyl peroxydicarbamate, bis(o-tolyl) peroxide, didecanoyl peroxide, dioctanoyl peroxide, tert-butyl peroctoate, dilauroyl peroxide, tert-butyl perisobutyrate, tert-butyl peracetate, di-tert-amyl peroxide, tert-butyl hydroperoxide, 2,2′-azobisisobutyronitrile, 2,2′-azobis(2-amidinopropane) dihydrochloride (=azobis(2-methylpropionamidine) dihydrochloride), azobis(2,4-dimethylvaleronitrile) or 2,2′-azobis(2-methylbutyronitrile).

Also suitable are initiator mixtures or redox initiator systems, for example

ascorbic acid/iron(II) sulfate/sodium peroxodisulfate,

tert-butyl hydroperoxide/sodium disulfite,

tert-butyl hydroperoxide/sodium hydroxymethanesulfinate,

H₂O₂/Cu^{I}.

In the process of the invention, the amount of initiator system (initiator) used varies within the range from 0.01 to 10 pphm, preferably within the range from 0.1 to 5 pphm, more preferably within the range from 0.2 to 2 pphm and especially within the range from 0.3 to 1.5 pphm (parts per hundred monomer=parts by weight per hundred parts by weight of monomer).

In the process of the invention, the free-radical initiator is generally provided in the form of a solution in a solvent comprising at least one of the aforementioned solvents S1) and optionally additionally at least one polyether of polyether component PE).

The polymerization can be effected without using a chain transfer agent (polymerization chain transfer agent) or in the presence of at least one chain transfer agent. Chain transfer agents generally refer to compounds having high transfer constants which accelerate chain transfer reactions and hence bring about a reduction in the degree of polymerization of the resulting polymers. The chain transfer agents can be divided into mono-, bi- and polyfunctional chain transfer agents, according to the number of functional groups in the molecule that can lead to one or more chain transfer reactions. Suitable chain transfer agents are described in detail, for example, by K. C. Berger and G. Brandrup in J. Brandrup, E. H. Immergut, Polymer Handbook, 3rd edition, John Wiley & Sons, New York, 1989, pp. 11/81-11/141.

Suitable chain transfer agents are, for example, aldehydes such as formaldehyde, acetaldehyde, propionaldehyde, n-butyraldehyde, isobutyraldehyde.

Further usable chain transfer agents are formic acid and salts or esters thereof, such as ammonium formate, 2,5-diphenyl-1-hexene, hydroxyammonium sulfate and hydroxyammonium phosphate.

Further suitable chain transfer agents are allyl compounds, for example allyl alcohol, functionalized allyl ethers, such as allyl ethoxylates, alkyl allyl ethers, or glycerol monoallyl ether.

Chain transfer agents used are preferably compounds comprising sulfur in bound form. Compounds of this kind are, for example, inorganic hydrogensulfites, disulfites and dithionites or organic sulfides, disulfides, polysulfides, sulfoxides and sulfones. These include di-n-butyl sulfide, di-n-octyl sulfide, diphenyl sulfide, thiodiglycol, ethylthioethanol, diisopropyl disulfide, di-n-butyl disulfide, di-n-hexyl disulfide, diacetyl disulfide, diethanol sulfide, di-t-butyl trisulfide, dimethyl sulfoxide, dialkyl sulfide, dialkyl disulfide and/or diaryl sulfide. Also suitable as polymerization chain transfer agents are thiols (compounds which comprise sulfur in the form of SH groups, also referred to as mercaptans). Preferred chain transfer agents are mono-, bi- and polyfunctional mercaptans, mercaptoalcohols and/or mercaptocarboxylic acids. Examples of these compounds are allyl thioglycolates, ethyl thioglycolate, cysteine, 2-mercaptoethanol, 1,3-mercaptopropanol, 3-mercaptopropane-1,2-diol, 1,4-mercaptobutanol, mercaptoacetic acid, 3-mercaptopropionic acid, mercaptosuccinic acid, thioglycerol, thioacetic acid, thiourea and alkyl mercaptans such as n-butyl mercaptan, n-hexyl mercaptan or n-dodecyl mercaptan. Examples of bifunctional chain transfer agents which comprise two sulfur atoms in bonded form are bifunctional thiols, for example dimercaptopropanesulfonic acid (sodium salt), dimercaptosuccinic acid, dimercapto-1-propanol, dimercaptoethane, dimercaptopropane, dimercaptobutane, dimercaptopentane, dimercaptohexane, ethylene glycol bisthioglycolates and butanediol bisthioglycolate. Examples of polyfunctional chain transfer agents are compounds which comprise more than two sulfurs in bound form. Examples thereof are trifunctional and/or tetrafunctional mercaptans.

The chain transfer agent is more preferably selected from mercaptoethanol, mercaptoacetic acid, mercaptopropionic acid, ethylhexyl thioglycolate and sodium hydrogensulfite.

Preferred chain transfer agents are also hypophosphorous acid (phosphinic acid) and salts of hypophosphorous acid. A preferred salt of hypophosphorous acid is the sodium salt.

If a chain transfer agent is used in the process of the invention, the amount is typically 1 to 40 pphm (“parts per hundred monomer”, i.e. parts by weight based on one hundred parts by weight of monomer composition). Preferably, the amount of chain transfer agents used in the process of the invention is in the range from 3 to 30 pphm, more preferably in the range from 5 to 25 pphm. It is also possible to conduct the polymerization without adding a chain transfer agent.

Typically, the chain transfer agent is added continuously to the polymerization mixture in its entirety via one of the feeds in step B2). However, it is also possible to add the chain transfer agent either in its entirety to the initial charge, i.e. before the actual polymerization, or to include only some of the chain transfer agent in the initial charge and to add the remainder continuously to the polymerization mixture in step B2) via one of the feeds. The chain transfer agent can be added here in each case without or with solvent S1).

The amount of chain transfer agent and the way in which it is added to the reaction mixture have a major influence on the average molecular weight of the polymer composition P1). If no chain transfer agent or only a small amount of chain transfer agent is used and/or if the addition predominantly precedes the polymerization, this generally leads to higher average molecular weights of the polymer formed. If, by contrast, a relatively large amount of chain transfer agent is used and/or the chain transfer agent is added for the most part during the polymerization (step B2)), this generally leads to a smaller average molecular weight.

In order to avoid or to reduce unwanted foam formation in the synthesis, in transport (for example in pumping) and in storage, and also in film production, defoamers and foam inhibitors may be used. In principle, all known foam inhibitors or defoamers are useful. Mention should be made here, for example, of (1) oil-based systems based on mineral oil or vegetable oil, which may additionally comprise waxes or silica particles, (2) water-based systems in which oil and waxes are dispersed, (3) silicone-based systems (polysiloxanes), for example in water-soluble form, as oil or water-based emulsion, (4) EO/PO-based polyalkoxylates, (5) alkyl polyacrylates, (6) fatty acids and fatty acid esters, especially mono- and diglycerides of fatty acids, (8) fatty alcohol alkoxylates, (9) defoamers from the class of the phosphoric esters and salts thereof, such as sodium (C₆-C₂₀-alkyl)phosphates, e.g. sodium octylphosphate or tri(C₁-C₂₀-alkyl) phosphates, e.g. tributyl phosphate, and (10) metal soaps, such as aluminum stearate or calcium oleate.

The polysiloxanes (polydimethylsiloxanes) can also be used in modified form, for example in alkyl group-modified or polyether group-modified form. These are used with preference.

Preferably, the polymer compositions P1) obtained after the polymerization has ended (step B3)) are transferred to a suitable vessel and optionally cooled directly to ambient temperature (20° C.).

The polymer compositions P1) obtained in this way are advantageously suitable for production of multilayer films, for example for use as a washing or cleaning composition or as a sheath for a liquid washing or cleaning composition. The production of multilayer films and of sheaths based thereon is described in detail hereinafter.

The weight-average molecular weight M_{w} of the polymer composition P1) of the invention was determined by means of gel permeation chromatography (GPC) in aqueous solution using neutralized polyacrylic acid as polymer standard. This type of molecular weight determination covers the components of the polymer composition P1) which comprise the monomers M1) in copolymerized form. The polymer composition P1) preferably has a weight-average molecular weight of 2000 to 100 000 g/mol, preferably of 3000 to 80 000 g/mol.

The polymer composition P1) has a sufficiently low glass transition temperature TG suitable for film formation. Preferably, the polymer compositions P1) have a glass transition temperature TG in the range from 0 to 80° C., more preferably from 0 to 60° C., especially from 0 to 30° C.

Prior to use for film production (i.e. before it passes through a drying operation), the polymer composition P1) preferably has a content of acid groups of more than 1 mmol/g, more preferably of more than 1.3 mmol/g. Prior to use for film production, the polymer composition P1) preferably has a content of acid groups of not more than 15 mmol/g. Prior to use for film production, the polymer composition P1) especially has a content of acid groups of 1.5 mmol/g to 10 mmol/g.

In a preferred embodiment, the acid groups of the polymer composition P1) of the invention are in non-neutralized form.

As mentioned at the outset, the multilayer film can be produced by a lamination method. Lamination methods in which two or more film layers are bonded to one another over their area are known to those skilled in the art. Lamination involves pressing two or more than two films together under elevated pressure and/or at elevated temperature. As likewise mentioned at the outset, the multilayer film can also be produced by a wet-on-wet application method. In addition, the multilayer film can also be produced by using combinations of the aforementioned production methods and the application method described hereinafter.

In a preferred embodiment, the multilayer film is produced by a process in which at least one free-flowing composition capable of film formation is applied to a carrier material, wherein the carrier material and/or the at least one free-flowing composition comprises or consists of a polymer composition P1) as defined above and hereinafter.

The invention further provides a process for producing a multilayer film as defined above, in which
a1) a first free-flowing composition capable of film formation is applied to a carrier material to obtain a first layer,
a2) the first layer applied to the carrier material is optionally subjected to an increase in viscosity,
a3) a second free-flowing composition capable of film formation is applied to the first layer obtained in step a1) or in step a2) to obtain a second layer,
a4) the second layer is optionally subjected to an increase in viscosity,
a5) step a3) is optionally repeated with a further composition capable of film formation to obtain a further layer and step a4) is optionally then repeated, it being possible to repeat steps a3) and a4) once or more than once,
a6) the layers applied to the carrier material are optionally subjected to a further increase in viscosity,
a7) the multilayer film obtained is optionally detached from the carrier material,

with the proviso that the free-flowing compositions each comprise a component which is capable of film formation and is independently selected from at least one polymer composition P1), at least one polymer P2) or a mixture thereof, and with the proviso that at least one of the free-flowing compositions and/or the carrier material comprises or consists of a polymer composition P1) as defined in any of the preceding claims.

In a specific embodiment, the application of two or more than two of the free-flowing compositions can also be effected partly or fully simultaneously. For this purpose, for example, the application of the (n+1)th composition can be commenced before the application of the nth composition has completely ended.

In a further specific embodiment, the production of the multilayer film proceeds from a carrier material which already comprises the first film layer and optionally also already comprises further film layers of the multilayer film. In other words, a carrier material which already comprises the first film layer and optionally further film layers of the multilayer film is used in step a1). In this case, the carrier material forms part of the multilayer film and remains in the multilayer film after the application of all the further layers. This means that the further layers applied to the carrier material are not subsequently detached again from the carrier material. In this embodiment, there is therefore no step a7) of the above-described process.

The viscosity of the free-flowing composition is matched to the technical demands of the production method and is determined by factors including the concentration of the components capable of film formation, the solvent content (water), the additives added and the temperature.

The free-flowing compositions capable of film formation are applied in steps a1), a3) and a5) generally by means of standard methods, for example by means of methods selected from airblade coating, knife coating, airknife coating, squeegee coating, impregnation coating, dip coating, reverse roll coating, transfer roll coating, gravure coating, kiss coating, flow coating, cascade flow coating, slide coating, curtain coating, mono- and multilaminar slot die coating, spray coating, spin coating, or printing methods such as relief printing, intaglio printing, rotogravure printing, flexographic printing, offset printing, inkjet printing, letterpress printing, pad printing, heatseal printing or screenprinting methods. The application can also be continuous or semicontinuous, for example when the carrier material is moving, for example a permanently or intermittently moving belt.

Suitable carrier materials are firstly all materials which enable simple detachment of the finished multilayer film. Examples of these include glass, metals such as galvanized steel sheet or stainless steel, polymers such as silicones or polyethylene terephthalate, polymer-coated paper, such as silicone paper, etc. Suitable carrier materials are secondly monolaminar or multilaminar polymer films which remain as film layers in the multilayer film of the invention. With regard to the composition of these carrier materials, reference is made to the disclosure relating to polymer compositions P1) and polymers P2).

The increase in viscosity in layers a2), a4) and a6) can be effected by means of standard methods and generally depends on the form in which the free-flowing compositions capable of film formation have been applied in steps a1), a3) and a5). If they have been applied as a melt, for example, there is generally already an increase in viscosity in the course of cooling. The cooling can be effected by simply leaving the carrier material to stand or by active cooling, such as cooling of the carrier material, jetting with a cool gas (jet), cooling in a cold room/refrigerator and the like. If the free-flowing composition capable of film formation has been applied in the form of a solution or dispersion, it is generally necessary to remove at least some of the solvent, which can be effected, for example, by simply leaving the carrier material to stand, drying with an air jet or hot air jet, drying in drying cabinets, heating of the carrier material, application of a reduced pressure, optionally with simultaneous supply of heat, IR irradiation, microwave radiation, for example in a corresponding oven, and the like. Should the composition be curable, for example because the polymers present therein comprise as yet unconverted polymerizable/condensable groups, the increase in viscosity can alternatively or additionally be effected by curing the polymer. The measures suitable for curing depend on the polymerizable/condensable groups present. For instance, ethylenically unsaturated crosslinkable groups are especially cured by UV radiation; condensable groups, by contrast, generally cure either by being left to stand or with supply of heat. The heat can again be supplied as described above, i.e., for example, by incidence of warm or hot air or other warm or hot gases, drying in drying cabinets, heating of the carrier material, IR irradiation and the like. It is also possible to gelate the solution or dispersion applied by cooling, in the sense of forming a physical network extended over macroscopic dimensions, which likewise results in an increase in viscosity.

In a specific embodiment, the free-flowing compositions capable of film formation for two or more than two of the layers that form the multilayer film are applied by a wet-on-wet application method. The application in a3), a5) etc. can thus be effected wet-on-wet, meaning that the next layer can also be applied to the layer applied in step a1), a3) and/or a5) without an explicit step for increasing viscosity having been conducted beforehand. This is especially true when the layer to which the next polymer layer is applied is sufficiently thin, such that it solidifies sufficiently even without being explicitly left to stand, dried, heated, cured, etc. before the next layer is applied, and there is no complete mixing with the components of the next layer. This is also true when the two layers, i.e. those to which application is effected, and the layer applied subsequently do not have any strong tendency to mix, for example because one layer is based on an aqueous polymer solution/dispersion and the other on a hydrophobic organic solution/dispersion or a hydrophobic melt.

The polymers applied in steps a1), a3), a5) etc. are film-forming polymers.

In a particular embodiment, after steps a1), a2), a3), a4), a5) and/or a6), it is also possible to apply one or more layers that do not comprise any film-forming polymers. These are especially layers comprising components (functional materials) connected to the desired end use of the multilayer film. Should the film serve, for example, in or as a washing composition or as a sheath for washing compositions, these optional further layers may comprise surfactants, builders, cobuilders, bleaches, enzymes, enzyme stabilizers, graying inhibitors, optical brighteners, fragrances, bitter substances, dyes, etc. These components may, like the polymer layers too, be applied in solution/dispersion or melt. Suitable application techniques here too are those mentioned above.

The application of these layers may also be followed by a step of increasing the viscosity, or the next layer can be applied wet-on-wet. The statements made above apply analogously.

If the above-described layers that are applied do not comprise any film-forming polymers but do comprise components connected to the desired end use of the multilayer film, it is possible after steps a1), a2), a3), a4), a5) and/or a6), especially after steps a1), a3) and/or a5), to emboss or punch the polymer layer, so as to give rise to recesses in which the functional materials applied at a later stage can be accommodated in relatively large amounts. This can be effected by means of standard embossing, printing, stamping and punching tools.

The process of the invention allows the production of multilayer films without a complex lamination method in which the individual films have to be bonded to one another. It will be appreciated that the multilayer films of the invention can also be produced, as described above, by bonding two or more than two film layers to one another by laminating. For instance, multilaminar polymer films which serve as carrier material for application of further film layers may be provided by bonding two or more than two film layers to one another by laminating.

For provision of the compositions applied in steps a1), a3), a5) etc., for example, a component which is capable of film formation and is selected from at least one polymer composition P1), at least one polymer P2) or a mixture thereof, optionally after addition of at least one additive, is melted or dissolved in a suitable solvent or solvent mixture, the free-flowing composition thus obtained is poured out to form a layer and the solvent or solvent mixture is optionally removed by evaporation.

Suitable solvents and solvent mixtures are those described above as component S1), to which reference is made here in its entirety. The solvent is more preferably selected from water, ethanol, n-propanol, isopropanol, ethylene glycol, diethylene glycol, 1,2-propylene glycol, 1,2-dipropylene glycol and mixtures thereof. In a specific embodiment, the solvent used is selected from water and a mixture of water and at least one solvent other than water, selected from ethanol, n-propanol, isopropanol, ethylene glycol, diethylene glycol, 1,2-propylene glycol, 1,2-dipropylene glycol and mixtures thereof.

In a specific embodiment of the present invention, a first dilaminar film is combined with a second dilaminar film in the manner of a lamination.

Preferably, the first dilaminar film comprises a layer S1) comprising a polymer composition P1) or consisting of a polymer composition P1) and a layer S2) comprising at least one polymer P2) or consisting of at least one polymer P2). The first dilaminar film may be combined with a second dilaminar film by steps a1) to a4), optionally after the drying of the second layer, in the manner of a lamination.

The second dilaminar film may likewise be produced simultaneously according to steps (a) to (d), as described above, or in a plant connected in parallel. If the same composition is used for the laminas of the two films that come into contact, the multilaminar film produced in this way via lamination consists of three laminas. In that case, if the outer laminas are chemically different, the resulting multilayer film has three chemically different laminas. If the outer laminas are also chemically identical, the resulting multilayer film has only two chemically different laminas.

In a further embodiment of the present invention, a dilaminar film is cut into two halves and then the two halves of the film obtained are laminated. When a customary machine for production of film sheets is used, these can be cut in the middle in machine direction, placed one on top of the other and then laminated. In this embodiment too, the dilaminar film can be produced by steps a1) to a4) and optionally drying of the second layer. In this embodiment, it is also possible to laminate the chemically identical interfaces to one another in order to effectively obtain a multilayer film composed of three laminas, where the two outer laminas are chemically identical.

The advantage of the two abovementioned embodiments of the present invention is that of distinctly accelerated drying by virtue of the reduced layer thickness, which is directly connected to an elevated production rate. Without being restricted to the theory, the mass transfer of the solvent through the film with a constant coefficient of diffusion is proportional to 1/film thickness.

A specific embodiment is a process for producing a multilayer film of the invention comprising at least one additive. In this case, an individual layer or a plurality of but not all the layers or all the layers may each comprise one or more than one additive. Alternatively or additionally, it is possible that at least one additive is present between at least two layers. Additives may, as described above, already be added in the course of the free-radical polymerization in step B) or in the provision of the free-flowing compositions capable of film formation in steps a1), a3), a5) etc. Whether the addition is already effected in step B) or only in the provision of the free-flowing compositions capable of film formation depends on the nature and effect of the particular additive.

The additives may be auxiliaries for adjustment of the properties of the free-flowing compositions capable of film formation, typical additives for the end use of the multilayer films or mixtures thereof. Typical additives for the end use of the multilayer films are especially selected from additives for washing compositions, cleaning compositions, dishwashing compositions, rinse aids, hygiene products, disinfectants, personal care compositions, personal cleansing compositions, cosmetic compositions, pharmaceutical compositions, crop protection compositions, bait traps, wetting agents, etc.

Preference is given to multilayer films in which at least one of the layers includes an additive. Particular preference is given to multilayer films in which at least one of the layers includes an additive which is a constituent customary for washing and cleaning compositions. In that case, the additive is preferably selected from nonionic, anionic, cationic and amphoteric surfactants, builders, complexing agents such as methylglycinediacetic acid, glutaminediacetic acid, glutamic acid diacetic acid and citric acid and the sodium and potassium salts thereof, bleaches, enzymes, enzyme stabilizers, bases, corrosion inhibitors, defoamers and foam inhibitors, wetting agents, dyes, pigments, fragrances, fillers, tableting aids, disintegrants, thickeners, solubilizers, organic solvents, electrolytes, pH modifiers, perfume carriers, bitter substances, fluorescers, hydrotropes, antiredeposition agents, optical brighteners, graying inhibitors, antishrink agents, anticrease agents, dye transfer inhibitors, antimicrobial active ingredients, antioxidants, anti-yellowing agents, corrosion inhibitors, antistats, ironing aids, hydrophobizing and impregnating agents, antiswell and antislip agents, plasticizers, scavengers, polymers other than the polymer compositions P1) and the polymers P2), agents for modification of gas permeability and water vapor permeability, antistats, glidants, slip agents, UV absorbers and mixtures thereof.

In a preferred embodiment, a layer of the multilayer film of the invention comprises, as additive, at least one enzyme and optionally at least one enzyme stabilizer. Suitable enzymes and enzyme stabilizers are those mentioned hereinafter as components E1).

Suitable bitter substances are those mentioned hereinafter as components E6).

Some additives can fulfill more than one function, for example as solvent S1) and as plasticizer.

In order to make the multilayer films of the invention more flexible, plasticizers can be added thereto in the course of production. For production of the free-flowing compositions capable of film formation, preferably 0.5% to 30% by weight, more preferably 2% to 20% by weight and especially 3% to 15% by weight of plasticizer is used, based on the total weight of the composition.

Suitable plasticizers are alkyleneamines, alkanolamines, polyols such as alkylene glycols and oligoalkylene glycols, e.g. 2-methylpropane-1,3-diol, 3-methylpentane-1,5-diol, hydroxypropylglycerol, neopentyl glycol, alkoxylated glycerol (for example Voranol® from Dow Chemicals), water-soluble polyesterpolyols (for example TriRez from Geo Specialty Chemicals) and mixtures thereof. Suitable plasticizers are also polyetherpolyols available under the Lupranol® name from BASF SE. The term “alkyleneamines” refers to condensation products of alkanolamines with ammonia or primary amines; for example, ethyleneamines are obtained by reaction of monoethanolamine with ammonia in the presence of a catalyst. This results in the following main components: ethylenediamine, piperazine, diethylenetriamine and aminoethylethanolamine.

Preferably, the plasticizers are selected from glycerol, diglycerol, propylene glycols having a weight-average molecular weight of up to 400, ethylene glycol, polyethylene glycols having a weight-average molecular weight of up to 400, diethylene glycol, triethylene glycol, tetraethylene glycol, sugar alcohols such as sorbitol, mannitol, xylitol, isomalt, lactitol, isopentyldiol, neopentyl glycol, trimethylolpropane, diethylenetriamine, triethylenepentamine, triethanolamine and mixtures thereof.

In order to make the multilayer films of the invention more resistant to aggressive ingredients (for example chlorine-releasing compounds as used in the field of disinfection of water, etc.), it is possible to add what are called “scavengers” (capture molecules) to the film. Suitable scavengers are polyamines, polymeric polyamines, such as polyethyleneimines, poly(amidoamines) and polyamides. In addition, it is also possible to use ammonium sulfate, primary and secondary amines having a low vapor pressure, such as ethanolamines, amino acid and salts thereof, and also polyamino acid and salts thereof, fatty amines, glucosamines and other aminated sugars. It is further possible to use reducing agents, such as sulfites, bisulfites, thiosulfites, thiosulfates, iodides, nitrites and antioxidants such as carbamates, ascorbates and mixtures thereof.

For production of the multilayer films of the invention, it is possible to add further additives in the form of polymers to the polymer composition P1) and/or the polymers P2) before and/or during the film production. Typically, 0.05% to 20% by weight, preferably 0.1% to 15% by weight and more preferably 0.2% to 10% by weight of polymers (based on the total weight of the polymer composition P1), polymers P2) and additional polymers) are used. Such additives can simultaneously improve the washing properties of the multilayer film, improve the mechanical properties of the multilayer film, and increase the resistance of the multilayer film to washing composition components. Suitable further polymers are, for example, oligosaccharides and polysaccharides, starch, degraded starches (maltodextrins), cellulose ethers, specifically hydroxyethyl cellulose, hydroxypropyl cellulose, methyl cellulose, ethyl cellulose, hydroxypropyl methyl cellulose, hydroxypropyl ethyl cellulose, microcrystalline cellulose, inulin, carboxymethylcellulose, for example in the form of the sodium salts, alginic acid and alginates, pectin acid and pectins, polyethyleneimines, alkoxylated and especially ethoxylated polyethyleneimines, graft polymers of vinyl acetate onto polyalkylene glycols, especially onto polyethylene glycols, homopolymers of N-vinylpyrrolidone, copolymers of N-vinylpyrrolidone and N-vinylimidazole, copolymers of N-vinylpyrrolidone with vinyl acetate and with vinylcaprolactam, polyalkylene oxides, polyvinyl alcohol, polyvinyl alcohols with fractions of unhydrolyzed vinyl acetate, thickeners, for example xanthan gum, guar gum, gelatin, agar-agar and mixtures thereof.

It is additionally possible to subject at least one surface or both surfaces of the multilayer films of the invention to at least partial coating with at least one additive.

Such a treatment may serve, for example, to provide the surface with particular properties, such as nonstick action, antistatic action, hydrophilic or hydrophobic properties, etc. It is thus possible to provide the multilayer films, for example, with better detachment properties from the carrier material used in the production, better roll-off properties, better glide properties, reduced tack, better compatibility with particular components ensheathed or coated therewith, etc. According to the nature and formulation of the additive, the application can be effected by standard methods, for example by spraying, dipping, powder application, etc. Suitable additives for coating of the surface of the multilayer films of the invention are, for example, talc, surfactants such as silicone-containing surfactants, waxes, etc.

Printing or embossing of the multilayer films of the invention is also possible, in order to provide these, for example, with patterns, motifs, or inscriptions. The printing may follow the production of the multilayer film or be effected in an intermediate step during the buildup of the layers. This printing step preferably follows directly inline after the film production, in a separate printing or converting process, or inline with the pod production. Suitable printing methods are inkjet printing, and also intaglio and planographic printing methods such as flexographic printing, gravure printing, offset printing or inkjet printing.

As stated above, the film production process is not subject to any particular restrictions and the person skilled in the art is able to apply any desired production process of which he is aware on account of his art knowledge. This applies to the production of multilayer films which are to be used as such for use as a washing composition or as a cleaning composition. The same applies to the production of sheaths and coatings based on a multilayer film of the invention. Particularly suitable methods are coating bar methods, casting methods, roll application methods and extrusion methods.

The multilayer films of the invention are generally thermoplastic and can be subjected to a forming operation by thermoforming (i.e. hot forming, deep drawing or vacuum deep drawing). A process for producing water-soluble film packagings by a thermoforming process which comprises a hot forming or deep drawing step is described in WO 00/55044.

For production of film portions, the multilayer film of the invention can be processed in a suitable manner, for example by cutting to a desired size and/or folding to form compartments. Subsequently, the edges can be sealed by standard sealing methods such as heat sealing, liquid sealing or pressure sealing.

As stated above, the multilayer film of the invention may preferably consist of 2 to 20 layers, more preferably 2 to 15 layers and especially 2 to 10 layers. These specifically include multilayer films consisting of 2, 3, 4, 5, 6, 7 or 8 layers. The sequence of the layers of the multilayer films of the invention is guided by the desired end use.

According to the invention, one or more layers of the multilayer film of the invention comprise a polymer composition P1). In a specific embodiment, one layer of the multilayer film of the invention consists of a polymer composition P1).

In a preferred embodiment, one or more layers of the multilayer film of the invention comprise a homo- or copolymer P2) comprising repeat units which derive from vinyl alcohol, vinyl esters or mixtures thereof. Preferred polymers P2) are polyvinyl alcohols having a hydrolysis level of 50 to 99 mol %, more preferably of 70 to 98 mol %.

In a specific embodiment, one or more layers of the multilayer film of the invention comprise a cold water-soluble polyvinyl alcohol P2) having a hydrolysis level of not more than 90 mol %.

In a further specific embodiment, one or more layers of the multilayer film of the invention comprise a hot water-soluble polyvinyl alcohol P2) having a hydrolysis level of about 90 to about 99 mol %.

In a further preferred embodiment, one or more layers of the multilayer film of the invention comprise at least one cellulose ether P2). Preferred cellulose ethers are selected from alkyl celluloses, hydroxyalkyl celluloses, hydroxyalkyl alkyl celluloses, carboxyalkyl celluloses and salts thereof, carboxyalkyl alkyl celluloses and salts thereof, carboxyalkyl hydroxyalkyl celluloses and salts thereof, carboxyalkyl hydroxyalkyl alkyl celluloses and salts, sulfoalkyl celluloses and salts thereof. Particularly preferred cellulose ethers are selected from carboxymethyl celluloses. The carboxyalkyl radicals may also be in salt form.

In a further preferred embodiment, one or more layers of the multilayer film of the invention comprise at least one homo- or copolymer comprising at least one copolymerized monomer selected from N-vinylpyrrolidone, N-vinylcaprolactam, N-vinylimidazole, 2-vinylpyridine, 4-vinylpyridine, salts of the three latter monomers, vinylpyridine N-oxide, N-carboxymethyl-4-vinylpyridium halides and mixtures thereof.

In a specific embodiment, one or more layers of the multilayer film of the invention comprise a polyvinylpyrrolidone homopolymer.

In a further specific embodiment, one or more layers of the multilayer film of the invention comprise a copolymer comprising copolymerized vinylpyrrolidone and vinylimidazole.

Washing, Cleaning and Dishwashing Compositions

The multilayer films of the invention are suitable as such for use as a washing composition or as a cleaning composition or as a dishwashing composition. The term “dishwashing composition” here also covers rinse aids. Since at least one layer of the multilayer films includes a polymer composition P1), they feature dispersing, film-inhibiting, emulsifying and/or surfactant properties, and so the polymer composition P1) also contributes to the washing and cleaning performance. The multilayer films of the invention do not just improve the washing power, i.e. actively help to remove soil from the fabric or from hard surfaces such as ceramic, glass, plastic and metal, but also prevent redeposition of detached soil on concomitantly washed fabric or hard surfaces, meaning that they have a graying-inhibiting and deposition-inhibiting effect. Because of their washing and cleaning effect, they are especially suitable for formulation of laundry detergents and dishwashing compositions. In this embodiment too, the multilayer films of the invention take the form of a self-supporting flat structure having at least two film layers.

The maximum thickness of the multilayer films of the invention for use as a washing composition or as a cleaning composition or as a dishwashing composition is preferably not more than 30 mm, more preferably not more than 20 mm and especially not more than 15 mm.

The thickness of the multilayer films for use as a washing composition or as a cleaning composition or as a dishwashing composition is preferably less than the length of the greatest longitudinal axis by a factor of at least 2, more preferably at least 5 and especially at least 10.

Preferably, multilayer films for use as a washing composition or as a cleaning composition or as a dishwashing composition have an area in the plane of the polymer layers of at least 1 cm², more preferably of at least 2 cm², especially of at least 3 cm³.

Preferably, the multilayer films for use as a washing composition or as a cleaning composition or as a dishwashing composition have an area in the plane of the polymer layers of 1 to 500 cm², more preferably of 2 to 400 cm², especially of 3 to 300 cm².

Preferably, the multilayer films for use as a washing composition or as a cleaning composition or as a dishwashing composition have a volume of 1 to 100 cm³, more preferably of 2 to 80 cm³, especially of 3 to 60 cm³.

The outer shape of the multilayer films for use as a washing composition or as a cleaning composition or as a dishwashing composition is generally uncritical. Suitable structures are those having an essentially round, elliptical or rectangular footprint. For aesthetic reasons, it is also possible to choose other shapes, such as leaves, flowers, animals, etc.

The multilayer films of the invention are advantageously also suitable for use for packaging of washing, cleaning and dishwashing compositions as portions. They are firstly specifically suitable for production of a sheath comprising washing, cleaning or dishwashing compositions in solid or liquid or gel form or at least one of the components thereof. The multilayer films of the invention are additionally suitable for production of a coating on a solid washing, cleaning or dishwashing composition or on at least one solid component thereof. The multilayer films dissolve at the start of the respective use (for example in the washing or rinse water), thus release the constituents of the washing and cleaning composition and, in dissolved form, because of their dispersing, film-inhibiting, emulsifying and surfactant properties, contribute considerably to the washing and cleaning performance. The multilayer films of the invention do not just improve the washing power, i.e. actively help to remove soil from the fabric or from hard surfaces such as ceramic, glass, plastic and metal, but also prevent (re)deposition of detached soil and sparingly soluble salts of the water hardness ions on concomitantly washed fabric or hard surfaces, meaning that they have a graying-inhibiting and deposition-inhibiting effect. They especially prevent the redeposition of particulate soil, for example clay particles, soot particles and color pigments, and the deposition of sparingly soluble salts of the water hardness ions, such as the carbonates and silicates of calcium(II) and magnesium (II) ions. Because of their washing effect, they are especially suitable for formulation of laundry detergents.

The washing or cleaning composition portions of the invention comprise, as sheath and/or coating, at least one washing- or cleaning-active multilayer film of the invention. The layers of the multilayer film may comprise washing-active or cleaning-active components as additives. In addition, the washing or cleaning composition portions of the invention comprise measured amounts of at least one washing-active or cleaning-active composition within the sheath or coating. It is possible here that the washing composition or cleaning composition portions comprise just one individual washing- or cleaning-active composition. It is also possible that the washing composition or cleaning composition portions of the invention comprise two or more than two different washing- or cleaning-active compositions. The different compositions may be surrounded by the same or different sheath and/or coating. In this case, at least one of the sheaths and/or coatings comprises a washing- or cleaning-active multilayer film of the invention. The different compositions may differ with regard to the concentration of the individual components (in quantitative terms) and/or with regard to the nature of the individual components (in qualitative terms). It is more preferable that the components, in terms of type and concentration, are matched to the tasks that the active ingredient portion packages have to fulfill in the washing or cleaning operation.

The multilayer films of the invention are also advantageously suitable for production of what are called multichamber systems. Multichamber systems have 2, 3, 4, 5 or more than 5 chambers which each comprise a single component or a plurality of components of a washing or cleaning composition. This may in principle be a single washing- or cleaning-active ingredient, a single auxiliary or any desired mixture of two or more than two active ingredients and/or auxiliaries. The constituents of the individual chambers may each be in liquid, gel or solid form. Multichamber systems are an option, for example, in order to separate components of a washing or cleaning composition that are incompatible or not very compatible from one another. For example one chamber may comprise one or more enzyme(s) and another chamber at least one bleach. Multichamber systems are also an option, for example, in order to facilitate controlled release of a particular component, for example at a certain time point in the washing or cleaning operation. For this purpose, for example, it is possible to use film materials of different material thickness. In addition, individual chambers can be produced using a multilayer film of the invention and others using a different conventional film.

Where statements are made hereinafter regarding the qualitative and quantitative composition of washing and cleaning compositions, these shall always encompass the overall formulation composed of multilayer film and ensheathed or coated components. In the case of formulation of this composition as a multichamber system, the chambers may each comprise an individual component or a plurality of components of the formulation, or the total amount of any component may be divided between two or more than two chambers.

The washing composition or cleaning composition or dishwashing composition portions of the invention comprise at least one washing- or cleaning-active composition within. These compositions may be any desired substances or substance mixtures that are of relevance in connection with a washing or cleaning operation. These are primarily the actual washing compositions or cleaning compositions with their individual components explained in detail hereinafter.

In the context of the present invention, washing compositions are understood to mean those compositions which are used for cleaning of flexible materials having high absorptivity, for example of materials having a textile character, whereas cleaning compositions in the context of the present invention are understood to mean those compositions which are used for cleaning of materials having a closed surface, i.e. having a surface which has only few small pores, if any, and as a result has only low absorptivity, if any.

Examples of flexible materials having high absorptivity are those which comprise or consist of natural, synthetic or semisynthetic fiber materials and which accordingly generally have at least some textile character. The fibrous materials or those consisting of fibers may in principle be in any form that occurs in use or manufacture and processing. For example, fibers may be in unordered form in the form of staple or aggregate, in ordered form in the form of fibers, yarns, threads, or in the form of three-dimensional structures such as nonwoven fabrics, lodens or felt, woven fabrics, knitted fabrics, in all conceivable binding types. The fibers may be raw fibers or fibers in any desired stages of processing. Examples are natural protein or cellulose fibers, such as wool, silk, cotton, sisal, hemp or coconut fibers, or synthetic fibers, for example polyester, polyamide or polyacrylonitrile fibers.

Examples of materials having only few and small pores, if any, and having zero or only low absorptivity are metal, glass, enamel or ceramic. Typical objects made of these materials are, for example, metallic sinks, cutlery, glass and porcelain dishware, bathtubs, washbasins, tiles, flags, cured synthetic resins, for example decorative melamine resin surfaces on kitchen furniture or painted metal surfaces, for example refrigerators and car bodies, printed circuit boards, microchips, sealed or painted woods, e.g. parquet or wall cladding, window frames, doors, plastics coverings such as floor coverings made of PVC or hard rubber, or rigid or flexible foams having substantially closed surfaces.

Examples of cleaning compositions which may comprise the washing- and cleaning-active multilayer film of the invention include washing and cleaning compositions, dishwashing compositions such as manual dishwashing compositions or machine dishwashing compositions (=dishwashing composition for the machine dishwasher), metal degreasers, glass cleaners, floor cleaners, all-purpose cleaners, high-pressure cleaners, neutral cleaners, alkaline cleaners, acidic cleaners, spray degreasers, dairy cleaners, commercial kitchen cleaners, machinery cleaners in industry, especially the chemical industry, cleaners for carwashing and also domestic all-purpose cleaners.

The washing, cleaning or dishwashing compositions of the invention may be compositions comprising a polymer composition P1) of the invention in the sheath or coating. The washing, cleaning or dishwashing compositions of the invention may also be portions of washing or cleaning compositions in solid, liquid or gel form packaged in pouches. In a specific embodiment, these are called pouches (liquid tabs). The products may also be compressed shaped bodies such as tablets (“tabs”), blocks, briquettes, etc. In a specific embodiment, they are tableted washing or cleaning compositions. In a further particularly preferred embodiment, they are then tableted dishwashing compositions, especially tableted machine dishwashing compositions.

Tableted dishwashing compositions may be simple tabs or else what are called “2 in 1”, “3 in 1”, “5 in 1” or “7 in 1” products (multifunctional products). Further details of these formulations can be found in Hermann G. Hauthal, G. Wagner (eds.), Reinigungs-und Pflegemittel im Haushalt [Domestic Cleaning and Care Products], Verlag für chemische Industrie, H. Ziolkowsky GmbH, Augsburg 2003, Chapter 4.2, pages 161-184. “2 in 1” products comprise, as well as the customary constituents of machine dishwashing compositions, additionally a rinse aid. “3 in 1” products also comprise a water softener. “5 in 1” products generally also comprise a glass protector and a rinsing power enhancer. “7 in 1” products also comprise a stainless steel brightener and a deincrustation agent. In these tableted dishwashing compositions, the polymer composition P1) of the invention may be present in the rinse aid core, or it is present in solid form in the tableted dishwashing composition.

Washing and Cleaning Compositions

The washing or cleaning composition of the invention preferably comprises the following constituents:
A) at least one sheath and/or coating comprising or consisting of a washing- and cleaning-active multilayer film of the invention,
B) at least one surfactant,
C) optionally at least one builder,
D) optionally at least one bleach system,
E) optionally at least one further additive, preferably selected from enzymes, enzyme stabilizers, bases, corrosion inhibitors, defoamers and foam inhibitors, dyes, fragrances, fillers, tableting aids, disintegrants, thickeners, solubilizers, organic solvents, electrolytes, pH modifiers, perfume carriers, bitter substances, fluorescers, hydrotropes, antiredeposition agents, optical brighteners, graying inhibitors, antishrink agents, anticrease agents, dye transfer inhibitors, antimicrobial active ingredients, antioxidants, anti-yellowing agents, corrosion inhibitors, antistats, ironing aids, hydrophobizing and impregnating agents, antiswell and antislip agents and UV absorbers, and
F) optionally water.

In the context of the present invention, the builder C) also comprises compounds referred to as sequestrant, complexing agent, chelator, chelating agent or softener.

The bleach systems D) comprise, as well as bleaches, optionally also bleach activators, bleach catalysts and/or bleach stabilizers.

More preferably, the washing and cleaning composition of the invention comprises at least one enzyme as additive E).

A preferred embodiment relates to washing or cleaning compositions in liquid or gel form, comprising:
A) 0.1% to 20% by weight of at least one sheath and/or coating comprising or consisting of a washing- and cleaning-active multilayer film of the invention,
B) 1% to 80% by weight of at least one surfactant,
C) 0.1% to 50% by weight of at least one builder,
D) 0% to 20% by weight of a bleach system,
E) 0.1% to 60% by weight of at least one further additive, preferably selected from enzymes, enzyme stabilizers, bases, corrosion inhibitors, defoamers and foam inhibitors, dyes, fragrances, fillers, tableting aids, disintegrants, thickeners, solubilizers, organic solvents, electrolytes, pH modifiers, perfume carriers, bitter substances, fluorescers, hydrotropes, antiredeposition agents, optical brighteners, graying inhibitors, antishrink agents, anticrease agents, dye transfer inhibitors, antimicrobial active ingredients, antioxidants, anti-yellowing agents, corrosion inhibitors, antistats, ironing aids, hydrophobizing and impregnating agents, antiswell and antislip agents and UV absorbers, and
F) 0% to 98.7% by weight of water.

The percent by weight data relate to the total weight of the washing and cleaning composition. The weight amounts of A) to F) add up to 100% by weight.

Preferably, the washing or cleaning compositions in liquid or gel form comprise up to 70% by weight of water, more preferably up to 50% by weight of water, especially up to 30% by weight of water.

A further preferred embodiment relates to solid washing or cleaning compositions comprising:
A) 0.1% to 20% by weight of at least one sheath and/or coating comprising or consisting of a washing- and cleaning-active multilayer film of the invention,
B) 1% to 50% by weight of at least one surfactant,
C) 0.1% to 70% by weight of at least one builder,
D) 0% to 30% by weight of a bleach system,
E) 0.1% to 70% by weight of at least one further additive, preferably selected from enzymes, enzyme stabilizers, bases, corrosion inhibitors, defoamers and foam inhibitors, dyes, fragrances, fillers, tableting aids, disintegrants, thickeners, solubilizers, organic solvents, electrolytes, pH modifiers, perfume carriers, bitter substances, fluorescers, hydrotropes, antiredeposition agents, optical brighteners, graying inhibitors, antishrink agents, anticrease agents, dye transfer inhibitors, antimicrobial active ingredients, antioxidants, anti-yellowing agents, corrosion inhibitors, antistats, ironing aids, hydrophobizing and impregnating agents, antiswell and antislip agents and UV absorbers, and
F) optionally water.

The percent by weight data relate to the total weight of the washing and cleaning composition. The weight amounts of A) to F) add up to 100% by weight.

Component A) With regard to suitable and preferred washing- and cleaning-active multilayer films of the invention, reference is made to the details above.

Component B)

The washing and cleaning compositions of the invention comprise at least one surfactant as component B). Suitable surfactants B) are nonionic, anionic, cationic or amphoteric surfactants.

Examples of surfactants B) which may be used in the context of the present invention include nonionic surfactants (NIS). Nonionic surfactants used are preferably alkoxylated alcohols. Preference is given to alkoxylated primary alcohols. Preferred alkoxylated alcohols are ethoxylated alcohols having preferably 8 to 18 carbon atoms in the alkyl radical and an average of 1 to 12 mol of ethylene oxide (EO) per mole of alcohol. The alcohol radical may be linear or preferably 2-methyl-branched or may comprise linear and methyl-branched radicals in a mixture, as typically present in oxo process alcohol radicals. Especially preferred are alcohol ethoxylates having linear or branched radicals from alcohols of native or petrochemical origin having 12 to 18 carbon atoms, for example from coconut alcohol, palm alcohol, tallow alcohol or oleyl alcohol, and an average of 2 to 8 EO per mole of alcohol.

The ethoxylated alcohols are preferably selected from:
C₁₂C₁₄-alcohols with 3 EO, 5 EO, 7 EO or 9 EO,
C₉C₁₁-alcohols with 7 EO,
C₁₃-oxo process alcohols with 3 EO, 5 EO, 7 EO or 9 EO,
C₃C₁₅-alcohols with 3 EO, 5 EO, 7 EO or 9 EO,
C₁₂C₁₈-alcohols with 3 EO, 5 EO, 7 EO or 9 EO and mixtures thereof,
2-propylheptanol with 3 EO, 4 EO, 5 EO, 6 EO, 7 EO, 8 EO and 9 EO

and mixtures of two or more than two of the aforementioned ethoxylated alcohols.

A preferred mixture of nonionic surfactants is a mixture of C₁₂C₁₄-alcohol (lauryl alcohol/myristyl alcohol) with 3 EO and C₁₂C₁₈-alcohol (lauryl alcohol/myristyl alcohol/cetyl alcohol/stearyl alcohol) with 7 EO. Preference is also given to mixtures of short-chain alcohol ethoxylates (e.g. 2-propylheptanol with 7 EO) and long-chain alcohol ethoxylates (e.g. C₁₆C₁₈ with 7 EO).

The stated ethoxylation levels are statistical averages (number averages, Mn), which may be an integer or a fraction for a specific product. Preferred alcohol ethoxylates have a narrowed homolog distribution (narrow range ethoxylates, NRE). In addition to these nonionic surfactants, it is also possible to use fatty alcohols with more than 12 EO. Examples of these are tallow alcohol with 14 EO, 25 EO, 30 EO or 40 EO. Also usable are nonionic surfactants comprising ethylene oxide (EO) and propylene oxide (PO) groups together in the molecule. It is possible here to use block copolymers with EO-PO block units or PO-EO block units, but also EO-PO-EO copolymers or PO-EO-PO copolymers. It is of course also possible to use mixedly alkoxylated nonionic surfactants in which EO and PO units are not in blocks but in random distribution. Such products are obtainable by simultaneous action of ethylene oxide and propylene oxide on fatty alcohols.

Surfactants suitable as component B) are also polyetherols, preferably with a number-average molecular weight of at least 200 g/mol.

Suitable polyetherols may be linear or branched, preferably linear. Suitable polyetherols generally have a number-average molecular weight in the range from about 200 to 100 000 g/mol, preferably 300 to 50 000 g/mol, more preferably 500 to 40 000 g/mol. Suitable polyetherols are, for example, water-soluble or water-dispersible nonionic polymers having repeat alkylene oxide units. Preferably, the proportion of repeat alkylene oxide units is at least 30% by weight, based on the total weight of the compound. Suitable polyetherols are polyalkylene glycols, such as polyethylene glycols, polypropylene glycols, polytetrahydrofurans and alkylene oxide copolymers. Suitable alkylene oxides for preparation of alkylene oxide copolymers are, for example, ethylene oxide, propylene oxide, epichlorohydrin, 1,2- and 2,3-butylene oxide. Suitable examples are copolymers of ethylene oxide and propylene oxide, copolymers of ethylene oxide and butylene oxide, and copolymers of ethylene oxide, propylene oxide and at least one butylene oxide. The alkylene oxide copolymers may comprise the copolymerized alkylene oxide units in randomly distributed form or in the form of blocks. Preferably, the proportion of repeat units derived from ethylene oxide in the ethylene oxide/propylene oxide copolymers is 40% to 99% by weight. Particular preference is given to ethylene oxide homopolymers and ethylene oxide/propylene oxide copolymers.

In addition, further nonionic surfactants which may be used are also alkyl glycosides of the general formula (IV)

R¹⁰O(G)ᵢ (IV)

in which
R¹⁰ is a primary straight-chain or methyl-branched aliphatic radical having 8 to 22 carbon atoms,
G is a glycoside unit having 5 or 6 carbon atoms, and
i is any number between 1 and 10.

In the compounds of the formula (IV), R¹⁰ is preferably a 2-methyl-branched aliphatic radical having 8 to 22 and preferably 12 to 18 carbon atoms.
G is preferably glucose.

The oligomerization level i, which states the distribution of monoglycosides and oligoglycosides, is preferably within a range from 1.2 to 1.4.

A further class of nonionic surfactants which are used with preference in the context of the present invention and are used either as the sole nonionic surfactant or in combination with other nonionic surfactants is that of alkoxylated, preferably ethoxylated or ethoxylated and propoxylated, fatty acid alkyl esters, preferably having 1 to 4 carbon atoms in the alkyl chain. Especially preferred are fatty acid methyl esters as described, for example, in the Japanese patent application JP 58/217598, or those which are preferably prepared by the process described in the international patent application WO 90/13533.

Further suitable nonionic surfactants are amine oxides, for example N-cocoalkyl-N,N-dimethylamine oxide and N-tallowalkyl-N,N-dihydroxyethylamine oxide, and fatty acid alkanolamides. These nonionic surfactants are preferably used as a mixture with alkoxylated alcohols. Preference is given to the mixture with ethoxylated fatty alcohols.

The weight amount of these nonionic surfactants is preferably not more than that of the ethoxylated fatty alcohols, especially not more than half thereof.

Further suitable surfactants B) are polyhydroxy fatty acid amides of the formula (V)

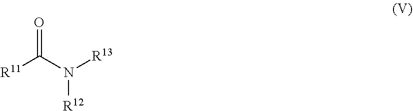

in which the R¹¹—C(═O) group is an aliphatic acyl radical having 6 to 22 carbon atoms, R¹² is hydrogen, an alkyl radical having 1 to 4 carbon atoms or a hydroxyalkyl radical having 1 to 4 carbon atoms, and R¹³ is a linear or branched polyhydroxyalkyl radical having 3 to 10 carbon atoms and 3 to 10 hydroxyl groups. The polyhydroxy fatty acid amides are known substances which can typically be obtained by reductive amination of a reducing sugar with ammonia, an alkylamine or an alkanolamine and subsequent acylation with a fatty acid, a fatty acid alkyl ester or a fatty acid chloride. The group of polyhydroxy fatty acid amides includes in this connection also compounds of the formula (VI)

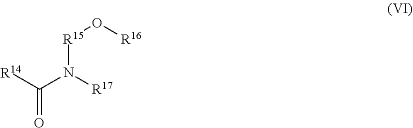

in which R¹⁴ is a linear or branched alkyl or alkenyl radical having 7 to 12 carbon atoms, R¹⁵ is a linear, branched or cyclic alkylene radical having 2 to 8 carbon atoms or an arylene radical having 6 to 8 carbon atoms, and R¹⁶ is a linear, branched or cyclic alkyl radical or an aryl radical or an oxyalkyl radical having 1 to 8 carbon atoms, preference being given to C₁-C₄-alkyl or phenyl radicals, and R¹⁷ is a linear polyhydroxyalkyl radical wherein the alkyl chain is substituted by at least two hydroxyl groups, or alkoxylated, preferably ethoxylated or propoxylated derivatives of this radical. R¹⁷ is preferably obtained by reductive amination of a sugar, for example glucose, fructose, maltose, lactose, galactose, mannose or xylose. The N-alkoxy- or N-aryloxy-substituted compounds can then be converted to the desired polyhydroxy fatty acid amides, for example according to WO 95/07331 by reaction with fatty acid methyl esters in the presence of an alkoxide as catalyst.

Suitable surfactants B) are also anionic surfactants. Typical examples of anionic surfactants are soaps, alkylsulfonates, alkylbenzenesulfonates, olefinsulfonates, methyl ester sulfonates, sulfo fatty acids, alkyl sulfates, mono- and dialkyl sulfosuccinates, mono- and dialkyl sulfosuccinamates, sulfotriglycerides, amide soaps, ethercarboxylic acids and salts thereof, fatty acid isethionates, fatty acid sarcosinates, fatty acid taurides, N-acylamino acids, for example acyl lactylates, acyl tartrates, acyl glutamates and acyl aspartates, alkyl oligoglucoside sulfates, alkylglucose carboxylates, protein fatty acid condensates and alkyl (ether) phosphates.

A first preferred embodiment is that of anionic surfactants of the sulfonate and sulfate types. Preferred surfactants of the sulfonate type are C₉-C₁₃-alkylbenzene sulfonates, olefinsulfonates, i.e. mixtures of alkene- and hydroxyalkanesulfonates, and disulfonates as obtained, for example, from C₁₂-C₁₈-monoolefins having a terminal or internal double bond by sulfonation with gaseous sulfur trioxide and subsequent alkaline or acidic hydrolysis of the sulfonation products. Also suitable are alkanesulfonates which are obtained from C₁₂-C₁₈-alkanes, for example, by sulfochlorination or sulfoxidation with subsequent hydrolysis and/or neutralization. Also likewise suitable are the esters of α-sulfo fatty acids (estersulfonates), for example the α-sulfonated methyl esters of hydrogenated coconut, palm kernel or tallow fatty acids. Further suitable anionic surfactants are sulfated fatty acid glycerol esters. Fatty acid glycerol esters are understood to mean, inter alia, the mono-, di- and triesters, and mixtures thereof, as obtained in the preparation by esterification of a monoglycerol with 1 to 3 mol of fatty acid or in the transesterification of triglycerides with 0.3 to 2 mol of glycerol. Preferred sulfated fatty acid glycerol esters here are the sulfation products of saturated fatty acids having 6 to 22 carbon atoms, for example of caproic acid, caprylic acid, capric acid, myristic acid, lauric acid, palmitic acid, stearic acid or behenic acid.

Preferred alk(en)yl sulfates are the alkali metal and especially the sodium salts of the sulfuric monoesters of C₁₂-C₁₈-fatty alcohols, for example of coconut alcohol, tallow alcohol or lauryl, myristyl, cetyl or stearyl alcohol, or of the C₁₀-C₂₀-oxo process alcohols and the monoesters of secondary C₁₀-C₂₀-alcohols. Additionally preferred are alk(en)yl sulfates comprising a synthetic petrochemical-based straight-chain C₁₀-C₂₀-alkyl radical. These have analogous degradation behavior to the equivalent compounds based on oleochemical raw materials. From the point of view of washing, preference is given to the C₁₂-C₁₆-alkyl sulfates and C₁₂-C₁₅-alkyl sulfates, and also C₁₄-C₁₅-alkyl sulfates. 2,3-Alkyl sulfates, which are prepared, for example, according to U.S. Pat. No. 3,234,258 or 5,075,041 and can be obtained as commercial products from Shell Oil Company under the DAN® name, are also suitable anionic surfactants. Also suitable among other substances are the sulfuric monoesters of the straight-chain or branched C₇-C₂₁ alcohols which have been ethoxylated with 1 to 6 mol of ethylene oxide, such as 2-methyl-branched C₉-C₁₁ alcohols with an average of 3.5 mol of ethylene oxide (EO) or C₁₂-C₁₈ fatty alcohols with 1 to 4 EO. Owing to their high foaming level, they are conventionally used in cleaning compositions only in relatively small amounts, for example in amounts of 1% to 5% by weight. Further suitable anionic surfactants in the context of the present invention are also the salts of alkylsulfosuccinic acid, which are also referred to as sulfosuccinates or as sulfosuccinic acid esters and are the monoesters and/or diesters of sulfosuccinic acid with alcohols, preferably fatty alcohols and especially ethoxylated fatty alcohols. Preferred sulfosuccinates comprise C₈-C₁₈ fatty alcohol radicals or mixtures of these. Particularly preferred sulfosuccinates comprise a fatty alcohol radical derived from ethoxylated fatty alcohols. Particular preference is given here in turn to sulfosuccinates wherein the fatty alcohol radicals are derived from ethoxylated fatty alcohols having a narrow homolog distribution. It is likewise also possible to use alk(en)ylsuccinic acid having preferably 8 to 18 carbon atoms in the alk(en)yl chain or salts thereof.

Particularly preferred anionic surfactants are soaps. Saturated and unsaturated fatty acid soaps are suitable, such as the salts of lauric acid, myristic acid, palmitic acid, stearic acid, (hydrogenated) erucic acid and behenic acid, and especially soap mixtures derived from natural fatty acids, for example coconut fatty acids, palm kernel fatty acids, olive oil fatty acids or tallow fatty acids.

The anionic surfactants including the soaps may be present in the form of their sodium, potassium or ammonium salts, or as soluble salts of organic bases, such as mono-, di- or triethanolamine. The anionic surfactants are preferably in the form of their sodium or potassium salts, especially in the form of the sodium salts.

Suitable surfactants B) are also cationic surfactants. Particularly preferred cationic surfactants are:
C₇-C₂₅-alkylamines;
N, N-dimethyl-N-(hydroxy-C₇-C₂₅-alkyl)ammonium salts;
mono- and diC₇-C₂₅-alkyl)dimethylammonium compounds quaternized with alkylating agents;
ester quats, especially quaternary esterified mono-, di- and trialkanolamines esterified with C₈-C₂₂-carboxylic acids;
imidazoline quats, especially 1-alkylimidazolinium salts of the formulae VII or VIII

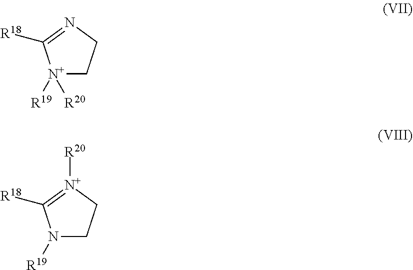

where the variables are defined as follows:
R¹⁸ is C₁-C₂₅-alkyl or C₂-C₂₅-alkenyl,
R¹⁹ is C₁-C₄-alkyl or hydroxy-C₁-C₄-alkyl,
R²⁰ is C₁-C₄-alkyl, hydroxy-C₁-C₄-alkyl or an R²¹—(CO)—R²²—(CH₂)ᵣ radical where R²¹ is H or C₁-C₄-alkyl, R²² is —O— or —NH— and r is 2 or 3,

where at least one R¹⁸ radical is a C₇-C₂₂-alkyl radical.

The surfactants B) may also be amphoteric surfactants. Suitable amphoteric surfactants are alkyl betaines, alkyl amidobetaines, alkyl sulfobetaines, aminopropionates, aminoglycinates and amphoteric imidazolium compounds. For example, it is possible to use cocodimethylsulfopropyl betaine, lauryl betaine, cocamidopropyl betaine, sodium cocamphopropionate or tetradecyldimethylamine oxide.

The content of surfactants in washing and cleaning compositions in liquid and gel form is preferably 2% to 75% by weight and especially 5% to 65% by weight, based in each case on the overall composition.

The content of surfactants in solid washing and cleaning compositions is preferably 2% to 40% by weight and especially 5% to 35% by weight, based in each case on the overall composition.

Component C)

Builders, which are sometimes also referred to as sequestrant, complexing agent, chelator, chelating agent or softener, bind alkaline earth metals and other water-soluble metal salts without precipitation. They help to break up soil, disperse soil particles and help to detach soil, and sometimes themselves have a washing effect.

Suitable builders may either be organic or inorganic in nature. Examples are aluminosilicates, carbonates, phosphates and polyphosphates, polycarboxylic acids, polycarboxylates, hydroxycarboxylic acids, phosphonic acids, e.g. hydroxyalkylphosphonic acids, phosphonates, aminopolycarboxylic acids and salts thereof and polymeric compounds containing carboxylic acid groups, and salts thereof.

Suitable inorganic builders are, for example, crystalline or amorphous aluminosilicates having ion-exchanging properties, such as zeolites. Different types of zeolites are suitable, especially zeolites A, X, B, P, MAP and HS in their sodium form or in forms in which sodium has been partly exchanged for other cations such as Li, K, Ca, Mg or ammonium. Suitable zeolites are described, for example, in U.S. Pat. No. 4,604,224. Crystalline silicates suitable as builders are, for example, disilicates or sheet silicates, e.g. 5-Na₂Si₂O₅ or B—Na₂Si₂O₅(SKS 6 or SKS 7). The silicates can be used in the form of their alkali metal, alkaline earth metal or ammonium salts, preferably as sodium, lithium and magnesium silicates. Likewise usable are amorphous silicates, for example sodium metasilicate having a polymeric structure, or amorphous disilicate (Britesil® H 20, manufacturer: Akzo). Among these, preference is given to sodium disilicate.

Suitable inorganic builder substances based on carbonate are carbonates and hydrogencarbonates. These can be used in the form of their alkali metal, alkaline earth metal or ammonium salts. Preference is given to using sodium carbonates and hydrogencarbonates, lithium carbonates and hydrogencarbonates and magnesium carbonates and hydrogencarbonates, especially sodium carbonate and/or sodium hydrogencarbonate.

Customary phosphates used as inorganic builders are alkali metal orthophosphates and/or polyphosphates, for example pentasodium triphosphate.

Suitable organic builders are, for example, C₄-C₃₀-di-, -tri- and -tetracarboxylic acids, for example succinic acid, propanetricarboxylic acid, butanetetracarboxylic acid, cyclopentanetetracarboxylic acid and alkyl- and alkenylsuccinic acids having C₂-C₂₀-alkyl or -alkenyl radicals.

Suitable organic builders are also hydroxycarboxylic acids and polyhydroxycarboxylic acids (sugar acids). These include C₄-C₂₀-hydroxycarboxylic acids, for example malic acid, tartaric acid, gluconic acid, mucic acid, lactic acid, glutaric acid, citric acid, tartronic acid, glucoheptonic acid, lactobionic acid, and sucrosemono-, -di- and -tricarboxylic acid. Among these, preference is given to citric acid and salts thereof.

Suitable organic builders are additionally phosphonic acids, for example hydroxy alkylphosphonic acids, aminophosphonic acids and the salts thereof. These include, for example, phosphonobutanetricarboxylic acid, aminotrismethylenephosphonic acid, ethylenediaminetetraethylenephosphonic acid, hexamethylenediaminetetramethylene phosphonic acid, diethylenetriaminepentamethylenephosphonic acid, morpholino methanediphosphonic acid, 1-hydroxy-C₁- to -C₁₀-alkyl-1,1-diphosphonic acids such as 1-hydroxyethane-1,1-diphosphonic acid. Among these, preference is given to 1-hydroxyethane-1,1-diphosphonic acid and salts thereof.

Suitable organic builders are also aminopolycarboxylic acids, such as nitrilotriacetic acid (NTA), nitrilomonoacetic dipropionic acid, nitrilotripropionic acid, β-alaninediacetic acid (β-ADA), ethylenediaminetetraacetic acid (EDTA), diethylenetriaminepentaacetic acid, propylene-1,3-diaminetetraacetic acid, propylene-1,2-diaminetetraacetic acid, N-(alkyl)ethylenediaminetriacetic acid, N-(hydroxyalkyl)-ethylenediaminetriacetic acid, ethylenediaminetriacetic acid, cyclohexylene-1,2-diaminetetraacetic acid, iminodisuccinic acid, hydroxyiminodisuccinic acid, ethylenediaminedisuccinic acid, serinediacetic acid, isoserinediacetic acid, L-asparaginediacetic acid, L-glutamine diacetic acid, glutamic acid, diacetic acid, methylglycinediacetic acid (MGDA) and the salts of the aforementioned aminopolycarboxylic acids. Preference is given to methylglycinediacetic acid, glutamic acid diacetic acid and salts thereof. The salts of methylglycinediacetic acid may be in racemic form, meaning that D and L enantiomers are present in an equimolar mixture, or one enantiomer, e.g. the L enantiomer, may be present in excess.

Suitable organic builders are also polymeric compounds containing carboxylic acid groups, such as acrylic acid homopolymers. These preferably have a number-average molecular weight in the range from 800 to 70 000 g/mol, more preferably from 900 to 50 000 g/mol, particularly 1000 to 20 000 g/mol and especially 1000 to 10 000 g/mol. In this context, the term “acrylic acid homopolymer” also encompasses polymers in which the carboxylic acid groups are in partly or fully neutralized form. These include acrylic acid homopolymers in which the carboxylic acid groups are present partly or completely in the form of alkali metal salts or ammonium salts. Preference is given to acrylic acid homopolymers in which the carboxylic acid groups are protonated or are partly or completely in the form of sodium salts.

Suitable polymeric compounds containing carboxylic acid groups are also oligomaleic acids, as described, for example, in EP-A 451 508 and EP-A 396 303.

Suitable polymeric compounds containing carboxylic acid groups are also terpolymers of unsaturated C₄-C₈ dicarboxylic acids, which may include copolymerized monoethylenically unsaturated monomers from the group (i) mentioned below in amounts of up to 95% by weight, from the group (ii) in amounts of up to 60% by weight and from the group (iii) in amounts of up to 20% by weight as comonomers. Suitable unsaturated C₄-C₈ dicarboxylic acids here are, for example, maleic acid, fumaric acid, itaconic acid and citraconic acid. Preference is given to maleic acid. Group (i) encompasses monoethylenically unsaturated C₃-C₈ monocarboxylic acids, for example acrylic acid, methacrylic acid, crotonic acid and vinylacetic acid. From group (i), preference is given to using acrylic acid and methacrylic acid. Group (ii) encompasses monoethylenically unsaturated C₂-C₂₂ olefins, vinyl alkyl ethers having C₁-C₈-alkyl groups, styrene, vinyl esters of C₁-C₈ carboxylic acids, (meth)acrylamide and vinylpyrrolidone. From group (ii), preference is given to using C₂-C₆ olefins, vinyl alkyl ethers having C₁-C₄-alkyl groups, vinyl acetate and vinyl propionate. If the polymers of group (ii) comprise copolymerized vinyl esters, these may also be in partly or fully hydrolyzed form to give vinyl alcohol structural units. Suitable co- and terpolymers are known, for example, from U.S. Pat. No. 3,887,806 and DE-A 4313909. Group (iii) encompasses (meth)acrylic esters of C₁-C₈ alcohols, (meth)acrylonitrile, (meth)acrylamides of C₁-C₈ amines, N-vinylformamide and N-vinylimidazole.

Suitable polymeric compounds containing carboxylic acid groups are also homopolymers of the monoethylenically unsaturated C₃-C₈ monocarboxylic acids, for example acrylic acid, methacrylic acid, crotonic acid and vinylacetic acid, especially of acrylic acid and methacrylic acid, copolymers of dicarboxylic acids, for example copolymers of maleic acid or itaconic acid and acrylic acid in a weight ratio of 10:90 to 95:5, more preferably those in a weight ratio of 30:70 to 90:10 with molar masses of 1000 to 150 000 g/mol; terpolymers of maleic acid, acrylic acid and a vinyl ester of a C₁-C₃ carboxylic acid in a weight ratio of 10 (maleic acid):90 (acrylic acid+vinyl ester) to 95 (maleic acid):10 (acrylic acid+vinyl ester), where the weight ratio of acrylic acid to the vinyl ester may vary within the range from 30:70 to 70:30; copolymers of maleic acid with C₂-C₈ olefins in a molar ratio of 40:60 to 80:20, particular preference being given to copolymers of maleic acid with ethylene, propylene or isobutene in a molar ratio of 50:50.

Suitable polymeric compounds containing carboxylic acid groups are also copolymers of 50% to 98% by weight of ethylenically unsaturated weak carboxylic acids with 2% to 50% by weight of ethylenically unsaturated sulfonic acids, as described, for example, in EP-A-0877002. Suitable weak ethylenically unsaturated carboxylic acids are especially C₃-C₆ monocarboxylic acids, such as acrylic acid and methacrylic acid. Suitable ethylenically unsaturated sulfonic acids are 2-acetylamidomethyl-1-propanesulfonic acid, 2-methacrylamido-2-methyl-1-propanesulfonic acid, 2-methacrylamido-2-hydroxy propanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 3-sulfopropyl methacrylate, sulfomethylacrylamide, sulfomethylmethacrylamide and salts of these acids. The copolymers may also comprise 0% to 30% by weight of copolymerized ethylenically unsaturated C₄-C₈ dicarboxylic acids, such as maleic acid, and 0% to 30% by weight of at least one monomer copolymerizable with the aforementioned monomers. The latter monomer comprises, for example, C₁-C₄-alkyl esters of (meth)acrylic acid, C₁-C₄-hydroxyalkyl esters of (meth)acrylic acid, acrylamide, alkyl-substituted acrylamide, N,N-dialkyl-substituted acrylamide, vinylphosphonic acid, vinyl acetate, allyl alcohols, sulfonated allyl alcohols, styrene and other vinylaromatics, acrylonitrile, N-vinylpyrrolidone, N-vinyl formamide, N-vinylimidazole or N-vinylpyridine. The weight-average molecular weight of these copolymers is in the range from 3000 to 50 000 daltons. Copolymers with about 77% by weight of at least one ethylenically unsaturated C₃-C₆ monocarboxylic acid and about 23% by weight of at least one ethylenically unsaturated sulfonic acid are particularly suitable.

Graft polymers of unsaturated carboxylic acids onto low molecular weight carbohydrates or hydrogenated carbohydrates, cf. U.S. Pat. No. 5,227,446, DE-A 4415623 and DE-A 4313909, are likewise suitable. Suitable unsaturated carboxylic acids here are, for example, maleic acid, fumaric acid, itaconic acid, citraconic acid, acrylic acid, methacrylic acid, crotonic acid and vinylacetic acid, and mixtures of acrylic acid and maleic acid, which are grafted on in amounts of 40% to 95% by weight, based on the component to be grafted. For the modification, it is additionally possible for up to 30% by weight, based on the component to be grafted, of further monoethylenically unsaturated monomers to be present in copolymerized form. Suitable modifying monomers are the aforementioned monomers of groups (ii) and (iii). Suitable graft bases are degraded polysaccharides, for example acidically or enzymatically degraded starches, inulins or cellulose, protein hydrolyzates and reduced (hydrogenated or reductively aminated) degraded polysaccharides, for example mannitol, sorbitol, aminosorbitol and N-alkylglucamine, and also polyalkylene glycols having molar masses with up to M_{w}=5000, for example polyethylene glycols, ethylene oxide/propylene oxide or ethylene oxide/butylene oxide or ethylene oxide/propylene oxide/butylene oxide block copolymers and alkoxylated mono- or polyhydric C₁-C₂₂ alcohols (cf. U.S. Pat. No. 5,756,456).

Likewise suitable are polyglyoxylic acids as described, for example, in EP-B-001004, U.S. Pat. No. 5,399,286, DE-A-4106355 and EP-A-656914. The end groups of the polyglyoxylic acids can have different structures.

Also suitable are polyamidocarboxylic acids and modified polyamidocarboxylic acids; these are known, for example, from EP-A-454126, EP-B-511037, WO-A94/01486 and EP-A-581452.

It is also possible to use polyaspartic acids and the alkali metal salts thereof or cocondensates of aspartic acid with other amino acids, for example with glycine, glutamic acid or lysine, C₄-C₂₅ mono- or dicarboxylic acids and/or C₄-C₂₅ mono- or diamines as polymeric compounds containing carboxylic acid groups.

Among the polymeric compounds containing carboxylic acid groups, preference is given to polyacrylic acids, also in partly or fully neutralized form.

Suitable organic builders are also iminodisuccinic acid, oxydisuccinic acid, amino polycarboxylates, alkylpolyaminocarboxylates, aminopolyalkylenephosphonates, polyglutamates, hydrophobically modified citric acid, for example agaric acid, poly-[alpha]-hydroxyacrylic acid, N-acylethylenediamine triacetates such as lauroylethylene diamine triacetate, and alkylamides of ethylenediaminetetraacetic acid such as EDTA tallow amide.

In addition, it is also possible to use oxidized starches as organic builders.

Component D)

The bleach systems D) comprise at least one bleach and optionally at least one further component selected from bleach activators, bleach catalysts and bleach stabilizers.

Suitable bleaches are, for example, percarboxylic acids, e.g. diperoxododecanedicarboxylic acid, phthalimidopercaproic acid or monoperoxophthalic acid or -terephthalic acid, salts of percarboxylic acids, e.g. sodium percarbonate, adducts of hydrogen peroxide onto inorganic salts, e.g. sodium perborate monohydrate, sodium perborate tetrahydrate, sodium carbonate perhydrate or sodium phosphate perhydrate, adducts of hydrogen peroxide onto organic compounds, e.g. urea perhydrate, or of inorganic peroxo salts, e.g. alkali metal persulfates, or peroxodisulfates.

Suitable bleach activators are, for example, polyacylated sugars, e.g. pentaacetylglucose; acyloxybenzenesulfonic acids and their alkali metal and alkaline earth metal salts, e.g. sodium p-nonanoyloxybenzenesulfonate or sodium p-benzoyloxybenzenesulfonate; —N,N-diacylated and N,N,N′,N′-tetraacylated amines, e.g. N,N,N′,N′-tetraacetylmethylenediamine and -ethylenediamine (TAED), N,N-diacetylaniline, N,N-diacetyl-p-toluidine or 1,3-diacylated hydantoins such as 1,3-diacetyl-5,5-dimethylhydantoin; N-alkyl-N-sulfonylcarboxamides, e.g. N-methyl-N-mesylacetamide or N-methyl-N-mesylbenzamide; N-acylated cyclic hydrazides, acylated triazoles or urazoles, e.g. monoacetylmaleic hydrazide; O,N,N-trisubstituted hydroxylamines, e.g. O-benzoyl-N,N-succinylhydroxylamine, O-acetyl-N,N-succinyl hydroxylamine or O,N,N-triacetylhydroxylamine; N,N′-diacylsulfurylamides, e.g. N,N′-dimethyl-N,N′-diacetylsulfurylamide or N,N′-diethyl-N,N′-dipropionylsulfurylamide; acylated lactams, for example acetylcaprolactam, octanoylcaprolactam, benzoylcaprolactam or carbonylbiscaprolactam; anthranil derivatives, for example 2-methylanthranil or 2-phenylanthranil; triacyl cyanurates, e.g. triacetyl cyanurate or tribenzoyl cyanurate; oxime esters and bisoxime esters, for example O-acetylacetone oxime or bisisopropyliminocarbonate; carboxylic anhydrides, e.g. acetic anhydride, benzoic anhydride, m-chlorobenzoic anhydride or phthalic anhydride; enol esters, for example isopropenyl acetate; 1,3-diacyl-4,5-diacyloxyimidazolines, e.g. 1,3-diacetyl-4,5-diacetoxyimidazoline; tetraacetylglycoluril and tetrapropionylglycoluril; diacylated 2,5-diketopiperazines, e.g. 1,4-diacetyl-2,5-diketopiperazine; ammonium-substituted nitriles, for example N-methylmorpholinioacetonitrile methylsulfate; acylation products of propylenediurea and 2,2-dimethylpropylenediurea, e.g. tetraacetylpropylenediurea; α-acyloxypolyacylmalonamides, e.g. α-acetoxy-N,N′-diacetylmalonamide; diacyldioxohexahydro-1,3,5-triazines, e.g. 1,5-diacetyl-2,4-dioxohexahydro-1,3,5-triazine; benz-(4H)-1,3-oxazin-4-ones with alkyl radicals, e.g. methyl, or aromatic radicals e.g. phenyl, in the 2 position.

A bleach system composed of bleaches and bleach activators may optionally also comprise bleach catalysts. Suitable bleach catalysts are, for example, quaternized imines and sulfonimines, which are described, for example, in U.S. Pat. No. 5,360,569 and EP-A 453 003. Particularly effective bleach catalysts are manganese complexes, which are described, for example, in WO-A 94/21777. In the case of use thereof in the washing and cleaning compositions, such compounds are incorporated in maximum amounts of up to 1.5% by weight, especially up to 0.5% by weight, and in the case of very active manganese complexes in amounts of up to 0.1% by weight. As well as the bleach system composed of bleaches, bleach activators and optionally bleach catalysts described, the use of systems with enzymatic peroxide release or of photoactivated bleach systems is also possible for the washing and cleaning compositions of the invention.

Component E)

Suitable enzymes (=component E1) are those as customarily used as industrial enzymes. These include both enzymes with optimal activity in the neutral to alkaline pH range and enzymes with optimal activity in the acidic pH range. In a specific embodiment, component E1) additionally comprises at least one enzyme stabilizer. Suitable enzyme stabilizers E1) are those as customarily used.

The enzymes are preferably selected from aminopeptidases, amylases, arabinases, carbohydrases, carboxypeptidases, catalases, cellulases, chitinases, cutinases, cyclodextrin glycosyltransferases, deoxyribonucleases, esterases, galactanases, alpha-galactosidases, beta-galactosidases, glucanases, glucoamylases, alpha-glucosidases, beta-glucosidases, haloperoxidases, hydrolase invertases, isomerases, keratinases, laccases, lipases, mannanases, mannosidases, oxidases, pectinolytic enzymes, peptidoglutaminases, peroxidases, peroxygenases, phytases, polyphenol oxidases, proteolytic enzymes, ribonucleases, transglutaminases, transferases, xylanases and mixtures thereof.

The enzymes are specifically selected from hydrolases, such as proteases, esterases, glucosidases, lipases, amylases, cellulases, mannanases, other glycosyl hydrolases and mixtures of the aforementioned enzymes. All these hydrolases contribute to soil dissolution and removal of protein-, grease- or starch-containing soiling. Oxireductases can also be used for bleaching. Of particularly good suitability are enzymatic active ingredients obtained from bacterial strains or fungi such as Bacillus subtilis, Bacillus licheniformis, Streptomyceus griseus and Humicola insolens.

Preferred enzymes are described more particularly below:

Proteases:

Suitable proteolytic enzymes (proteases) may in principle be of animal, vegetable or microbial origin. Preference is given to proteolytic enzymes of microbial origin. These also include chemically or genetically modified mutants.

Lipases:

Suitable lipases may in principle originate from bacteria or fungi. These also include chemically or genetically modified mutants.

Amylases:

In principle, all α- and/or β-amylases are suitable. Suitable amylases may in principle originate from bacteria or fungi. These also include chemically or genetically modified mutants.

Cellulases:

In principle, all cellulases are suitable. Suitable cellulases may in principle originate from bacteria or fungi. These also include chemically or genetically modified mutants.

Peroxidases/oxidases:

Suitable peroxidases/oxidases may in principle originate from plants, bacteria or fungi. These also include chemically or genetically modified mutants.

Lyases:

In principle, all lyases are suitable. Suitable lyases may in principle originate from bacteria or fungi. These also include chemically or genetically modified mutants.

Compositions of the invention may comprise further enzymes which are referred to collectively by the term hemicellulases. These include, for example, mannanases, xanthan lyases, pectinylases (=pectinases), pectin esterases, xyloglucanases (=xylanases), pullulanases and β-glucanases.

Preferably, the washing or cleaning composition of the invention comprises at least one enzyme selected from proteases, amylases, mannanases, cellulases, lipases, pectin lyases and mixtures thereof.

Preferably, the washing or cleaning composition of the invention comprises at least one protease and/or amylase.

Preferably, the washing, cleaning or dishwashing composition of the invention comprises an enzyme mixture. For example, preference is given to enzyme mixtures comprising or consisting of the following enzymes:
protease and amylase,
protease and lipase (or lipolytic enzymes),
protease and cellulase,
amylase, cellulase and lipase (or lipolytic enzymes),
protease, amylase and lipase (or lipolytic enzymes),
protease, lipase (or lipolytic enzymes) and cellulase.

The enzymes can be adsorbed onto carrier substances in order to protect them from premature decomposition.

The washing or cleaning composition of the invention may optionally also comprise enzyme stabilizers E1). These include, for example, calcium propionate, sodium formate, boric acids, boronic acids and salts thereof, such as 4-formylphenylboronic acid, peptides and peptide derivatives, for example peptide aldehydes, polyols, such as propane-1,2-diol, and mixtures thereof.

The washing or cleaning compositions of the invention comprise the enzymes preferably in an amount of 0.1% to 5% by weight, more preferably 0.12% to 2.5% by weight, based on the total weight of the washing or cleaning compositions.

In order to impart the desired viscosity to liquid and specifically aqueous compositions, it is additionally possible to use at least one thickener (=component E2) as component E).

Suitable thickeners in principle are any known thickeners (rheology modifiers), provided they do not have any adverse effect on the action of the washing and cleaning composition. Suitable thickeners may either be of natural origin or synthetic in nature.

Examples of thickeners of natural origin are xanthan, carob seed flour, guar flour, carrageenan, agar, tragacanth, gum arabic, alginates, modified starches, such as hydroxyethyl starch, starch phosphate esters or starch acetates, dextrins, pectins and cellulose derivatives, such as carboxymethyl cellulose, hydroxyethyl cellulose, hydroxypropyl cellulose, hydroxypropyl methyl cellulose, methyl cellulose and the like.

Thickeners of natural origin are also inorganic thickeners, such as polysilicic acids and clay minerals, e.g. sheet silicates, and also the silicates specified under the builders.

Examples of synthetic thickeners are polyacrylic and polymethacrylic compounds, such as (partly) crosslinked homopolymers of acrylic acid, for example homopolymers, crosslinked with an allyl ether of sucrose or pentaerythritol or with propylene, of acrylic acid (carbomer), e.g. the Carbopol® brands from BF Goodridge (e.g. Carbopol® 676, 940, 941, 934 or the like) or the Polygel® brands from 3V Sigma (e.g. Polygel® DA), copolymers of ethylenically unsaturated mono- or dicarboxylic acids, for example terpolymers of acrylic acid, methacrylic acid or maleic acid with methyl or ethyl acrylate and a (meth)acrylate derived from long-chain ethoxylated alcohols, for example the Acusol® brands from Rohm & Haas (e.g. Acusol® 820 or 1206A), copolymers of two or more monomers selected from acrylic acid, methacrylic acid and their C₁-C₄-alkyl esters, e.g. copolymers of methacrylic acid, butyl acrylate and methyl methacrylate or of butyl acrylate and methyl methacrylate, e.g. the Aculyn® and Acusol® brands from Rohm & Haas (e.g. Aculyn® 22, 28 or 33 and Acusol® 810, 823 and 830), or crosslinked high molecular weight acrylic acid copolymers, for example copolymers, crosslinked with an allyl ether of sucrose or pentaerythritol, of C₁₀-C₃₀-alkyl acrylates with one or more comonomers selected from acrylic acid, methacrylic acid and their C₁-C₄-alkyl esters (e.g. Carbopol® ETD 2623, Carbopol® 1382 or Carbopol® AQUA 30 from Rohm & Haas).

Examples of synthetic thickeners are also reaction products of maleic acid polymers with ethoxylated long-chain alcohols, e.g. the Surfonic L series from Texaco Chemical Co. or Gantrez AN-119 from ISP; polyethylene glycols, polyamides, polyimines and polycarboxylic acids.

Also suitable are mixtures of the aforementioned thickeners.

Preferred thickeners are xanthans and the aforementioned polyacrylic and polymethacrylic compounds.

Suitable organic solvents (=component E3) are selected from mono- or polyhydric alcohols, alkanolamines or glycol ethers. Preferably, they are selected from ethanol, n- or isopropanol, butanols, glycol, propane- or butanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol monomethyl or -ethyl ether, diisopropylene glycol monomethyl or -ethyl ether, methoxy, ethoxy or butoxy triglycol, isobutoxyethoxy-2-propanol, 3-methyl-3-methoxybutanol, propylene glycol t-butyl ether, and mixtures of these solvents.

Useful foam inhibitors or defoamers (=component E4) are, for example, soaps, paraffins or silicone oils, which can optionally be applied to carrier materials.

Suitable bases (=component E5) are alkali metal hydroxides, alkaline earth metal hydroxides, alkali metal carbonates, alkaline earth metal carbonates, ammonium carbonate, alkali metal hydrogencarbonates, alkaline earth metal hydrogencarbonates, ammonium hydrogencarbonates and mixtures thereof. Preference is given to using sodium, lithium and magnesium carbonates or sodium, lithium and magnesium hydrogencarbonates, especially sodium carbonate and/or sodium hydrogencarbonate.

In addition, the washing or cleaning compositions of the invention may comprise further additives E6) which further improve the performance and/or aesthetic properties. In general, preferred compositions comprise, in addition to the aforementioned components, at least one further additive selected from electrolytes, pH modifiers, perfume carriers, bitter substances, fluorescers, hydrotropes, antiredeposition agents, optical brighteners, graying inhibitors, antishrink agents, anticrease agents, dye transfer inhibitors, antimicrobial active ingredients, antioxidants, anti-yellowing agents, corrosion inhibitors, antistats, ironing aids, hydrophobizing and impregnating agents, antiswell and antislip agents, and UV absorbers.

Suitable dye transfer inhibitors are especially homo- or copolymers comprising at least one copolymerized monomer selected from N-vinylpyrrolidone, N-vinylcaprolactam, N-vinylimidazole, 2-vinylpyridine, 4-vinylpyridine, salts of the three latter monomers, 4-vinylpyridine N-oxide, N-carboxymethyl-4-vinylpyridinium halides and mixtures thereof.

Suitable graying inhibitors and/or washing power boosters are especially:
carboxymethylcellulose,
graft polymers of vinyl acetate onto carbohydrates, for example onto degraded starch,
graft polymers of vinyl acetate onto polyethylene glycol,
alkoxylated oligo- and polyamines, e.g. ethoxylated hexamethylenediamine, which may additionally also be in quaternized and/or sulfated form, or alkoxylated polyethyleneimine with 16 to 24 EO per NH,
copolymers based on styrene and maleic acid which may additionally also have been modified with end group-capped polyethylene glycol,
copolymers based on styrene and acrylic acid.

In order to improve the aesthetic impression of the washing, cleaning or dishwashing compositions of the invention, they can be colored with suitable dyes. Preferred dyes, the selection of which does not present any difficulty at all to the person skilled in the art, have high storage stability and insensitivity to the other constituents of the compositions and to light, and also no marked substantivity with respect to textile fibers, in order not to stain them.

The washing, cleaning or dishwashing compositions of the invention may comprise at least one bitter substance. Bitter substances are specially used in order to prevent inadvertent swallowing of the compositions, for example by infants. Suitable bitter substances are known to those skilled in the art. These include, for example, denatonium benzoate (benzyldiethyl-(2,6-xylylcarbamoyl)methylammonium benzoate), the bitterest-tasting substance known to date, which is commercially available under the Bitrex® name.

Dishwashing Compositions

The above-described multilayer films of the invention are also particularly advantageously suitable for at least partial coating or ensheathing of dishwashing detergents, especially of dishwashing detergents for machine dishwashing processes (automatic dishwashing, ADW). The polymer composition P1) present in the multilayer films exerts a dispersing, film-inhibiting, emulsifying and/or surfactant effect in dishwashing detergents. In addition, they ensure good rinse aid and/or drying performance. Examples of formulations of the invention for dishwashing include machine dishwashing compositions, rinse aids and machine dishwashing detergents with rinse aid function.

Machine dishwashing processes in the domestic and commercial sector comprise a plurality of successive steps, the first comprising the mechanical removal of loosely adhering food residues and the second the actual cleaning operation with the aid of a machine dishwasher, and the third generally consisting of a rinsing step, which is followed by the drying of the cleaned dishware. These operations are conducted in more or less automated form, the central unit used being a machine dishwasher in which at least the cleaning step and generally also the subsequent rinsing step and/or the drying step are conducted.

In machine dishwashers for the domestic sector, the soiled dishware is generally cleaned in a single chamber, and the aforementioned treatment steps proceed successively in a controlled program. Fresh water passes through the softening unit to the pump well and is sprayed by means of moving spray arms over the ware to be rinsed. Water-insoluble substances rinsed off are filtered out in the pump well. In the second rinse cycle, a generally alkaline cleaning composition is added to the rinse water, heated to the set temperature and distributed over the ware to be rinsed. In the last rinse cycle, a rinse aid is added to the treatment liquid, which reduces the surface tension, as a result of which the treatment liquid runs more easily off the ware. After the last rinse cycle, the contents are dried. The components used in the rinse cycle, such as water treatment agents, cleaning compositions, rinse aids, etc., can be used either in the form of individual components or in multicomponent formulations. Multifunctional detergents of this kind comprise surfactants for rinsing and a polymer for water softening. In that case, it is unnecessary to separately dispense a rinse aid and a salt for water softening into the machine dishwasher.

Commercial machine dishwashers consist basically of stationary bath tanks from which an essentially aqueous cleaning solution is jetted or sprayed onto the dishware, which moves past these baths on a conveyor belt, such that the used solution flows back into the bath tanks again. Water enters the last bath tank, flows via overflows in the manner of a cascade through all the other tanks and leaves the machine via the overflow of the first tank. The application of a generally highly alkaline cleaning solution generally takes place with the aid of nozzles provided therefor, or of a specific spraying system normally arranged in the middle region of the machine.

The multilayer films of the invention are suitable for at least partial coating or ensheathing of dishwashing compositions for machine dishwashing, which especially feature excellent film-inhibiting action. Preferred machine dishwashing composition formulations have inhibiting action with respect to both inorganic and organic film deposits. The inorganic film deposits are especially calcium and magnesium phosphate, calcium and magnesium carbonate, calcium and magnesium silicate and/or calcium and magnesium phosphonate, which arise from the calcium and magnesium salts present in the water and the builders present in standard dishwashing compositions. The organic film deposits are especially soil constituents from the rinse liquor, for example protein, starch and fat deposits. The formulations used in accordance with the invention for machine dishwashing are also effective against carry-over deposits, which originate from the residual water in the bottom of the machine dishwasher and comprise, inter alia, dishwashing composition residues and possibly also soil residues from the previous wash cycle of the machine dishwasher.

The dishwashing composition of the invention preferably comprises the following constituents:
Ga) at least one sheath and/or coating comprising or consisting of a multilayer film of the invention,
Gb) optionally at least one complexing agent,
Gc) at least one builder and/or cobuilder,
Gd) at least one nonionic surfactant,
Ge) optionally at least one component selected from bleaches, bleach activators and bleach catalysts,
Gf) optionally at least one enzyme,
Gg) optionally at least one further additive, preferably selected from anionic or zwitterionic surfactants, alkali carriers, polymeric dispersants, corrosion inhibitors, defoamers and foam inhibitors, dyes, fragrances, bitter substances, fillers, tablet disintegrants, organic solvents, tableting aids, disintegrants, thickeners and solubilizers,
Gh) optionally water.

A preferred dishwashing composition of the invention comprises:
Ga) 0.1% to 30% by weight of at least one sheath and/or coating comprising or consisting of a multilayer film of the invention,
Gb) 0% to 50% by weight of at least one complexing agent,
Gc) 0.1% to 80% by weight of at least one builder and/or cobuilder,
Gd) 0.1% to 20% by weight of at least one nonionic surfactant,
Ge) 0% to 30% by weight of at least one component selected from bleaches, bleach activators and bleach catalysts,
Gf) 0% to 8% by weight of at least one enzyme,
Gg) 0% to 50% by weight of at least one further additive, preferably selected from anionic or zwitterionic surfactants, alkali carriers, polymeric dispersants, corrosion inhibitors, defoamers and foam inhibitors, dyes, fragrances, bitter substances, fillers, tablet disintegrants, organic solvents, tableting aids, disintegrants, thickeners and solubilizers, and
Gh) 0% to 99.7% by weight of water,

with the proviso that the weights of the components add up to 100% by weight.

With regard to suitable and preferred multilayer films Ga), reference is made to the general details relating to suitable and preferred multilayer films.

Complexing agents Gb) which may be used are, for example: nitrilotriacetic acid, ethylenediaminetetraacetic acid, diethylenetriaminepentaacetic acid, hydroxyethylethylenediaminetriacetic acid, methylglycinediacetic acid, glutamic acid diacetic acid, iminodisuccinic acid, hydroxyiminodisuccinic acid, ethylenediaminedisuccinic acid, aspartic acid diacetic acid, and also salts thereof in each case. Preferred complexing agents Gb) are methylglycinediacetic acid and glutamic acid diacetic acid and salts thereof. Particularly preferred complexing agents Gb) are methylglycinediacetic acid and salts thereof, especially the mono-, di- and trisodium, -potassium, -lithium and -ammonium salts. The salts of methylglycinediacetic acid may be in racemic form, meaning that D and L enantiomers are present in an equimolar mixture, or one enantiomer, e.g. the L enantiomer, may be present in excess. Preference is given in accordance with the invention to 3% to 50% by weight of complexing agent Gb).

Builders and/or co-builders Gc) used may especially be water-soluble or water-insoluble substances having the main task of binding calcium and magnesium ions. These may be low molecular weight carboxylic acids and also salts thereof such as alkali metal citrates, in particular anhydrous trisodium citrate or trisodium citrate dihydrate, alkali metal succinates, alkali metal malonates, fatty acid sulfonates, oxydisuccinate, alkyl or alkenyl disuccinates, gluconic acids, oxadiacetates, carboxymethyloxysuccinates, tartrate monosuccinate, tartrate disuccinate, tartrate monoacetate, tartrate diacetate and α-hydroxypropionic acid.

A further substance class with cobuilder properties which may be present in the dishwashing compositions of the invention is that of the phosphonates. These are in particular hydroxyalkanephosphonates or aminoalkanephosphonates. Among the hydroxyalkanephosphonates, 1-hydroxyethane-1,1-diphosphonate (HEDP) is of particular significance as cobuilder. It is preferably used in the form of the sodium salt, the disodium salt giving a neutral reaction and the tetrasodium salt an alkaline reaction (pH 9). Suitable aminoalkanephosphonates are preferably ethylenediaminetetramethylenephosphonate (EDTMP), diethylenetriaminepentamethylenephosphonate (DTPMP) and the higher homologs thereof. They are preferably used in the form of the neutral sodium salts, for example as the hexasodium salt of EDTMP or as heptasodium and octasodium salts of DTPMP. The builder used in this case is from the class of the phosphonates, preferably HEDP. Aminoalkanephosphonates additionally have a pronounced heavy metal binding capacity. Accordingly, it may be preferable to use aminoalkanephosphonates, particularly DTPMP, or mixtures of the phosphonates mentioned, particularly if the compositions also comprise bleach.

Silicates may be used, inter alia, as builders. Crystalline sheet silicates having the general formula NaMSiₓO₂ₓ₊₁ yH₂O may be present, where M is sodium or hydrogen, x is a number from 1.9 to 22, preferably from 1.9 to 4, particularly preferred values for x being 2, 3 or 4, and y is a number from 0 to 33, preferably 0 to 20. In addition, amorphous sodium silicates having an SiO₂:Na₂O ratio of 1 to 3.5, preferably 1.6 to 3 and in particular 2 to 2.8 may be used.

Furthermore, in the context of the dishwashing composition of the invention, builders and/or co-builders Gc) used may be carbonates and hydrogen carbonates, among which the alkali metal salts, particularly sodium salts, are preferred.

Furthermore, the cobuilders used may be homopolymers and copolymers of acrylic acid or methacrylic acid preferably having a weight-average molar mass of 2000 to 50 000 g/mol. Suitable comonomers are in particular monoethylenically unsaturated dicarboxylic acids such as maleic acid, fumaric acid and itaconic acid and also anhydrides thereof such as maleic anhydride. Also suitable are comonomers containing sulfonic acid groups such as 2-acrylamido-2-methylpropanesulfonic acid, allylsulfonic acid and methanesulfonic acid. Hydrophobic comonomers are also suitable, for example isobutene, diisobutene, styrene, alpha-olefins with 10 or more carbon atoms. Hydrophilic monomers having hydroxyl functions or alkylene oxide groups may also be used as comonomers. Examples include: allyl alcohol and isoprenol and also alkoxylates thereof and methoxypolyethylene glycol (meth)acrylate.

The dishwashing compositions of the invention preferably comprise builders and/or cobuilders Gc) in an amount of 5% to 80% by weight, more preferably 10% to 75% by weight, especially 15% to 70% by weight, more especially 15% to 65% by weight, based on the total weight of the dishwashing composition.

Suitable nonionic surfactants Gd) are, for example, weakly foaming or low-foaming nonionic surfactants. The dishwashing compositions of the invention comprise nonionic surfactants preferably in an amount of 0.1% to 20% by weight, more preferably of 0.1% to 15% by weight, especially of 0.25% to 10% by weight, especially of 0.5% to 10% by weight, based on the total weight of the dishwashing composition. Suitable nonionic surfactants include surfactants of the general formula (IX)

R³¹—O—(CH₂CH₂O)ₐ—(CH R³²CH₂O)_{b}—R³³ (IX),

in which R³¹ is a linear or branched alkyl radical having 8 to 22 carbon atoms, R³² and R³³ are each independently hydrogen or a linear or branched alkyl radical having 1 to 10 carbon atoms or H, where R³² is preferably methyl, and a and b are each independently 0 to 300. Preferably, a=1 to 100 and b=0 to 30.

Also suitable in the context of the present invention are surfactants of formula (X)

R³⁴—O—[CH₂CH(CH₃)O]_{c}[CH₂CH₂O]_{d}[CH₂CH(CH₃)O]ₑCH₂CH(OH)R³⁵ (X),

in which R³⁴ is a linear or branched aliphatic hydrocarbyl radical having 4 to 22 carbon atoms or mixtures thereof,

R³⁵ is a linear or branched hydrocarbyl radical having 2 to 26 carbon atoms or refers to mixtures thereof,

c and e have values between 0 and 40, and

d is a value of at least 15.

Also suitable in the context of the present invention are surfactants of formula (XI)

R³⁶O—(CH₂CH R³⁷O)_{f}(CH₂CH₂O)_{g}(CH₂CH R³⁸O)ₕ—CO—R³⁹ (XI),

in which

R³⁶ is a branched or unbranched alkyl radical having 8 to 16 carbon atoms,

R³⁷, R³⁸ are each independently H or a branched or unbranched alkyl radical having 1 to 5 carbon atoms,

R³⁹ is an unbranched alkyl radical having 5 to 17 carbon atoms,

f, h are each independently a number from 1 to 5, and

g is a number from 13 to 35.

The surfactants of the formulae (IX), (X) and (XI) may be either random copolymers or block copolymers; they are preferably block copolymers. Furthermore, in the context of the present invention, di- and multi-block copolymers constructed from ethylene oxide and propylene oxide can be used, which are commercially available, for example, under the name Pluronic® (BASF SE) or Tetronic® (BASF Corporation). Furthermore, reaction products of sorbitan esters with ethylene oxide and/or propylene oxide can be used. Amine oxides or alkyl glycosides are also suitable. An overview of suitable nonionic surfactants are disclosed in EP-A 851 023 and DE-A 198 19 187. Mixtures of two or more different nonionic surfactants may also be present. The dishwashing compositions of the invention may further comprise anionic or zwitterionic surfactants, preferably in a mixture with nonionic surfactants. Suitable anionic and zwitterionic surfactants are likewise specified in EP-A 851 023 and DE-A 198 19 187.

Bleaches and bleach activators Ge) used in connection with the dishwashing compositions of the invention may be representatives known to those skilled in the art. Bleaches are subdivided into oxygen bleaches and chlorine bleaches. Oxygen bleaches used are alkali metal perborates and hydrates thereof, and also alkali metal percarbonates. Preferred bleaches in this context are sodium perborate in the form of the mono- or tetrahydrate, sodium percarbonate or the hydrates of sodium percarbonate. Likewise useable as oxygen bleaches are persulfates and hydrogen peroxide. Typical oxygen bleaches are also organic peracids such as perbenzoic acid, peroxy-alpha-naphthoic acid, peroxylauric acid, peroxystearic acid, phthalimidoperoxycaproic acid, 1,12-diperoxydodecanedioic acid, 1,9-diperoxyazelaic acid, diperoxoisophthalic acid or 2-decyldiperoxybutane-1,4-dioic acid. In addition, the following oxygen bleaches can also be used in the dishwashing composition: cationic peroxy acids, which are described in the patent applications U.S. Pat. Nos. 5,422,028, 5,294,362 and 5,292,447, and sulfonylperoxy acids, which are described in the patent application U.S. Pat. No. 5,039,447. Oxygen bleaches can be used in amounts of generally 0.1% to 30% by weight, preferably of 1% to 20% by weight, more preferably of 3% to 15% by weight, based on the overall dishwashing composition.

Chlorine bleaches and the combination of chlorine bleaches with peroxide bleaches can also be used in connection with the dishwashing compositions of the invention. Known chlorine bleaches are, for example, 1,3-dichloro-5,5-dimethylhydantoin, N-chlorosulfamide, chloramine T, dichloramine T, chloramine B, N,N′-dichlorobenzoyl urea, p-toluenesulfonedichloroamide or trichloroethylamine. Preferred chlorine bleaches in this case are sodium hypochlorite, calcium hypochlorite, potassium hypochlorite, magnesium hypochlorite, potassium dichloroisocyanurate or sodium dichloroisocyanurate. Chlorine bleaches in this connection can be used in amounts of 0.1% to 30% by weight, preferably of 0.1% to 20% by weight, preferably of 0.2% to 10% by weight, more preferably of 0.3% to 8% by weight, based on the overall dishwashing composition.

In addition, small amounts of bleach stabilizers, for example phosphonates, borates, metaborates, metasilicates or magnesium salts, may be added.

Bleach activators in the context of the present invention can be compounds which, under perhydrolysis conditions, give rise to aliphatic peroxocarboxylic acids having preferably 1 to 10 carbon atoms, in particular 2 to 4 carbon atoms, and/or substituted perbenzoic acid. In this case, suitable compounds comprise, inter alia, one or more N or O-acyl groups and/or optionally substituted benzoyl groups, for example substances from the class of the anhydrides, esters, imides, acylated imidazoles or oximes. Examples are tetraacetylethylenediamine (TAED), tetraacetylmethylenediamine (TAMD), tetraacetylglycoluril (TAGU), tetraacetylhexylenediamine (TAHD), N-acylimides such as N-nonanoylsuccinimide (NOSI), acylated phenol sulfonates such as n-nonanoyl- or isononanoyloxybenzenesulfonate (n- or iso-NOBS), pentaacetylglucose (PAG), 1,5-diacetyl-2,2-dioxohexahydro-1,3,5-triazine (DADHT) or isatoic anhydride (ISA). Also suitable as bleach activators are nitrile quats such as N-methylmorpholinium acetonitrile salts (MMA salts) or trimethylammonium acetonitrile salts (TMAQ salts). Preferred suitable bleach activators are from the group consisting of polyacylated alkylenediamines, more preferably TAED, N-acylimides, more preferably NOSI, acylated phenolsulfonates, more preferably n- or iso-NOBS, MMA, and TMAQ. Bleach activators in connection with the present invention can be used in amounts of 0.1% to 30% by weight, preferably of 0.1% to 10% by weight, preferably of 1% to 9% by weight, more preferably of 1.5% to 8% by weight, based on the overall dishwashing composition.

In addition to the conventional bleach activators or in place of them, so-called bleach catalysts may also be incorporated in rinse aid particles. These substances are bleach-enhancing transition metal salts or transition metal complexes such as salen complexes or carbonyl complexes of manganese, iron, cobalt, ruthenium or molybdenum. Also usable as bleach catalysts are complexes of manganese, iron, cobalt, ruthenium, molybdenum, titanium, vanadium and copper with nitrogen-containing tripod ligands and also amine complexes of cobalt, iron, copper and ruthenium.

As component Gf), the dishwashing compositions of the invention may comprise 0% to 8% by weight of enzymes. If the dishwashing compositions comprise enzymes, they comprise them preferably in amounts of 0.1% to 8% by weight. Enzymes may be added to the dishwashing composition in order to increase the cleaning performance or to ensure the same quality of cleaning performance under milder conditions (e.g. at low temperatures). The enzymes can be used in free form or a form chemically or physically immobilized on a support or in encapsulated form. The enzymes used most frequently in this context include lipases, amylases, cellulases and proteases. In addition, it is also possible, for example, to use esterases, pectinases, lactases and peroxidases. Preference is given in accordance with the invention to using amylases and proteases.

In connection with the dishwashing compositions of the invention, additives Gg) used may be, for example, anionic or zwitterionic surfactants, alkali carriers, polymeric dispersants, corrosion inhibitors, defoamers, dyes, fragrances, fillers, tablet disintegrants, organic solvents, tableting aids, disintegrants, thickeners, solubilizers or water. The alkali carriers used may be, for example, in addition to the ammonium or alkali metal carbonates already mentioned as builder substances, ammonium or alkali metal hydrogencarbonates and ammonium or alkali metal sesquicarbonates, and also ammonium or alkali metal hydroxides, ammonium or alkali metal silicates and ammonium or alkali metal metasilicates and also mixtures of the aforementioned substances.

The corrosion inhibitors used may be, inter alia, silver anticorrosives from the group of the triazoles, the benzotriazoles, the bisbenzotriazoles, the aminotriazoles, the alkylaminotriazoles and the transition metal salts or complexes.

To prevent glass corrosion, which is noticeable as cloudiness, iridescence, streaks and lines on the glasses, preference is given to using glass corrosion inhibitors. Preferred glass corrosion inhibitors are, for example, magnesium, zinc and bismuth salts and complexes and polyethyleneimines.

Paraffin oils and silicone oils may optionally be used in accordance with the invention as defoamers and to protect plastics and metal surfaces. Defoamers are used preferably in proportions of 0.001% by weight to 5% by weight. In addition, dyes, for example patent blue, preservatives, for example Kathon CG, perfumes and other fragrances may be added to the cleaning formulation of the invention.

An example of a suitable filler in connection with the dishwashing compositions of the invention is sodium sulfate.

Further possible additives that should be mentioned in connection with the present invention include amphoteric and cationic polymers.

In order to improve the aesthetic impression of the washing, cleaning or dishwashing compositions of the invention, they can be colored using suitable dyes. Preferred dyes, the selection of which presents no difficulty whatsoever to the person skilled in the art, have a high storage stability and insensitivity with respect to the other ingredients of the compositions and to light, and do not have any marked substantivity toward textile fibers, in order not to stain them.

I & I Cleaners

The multilayer films of the invention are also suitable for at least partial coating or ensheathing for industrial and institutional cleaners (I & I cleaners). Industrial and institutional cleaners are typically washing compositions, all-purpose cleaners, foam cleaners, CIP (cleaning in place) cleaners for professional and generally automated cleaning operations, for example in industrial laundries, dairies, breweries, the food and drink industry, the pharmaceutical industry or pharmaceutical formulation, or sanitary cleaners.

The cleaners may be strongly basic with a high electrolyte content and, if required, comprise bleaches (such as hydrogen peroxide, sodium hypochlorite) or disinfectants and defoamers (for example in bottle cleaning). It is also possible for the standard aforementioned enzymes to be present in the industrial and institutional cleaners. There is a great variety in terms of the types of cleaning for which the formulations of the invention are suitable. Examples include cleaning baths (stationary or mobile), spray cleaning, ultrasound cleaning, steam jet cleaning and high-pressure cleaning, optionally in combination with mechanical cleaning, for example by means of rotating brushes.

Said formulations for cleaning include those for industry, transport, commerce and industry, and for the private sector. Specific examples include: professional laundries, professional cleaning businesses, ore processing industry, metal and metalworking industry, automobile and automobile supply industry, electrical industry, electronics industry, photographic industry and businesses, leisure industry and businesses, construction material industry, brewing industry and businesses; foods industry (e.g. processing or production of meat, poultry, dairy and fish products), animal nutrition industry, cosmetics industry, pharmaceutical industry, agrochemical industry, gastronomy, the health sector, workshops, and public transport. Examples of objects to be cleaned are institutional laundry, hospital laundry, laundry from laundry collection, buildings containing living spaces, office spaces or commercial spaces of a wide variety of different kinds, and sanitary spaces, warehouses, breweries, small businesses such as bakeries, butcheries and supermarkets; hospitals, care homes, homes for the elderly, administration buildings, factory buildings, doctors' practices; and also motor vehicles (cars and trucks), buses, road tanker vehicles (interior and exterior), rail tanker wagons, passenger vehicles and goods vehicles, and aircraft and ships; and also building facades, tiled or painted walls, wooden floors (parquet, boards) with screed or textile or plastics coverings, signaling and lighting installations, furniture, railings, overhead signage, other signage, safety reflectors, delineating markers, tanks, dishware, glass panes, roads and paths, outside paving, road and railway tunnels.

Acidic Sanitary Cleaners

The multilayer films of the invention are also suitable for at least partial coating or ensheathing of cleaners for the sanitary sector comprising at least one organic acid. Acidic sanitary cleaners are especially suitable for WC cleaning, for cleaning of washbasins, shower cubicles, shower trays and swimming baths, and sinks in the kitchen sector. They are effective, for example, in the removal of limescale and urine scale deposits and in the removal of bacteria which typically form on the limescale and urine scale deposits. They ensure cleanliness and effectively prevent malodors. It has now been found that, surprisingly, the multilayer films of the invention have high compatibility with acidic surfactant compositions and are particularly advantageously suitable for use in acidic sanitary cleaners.

A preferred acidic sanitary cleaner preferably comprises the following constituents:
at least one sheath and/or coating comprising or consisting of a multilayer film of the invention as defined above, or obtainable by a process as defined above,
at least one organic acid,
optionally water,
optionally at least one thickener, and
optionally at least one further additive.

The acidic sanitary cleaner may be in solid, liquid or gel form. The acidic sanitary cleaner is preferably in the liquid form or especially in gel form.

Suitable organic acids are formic acid, acetic acid, citric acid or methanesulfonic acid. Particular preference is given to acetic acid or citric acid. The cleaner of the invention comprises the organic acid preferably in an amount of 1% to 40% by weight, especially of 5% to 15% by weight, based on the total weight of the cleaner.

The cleaner of the invention preferably comprises at least one surfactant in an amount of 0.5% to 50% by weight, especially of 1% to 15% by weight, based on the total weight of the cleaner.

Suitable thickeners are those mentioned above as component E) for the washing and cleaning compositions of the invention, to which reference is made here in full.

Suitable additives are those mentioned above as component E) for the washing and cleaning compositions of the invention, to which reference is made here in full. These especially include stabilizers, dyes and fragrances.

Cosmetic and Pharmaceutical Compositions

The multilayer films of the invention are also suitable for at least partial coating or ensheathing of cosmetic and pharmaceutical products.

The cosmetic and pharmaceutical products may be in solid, liquid or gel form.

Specifically, the cosmetic and pharmaceutical products take the form of an aqueous formulation.

The invention further provides a cosmetic or pharmaceutical composition comprising
a) at least one sheath and/or coating comprising or consisting of a multilayer film of the invention as defined above, or obtainable by a process as defined above,
b) at least one cosmetically or pharmaceutically acceptable active, and
c) optionally at least one cosmetically or pharmaceutically acceptable auxiliary other than components a) and b).

Preferably, component c) comprises at least one cosmetically or pharmaceutically acceptable carrier.

Preferably, the carrier component c) is selected from
i) water,
ii) water-miscible organic solvents, preferably C₂-C₄-alkanols, especially ethanol,
iii) oils, fats, waxes,
iv) esters, other than iii), of C₆-C₃₀-monocarboxylic acids with mono-, di- or trihydric alcohols,
v) saturated acyclic and cyclic hydrocarbons,
vi) fatty acids,
vii) fatty alcohols,
viii) propellant gases,

and mixtures thereof.

Suitable hydrophilic components c) are the aforementioned organic solvents, oils and fats.

Especially suitable cosmetically acceptable oil and fat components c) are described in Karl-Heinz Schrader, Grundlagen und Rezepturen der Kosmetika [Fundamentals and Formulations of Cosmetics], 2nd edition, Verlag Hüthig, Heidelberg, p. 319-355, which is hereby incorporated by reference.

The cosmetic compositions of the invention may be skin-cosmetic, hair-cosmetic, dermatological, hygiene or pharmaceutical products.

The compositions of the invention may be in any form suitable for ensheathing and/or coating by a multilayer film of the invention. The compositions of the invention are preferably in the form of a gel, ointment, cream, emulsion, suspension, lotion, milk or paste. If desired, it is also possible to use liposomes or microspheres.

The cosmetic compositions of the invention may additionally comprise cosmetically and/or dermatologically active and effective substances, and also auxiliaries. Preferably, the cosmetic compositions of the invention comprise, as sheath and/or coating, at least one multilayer film of the invention as defined above, at least one carrier C) as defined above and at least one different constituent preferably selected from cosmetically active ingredients, emulsifiers, surfactants, preservatives, perfume oils, bitter substances, additional thickeners, hair polymers, hair and skin conditioners, graft polymers, water-soluble or dispersible silicone-containing polymers, light stabilizers, bleaches, gel formers, care agents, tints, tanning agents, dyes, pigments, consistency regulators, humectants, refatting agents, collagen, protein hydrolyzates, lipids, antioxidants, anti-yellowing agents, defoamers, antistats, emollients and softeners.

The cosmetic active ingredients may comprise at least one conventional thickener.

These include, for example, polysaccharides and organic sheet minerals such as Xanthan Gum® (Kelzan® from Kelco), Rhodopol® 23 (Rhone Poulenc) or Veegum® (from R. T. Vanderbilt) or Attaclay® (from Engelhardt). Suitable thickeners are also organic natural thickeners (agar-agar, carrageenan, tragacanth, gum arabic, alginates, pectins, polyoses, guar flour, carob seed flour, starch, dextrins, gelatin, casein) and inorganic thickeners (polysilicic acids, clay minerals such as montmorillonites, zeolites, silicas). Further thickeners are polysaccharide gums, for example gum arabic, agar, alginates, carrageenans and salts thereof, guar, guaran, tragacanth, gellan, ramsan, dextran or xanthan and derivatives thereof, for example propoxylated guar, and mixtures thereof. Other polysaccharide thickeners are, for example, starches of a wide variety of different origins and starch derivatives, for example hydroxyethyl starch, starch phosphate esters or starch acetates, or carboxymethyl cellulose or the sodium salt thereof, methyl cellulose, ethyl cellulose, hydroxyethyl cellulose, hydroxypropyl cellulose, hydroxypropyl methyl cellulose or hydroxyethyl methyl cellulose, or cellulose acetate. The thickeners used may additionally be sheet silicates. These include, for example, the magnesium or sodium-magnesium sheet silicates obtainable under the Laponite® trade name from Solvay Alkali, and the magnesium silicates from Süd-Chemie.

Suitable cosmetically and/or dermatologically active ingredients are, for example, skin and hair pigmentation agents, tanning agents, bleaches, keratin-hardening substances, antimicrobial active ingredients, photofilter active ingredients, repellent active ingredients, hyperemic substances, keratolytic and keratoplastic substances, antidandruff active ingredients, antiphlogistics, keratinizing substances, antioxidative active ingredients and active ingredients acting as free-radical scavengers, skin moisturizing or humectant substances, regreasing active ingredients, deodorizing active ingredients, sebostatic active ingredients, plant extracts, antierythematous or antiallergic active ingredients and mixtures thereof.

Artificial tanning active ingredients suitable for tanning the skin without natural or artificial irradiation with UV rays are, for example, dihydroxyacetone, alloxan and walnut shell extract. Suitable keratin-hardening substances are generally active ingredients as also used in antiperspirants, for example potassium aluminum sulfate, aluminum hydroxychloride, aluminum lactate, etc. Antimicrobial active ingredients are used to destroy microorganisms or to inhibit their growth and thus serve both as preservatives and also as deodorizing substance which reduces the formation or the intensity of body odor. These include, for example, customary preservatives known to those skilled in the art, such as p-hydroxybenzoic esters, imidazolidinylurea, formaldehyde, sorbic acid, benzoic acid, salicylic acid, etc. Examples of such deodorizing substances include zinc ricinoleate, triclosan, undecylenic acid alkylolamides, triethyl citrate, chlorhexidine etc. Suitable light filtering active ingredients are substances which absorb UV rays in the UV-B and/or UV-A region. Suitable UV filters are those mentioned above. Additionally suitable are p-aminobenzoic esters, cinnamic esters, benzophenones, camphor derivatives, and pigments which stop UV rays, such as titanium dioxide, talc and zinc oxide. Suitable repellent active ingredients are compounds capable of warding off or driving away certain animals, particularly insects, from humans. These include, for example, 2-ethyl-1,3-hexanediol, N,N-diethyl-m-toluamide etc. Suitable substances with hyperemic activity, which stimulate blood flow through the skin are, for example, essential oils, such as dwarf pine, lavender, rosemary, juniperberry, roast chestnut extract, birch leaf extract, hayseed extract, ethyl acetate, camphor, menthol, peppermint oil, rosemary extract, eucalyptus oil, etc. Suitable keratolytic and keratoplastic substances are, for example, salicylic acid, calcium thioglycolate, thioglycolic acid and its salts, sulfur, etc. Suitable antidandruff active ingredients are, for example, sulfur, sulfur polyethylene glycol sorbitan monooleate, sulfur ricinol polyethoxylate, zinc pyrithione, aluminum pyrithione, etc. Suitable antiphlogistics, which counter skin irritations, are, for example, allantoin, bisabolol, Dragosantol, camomile extract, panthenol, etc.

The cosmetic compositions of the invention may comprise, as a cosmetic active (and optionally also as an auxiliary), at least one cosmetically or pharmaceutically acceptable polymer. These include, in quite general terms, anionic, cationic, amphoteric and uncharged polymers.

Examples of anionic polymers are copolymers of acrylic acid and acrylamide and salts thereof; sodium salts of polyhydroxycarboxylic acids, water-soluble or water-dispersible polyesters, polyurethanes, e.g. Luviset PUR® from BASF, and polyureas. Particularly suitable polymers are copolymers of t-butyl acrylate, ethyl acrylate, methacrylic acid (e.g. Luvimer® 100P), copolymers of ethyl acrylate and methacrylic acid (e.g. Luvimer® MAE), copolymers of N-tert-butylacrylamide, ethyl acrylate, acrylic acid (Ultrahold® 8, strong), copolymers of vinyl acetate, crotonic acid and optionally further vinyl esters (e.g. Luviset® products), maleic anhydride copolymers, optionally reacted with alcohol, anionic polysiloxanes, e.g. carboxy-functional, t-butyl acrylate, methacrylic acid (e.g. Luviskol® VBM), copolymers of acrylic acid and methacrylic acid with hydrophobic monomers, for example C₄-C₃₀-alkyl esters of (meth)acrylic acid, C₄-C₃₀-alkyl vinyl esters, C₄-C₃₀-alkyl vinyl ethers and hyaluronic acid. Another example of an anionic polymer is the methyl methacrylate/methacrylic acid/acrylic acid/urethane acrylate copolymer obtainable under the Luviset® Shape name (INCI Name: Polyacrylate-22). Further examples of anionic polymers are vinyl acetate/crotonic acid copolymers, as commercially available, for example, under the Resyn® (National Starch) and Gafset® (GAF) names, and vinylpyrrolidone/vinyl acrylate copolymers obtainable, for example, under the Luviflex® (BASF) trade name. Further suitable polymers are the vinylpyrrolidone/acrylate terpolymer available under the Luviflex® VBM-35 (BASF) name, and sodium sulfonate-containing polyamides or sodium sulfonate-containing polyesters. Additionally suitable are vinylpyrrolidone/ethyl methacrylate/methacrylic acid copolymers, as sold by Stepan under the Stepanhold-Extra and -R1 names, and the Carboset® products from BF Goodrich.

Suitable cationic polymers are, for example, cationic polymers having the INCI name Polyquaternium, e.g. copolymers of vinylpyrrolidone/N-vinylimidazolium salts (Luviquat® FC, Luviquat® HM, Luviquat® MS, Luviset Clear®, Luviquat Supreme®, Luviquat® Care), copolymers of N-vinylpyrrolidone/dimethylaminoethyl methacrylate, quaternized with diethyl sulfate (Luviquat® PQ 11), copolymers of N-vinylcaprolactam/N-vinylpyrrolidone/N-vinylimidazolium salts (Luviquat® Hold); cationic cellulose derivatives (Polyquaternium-4 and -10), acrylamido copolymers (Polyquaternium-7) and chitosan. Suitable cationic (quaternized) polymers are also Merquat® (polymer based on dimethyldiallylammonium chloride), Gafquat® (quaternary polymers which form through reaction of polyvinylpyrrolidone with quaternary ammonium compounds), polymer JR (hydroxyethyl cellulose with cationic groups) and plant-based cationic polymers, e.g. guar polymers, such as the Jaguar® products from Rhodia.

Very particularly suitable polymers are uncharged polymers such as polyvinylpyrrolidones, copolymers of N-vinylpyrrolidone and vinyl acetate and/or vinyl propionate, polysiloxanes, polyvinylcaprolactam and other copolymers with N-vinylpyrrolidone, polyethyleneimines and salts thereof, polyvinylamines and salts thereof, cellulose derivatives, polyaspartic salts and derivatives. Examples of these include Luviflex® Swing (partly hydrolyzed copolymer of polyvinyl acetate and polyethylene glycol, from BASF).

Suitable polymers are also nonionic, water-soluble or water-dispersible polymers or oligomers, such as polyvinylcaprolactam, e.g. Luviskol® Plus (BASF SE), or polyvinylpyrrolidone and copolymers thereof, especially with vinyl esters such as vinyl acetate, e.g. Luviskol® VA 37, VA 55, VA 64, VA 73 (BASF SE); polyamides, for example based on itaconic acid and aliphatic diamines, as described, for example, in DE-A-43 33 238.

Suitable polymers are also amphoteric or zwitterionic polymers, such as the octyl acrylamide/methyl methacrylate/tert-butylaminoethyl methacrylate/2-hydroxypropyl methacrylate copolymers obtainable under the Amphomer® names (National Starch), and zwitterionic polymers as disclosed, for example, in German patent applications DE 39 29 973, DE 21 50 557, DE 28 17 369 and DE 37 08 451. Acrylamidopropyltrimethylammonium chloride/acrylic acid or methacrylic acid copolymers and alkali metal and ammonium salts thereof are preferred zwitterionic polymers. Further suitable zwitterionic polymers are methacryloylethyl betaine/methacrylate copolymers, commercially available under the Amersette® name (AMERCHOL), and copolymers of hydroxyethyl methacrylate, methyl methacrylate, N,N-dimethylaminoethyl methacrylate and acrylic acid (Jordapon®).

Suitable polymers are also nonionic, siloxane-containing, water-soluble or -dispersible polymers, for example polyethersiloxanes such as Tegopren® (Goldschmidt) or Belsil® (Wacker).

In a specific embodiment, the compositions of the invention comprise at least one polymer which acts as a thickener.

Suitable polymeric thickeners are, for example, optionally modified polymeric natural substances (carboxymethyl cellulose and other cellulose ethers, hydroxyethyl and hydroxypropyl cellulose and the like) and synthetic polymeric thickeners (polyacrylic and polymethacrylic compounds, vinyl polymers, polycarboxylic acids, polyethers, polyimines, polyamides). These include the polyacrylic and polymethacrylic compounds, some of which have already been mentioned above, for example the high molecular weight homopolymers of acrylic acid crosslinked with a polyalkenyl polyether, especially an allyl ether of sucrose, pentaerythritol or propylene (INCI name: Carbomer). Polyacrylic acids of this kind are obtainable, inter alia, from BF Goodrich under the Carbopol® trade name, e.g. Carbopol 940 (molecular weight about 4 000 000 daltons), Carbopol 941 (molecular weight about 1 250 000 daltons) or Carbopol 934 (molecular weight about 3 000 000 daltons). These additionally include acrylic acid copolymers obtainable, for example, from Rohm & Haas under the Aculyn® and Acusol® trade names, for example the anionic, non-associative polymers Aculyn 22, Aculyn 28, Aculyn 33 (crosslinked), Acusol 810, Acusol 823 and Acusol 830 (CAS 25852-37-3). Also especially suitable are associative thickeners, for example based on modified polyurethanes (HEUR) or hydrophobically modified acrylic or methacrylic acid copolymers (HASE thickeners, High Alkali Swellable Emulsion).

In a preferred embodiment, the compositions of the invention are a skin cleanser.

Preferred skin cleansers are soaps of liquid to gel consistency, such as transparent soaps, luxury soaps, deodorant soaps, cream soaps, baby soaps, skin protection soaps, abrasive soaps and syndets, pasty soaps, greasy soaps and washing pastes, liquid washing, showering and bathing preparations, such as washing lotions, shower baths and gels, foam baths, oil baths and scrub preparations, shaving foams, lotions and creams.

In a further preferred embodiment, the compositions of the invention are cosmetic compositions for care and protection of the skin, nail care products or preparations for decorative cosmetics.

More particularly, the skincare products according to the invention are W/O or O/W skin creams, day and night creams, eye creams, face creams, antiwrinkle creams, moisturizing creams, bleaching creams, vitamin creams, skin lotions, care lotions and moisturizing lotions.

Skin-cosmetic and dermatological compositions comprise preferably at least one multilayer film of the invention in a proportion of about 0.1% to 50% by weight, preferably 0.1% to 20% by weight, based on the total weight of the composition.

The skincare compositions of the invention may take any form suitable for ensheathing and/or coating by a multilayer film of the invention, for example of a cream, foam, gel, stick, mousse, milk or lotion.

As well as the polymer compositions P1) of the invention and suitable carriers, the skin-cosmetic preparations may also comprise further active ingredients and auxiliaries customary in skin cosmetics, as described above. These preferably include emulsifiers, preservatives, perfume oils, cosmetic active ingredients such as phytantriol, vitamin A, E and C, retinol, bisabolol, panthenol, light stabilizers, bleaches, tanning agents, collagen, protein hydrolyzates, stabilizers, pH regulators, dyes, salts, thickeners, gel formers, consistency regulators, silicones, humectants, refatting agents and further customary additives.

Preferred oil and fat components of the skin-cosmetic and dermatological products are the aforementioned mineral and synthetic oils, for example paraffins, silicone oils and aliphatic hydrocarbons having more than 8 carbon atoms, animal and vegetable oils, for example sunflower oil, coconut oil, avocado oil, olive oil, lanolin, or waxes, fatty acids, fatty acid esters, for example triglycerides of C₆-C₃₀ fatty acids, wax esters, for example jojoba oil, fatty alcohols, vaseline, hydrogenated lanolin and acetylated lanolin, and mixtures thereof.

It is also possible to blend the polymer composition P1) of the invention with conventional polymers, as described above, if specific properties are to be established.

To establish particular properties, for example improving the tactile properties, the spreading characteristics, the water resistance and/or the binding of active ingredients and auxiliaries, such as pigments, the skin-cosmetic and dermatological preparations may additionally also comprise conditioning substances based on silicone compounds. Suitable silicone compounds are, for example, polyalkylsiloxanes, polyarylsiloxanes, polyarylalkylsiloxanes, polyethersiloxanes or silicone resins.

The cosmetic or dermatological preparations are produced by customary methods known to those skilled in the art.

In a further preferred embodiment, the compositions of the invention are a shower gel, a shampoo formulation or a bathing preparation.

Formulations of this kind comprise at least one multilayer film of the invention as a sheath and/or coating and typically anionic surfactants as base surfactants and amphoteric and/or nonionic surfactants as cosurfactants. Further suitable active ingredients and/or auxiliaries are generally selected from lipids, perfume oils, dyes, organic acids, preservatives and antioxidants, and also thickeners/gel formers, skin conditioners and moisturizers.

These formulations comprise preferably 2% to 50% by weight, preferably 5% to 40% by weight, more preferably 8% to 30% by weight, of surfactants, based on the total weight of the formulation.

In the washing, showering and bathing preparations, it is possible to use any of the anionic, uncharged, amphoteric or cationic surfactants customarily used in personal care products.

Suitable surfactants are those mentioned above.

In addition, the shower gel/shampoo formulations may comprise further thickeners, for example sodium chloride, PEG-55, propylene glycol oleate, PEG-120 methylglucose dioleate and others, and also preservatives, further active ingredients and auxiliaries and water.

In a further preferred embodiment, the compositions of the invention are a hair treatment composition.

Hair treatment compositions of the invention preferably comprise at least one multilayer film of the invention in an amount in the range from about 0.1% to 50% by weight, preferably 0.1% to 20% by weight, based on the total weight of the composition.

Preferably, the hair treatment compositions of the invention take the form of a hair mousse, hair gel, shampoo, end fluids, neutralizer for permanent waves or hot-oil treatments. According to the field of application, the hair-cosmetic preparations can be applied in the form of a gel, cream, lotion or wax.

The multilayer films of the invention are especially suitable as a sheath and/or coating for hairstyling formulations, especially hair foams and hair gels.

Emulsifiers used may be any of the emulsifiers customarily used in hair foams. Suitable emulsifiers may be nonionic, cationic or anionic, or amphoteric.

The multilayer films of the invention are also suitable for styling gels. Additional gel formers used may be any of the gel formers customary in cosmetics. In this regard, reference is made to the aforementioned conventional thickeners.

The multilayer films of the invention are also suitable for shampoo formulations additionally comprising customary surfactants.

To achieve certain effects, customary conditioners may be used in the shampoo formulations. Examples of these include the aforementioned cationic polymers with the INCI name Polyquaternium, especially copolymers of vinylpyrrolidone/N-vinylimidazolium salts (Luviquat® FC, Luviquat® HM, Luviquat® MS, Luviquat® Care), copolymers of N-vinylpyrrolidone/dimethylaminoethyl methacrylate, quaternized with diethyl sulfate (Luviquat® PQ 11), copolymers of N-vinylcaprolactam/N-vinyl-pyrrolidone/N-vinylimidazolium salts (Luviquat® Hold); cationic cellulose derivatives (Polyquaternium-4 and -10), acrylamide copolymers (Polyquaternium-7). In addition, it is possible to use protein hydrolyzates, and conditioning substances based on silicone compounds, for example polyalkylsiloxanes, polyarylsiloxanes, polyarylalkylsiloxanes, polyethersiloxanes or silicone resins. Further suitable silicone compounds are dimethicone copolyols (CTFA) and aminofunctional silicone compounds such as amodimethicones (CTFA). In addition, it is possible to use cationic guar derivatives such as guar hydroxypropyltrimonium chloride (INCI).

The multilayer films of the invention are likewise suitable for use as a sheath and/or coating for pharmaceutical formulations of any kind and in the coating of such pharmaceutical formulations.

Typical pharmaceutical compositions comprise
A) at least one sheath and/or coating comprising or consisting of a washing- and cleaning-active multilayer film as defined above, or obtainable by a process as defined above,
B) at least one pharmaceutically acceptable active and
C) optionally at least one further pharmaceutically acceptable auxiliary other than A) and B).

Pharmaceutically acceptable auxiliaries C) are auxiliaries which are known to be usable in the field of pharmacy, food technology and related fields, especially those listed in the relevant pharmacopeias (e.g. DAB, Ph. Eur., BP, NF), and other auxiliaries whose properties do not preclude a physiological application.

Suitable auxiliaries C) may be: lubricants, wetting agents, emulsifiers and suspension media, preservatives, antioxidants, antiirritants, chelating agents, emulsion stabilizers, film formers, gel formers, odor-masking agents, bitter substances, resins, hydrocolloids, solvents, solubilizers, neutralizers, permeation accelerators, pigments, quaternary ammonium compounds, refatting and superfatting agents, ointment, cream or oil bases, silicone derivatives, stabilizers, sterilizers, propellants, desiccants, opacifiers, additional thickeners, waxes, plasticizers, white oils. This kind of configuration is based on specialist knowledge, as represented, for example, in Fiedler, H.P. Lexikon der Hilfsstoffe für Pharmazie, Kosmetik und angrenzende Gebiete [Lexicon of Auxiliaries for Pharmacy, Cosmetics and Related Fields], 4th ed., Aulendorf: ECV-Editio-Kantor-Verlag, 1996.

To produce pharmaceutical compositions of the invention, the active ingredients can be mixed or diluted with a suitable excipient. Excipients may be solid, semisolid or liquid materials which can serve as a vehicle, carrier or medium for the active. Further auxiliaries are added, if desired, in the manner known to the person skilled in the art. More particularly, these are aqueous solutions or solubilizates for oral or parenteral administration. Furthermore, the copolymers for use in accordance with the invention are also suitable for use in oral administration forms such as tablets, capsules, powders, solutions. Here, they can provide the sparingly soluble drug with increased bioavailability. In the case of parenteral administration, as well as solubilizates, it is also possible to use emulsions, for example fatty emulsions.

Pharmaceutical formulations of the type specified above can be obtained by processing the polymer composition of the invention with pharmaceutical active ingredients by conventional methods and using known and new active ingredients.

The content of the at least one multilayer film of the invention in the pharmaceutical compositions is preferably in the range from 0.1% to 50% by weight, preferably 0.1% to 20% by weight, based on the total weight of the composition.

For production of the pharmaceutical compositions of the invention, all pharmaceutical active ingredients and prodrugs are suitable in principle. These include benzodiazepines, antihypertensives, vitamins, cytostatics, especially taxol, anaesthetics, neuroleptics, antidepressants, antibiotics, antimycotics, fungicides, chemotherapeutics, urologics, platelet aggregation inhibitors, sulfonamides, spasmolytics, hormones, immunoglobulins, sera, thyroid therapeutics, psychopharmaceuticals, Parkinson's drugs and other antihyperkinetics, ophthalmics, neuropathy preparations, calcium metabolism regulators, muscle relaxants, narcotics, antilipemics, liver therapeutics, coronary drugs, cardiac drugs, immunotherapeutics, regulatory peptides and their inhibitors, hypnotics, sedatives, gynecological drugs, gout remedies, fibrinolytics, enzyme preparations and transport proteins, enzyme inhibitors, emetics, perfusion promoters, diuretics, diagnostics, corticoids, cholinergics, biliary therapeutics, antiasthmatics, broncholytics, beta-receptor blockers, calcium antagonists, ACE inhibitors, arteriosclerosis remedies, antiphlogistics, anticoagulants, antihypotensives, antihypoglycemics, antihypertensives, antifibrinolytics, antiepileptics, antiemetics, antidotes, antidiabetics, antiarrhythmics, antianemics, antiallergics, anthelmintics, analgesics, analeptics, aldosterone antagonists and slimming drugs. Examples of suitable pharmaceutical active ingredients are especially the active ingredients mentioned in paragraphs 0105 to 0131 of US 2003/0157170.

As well as for use in cosmetics and in pharmacy, the multilayer films of the invention are also suitable as a sheath and/or coating in the food and drink sector. In the context of the present invention, food and drink preparations are also understood to mean food supplements, for example preparations comprising food and drink dyes and dietetic foods and drinks. In addition, the polymer compositions P1) of the invention are also suitable for feed supplements for animal nutrition.

The multilayer films of the invention are also suitable for production of formulations of food supplements such as water-insoluble vitamins and provitamins such as vitamin A, vitamin A acetate, vitamin D, vitamin E, tocopherol derivatives such as tocopherol acetate, and vitamin K.

Crop Protection Compositions

The multilayer film of the invention is also advantageously suitable for ensheathing and/or coating of crop protection compositions. It has been found that, surprisingly, the polymer composition P1) of the invention in gel form has high compatibility with a multitude of crop protection active ingredients and adjuvants.

A preferred crop protection composition preferably comprises the following constituents:
at least one sheath and/or coating comprising or consisting of a washing- and cleaning-active multilayer film as defined above, or obtainable by a process as defined above,
at least one active,
optionally at least one adjuvant,
optionally water,
optionally at least one thickener, and
optionally at least one further additive.

Suitable active ingredients for use in the crop protection compositions of the invention are, for example, those which belong to the group of the herbicides, fungicides, insecticides, growth regulators, safeners, acaricides, molluscicides and nematicides.

In many cases, the addition of adjuvants, for example of oils, specific solvents, surfactants or surfactant mixtures, is advantageous. In crop protection, adjuvants are auxiliaries which increase the activity of an active (here: crop protection compositions) and/or the selectivity thereof in relation to the desired effect (for example fungicidal, insecticidal, herbicidal, bactericidal, nematicidal, growth-regulating effect), but which alone have only a very small effect, if any, in terms of crop protection activity. The effect of adjuvants is in many cases based on their interfacial activity, which improves contact of the administration form of the active with the surface of the plant and, by reducing the surface tension, improves the penetration of the administration form and hence of the active into the soil.

The crop protection composition of the invention may be in solid, liquid or gel form. The crop protection composition of the invention may additionally comprise at least one thickener. Suitable thickeners are those mentioned above as component E) for the washing and cleaning compositions, to which reference is made here in full. The crop protection composition of the invention comprises the multilayer film of the invention preferably in an amount of 0.1% to 50% by weight, more preferably of 0.1% to 20% by weight, based on the total weight of the crop protection composition.

The crop protection composition of the invention may comprise further components. These include, for example, dispersants, defoamers, preservatives, biocides, organic solvents, antifreezes and the like.

Suitable dispersants or surfactants are preferably nonionic. In principle, they may be similar in nature to the above-described adjuvants, in which case they differ from the latter by a generally higher molecular weight. Suitable molecular weights for dispersants vary in the range from about 1000 g/mol (e.g. phosphated tristyrylphenol ethoxylate, such as Soprophor 3D33 from Rhodia) up to several thousand g/mol in the case of comb polymers (e.g. Atlox 4913 from Croda). Defoamers are preferably silicone-based defoamers. A suitable preservative is, for example, dichlorophen. Suitable biocides are, for example, isothiazolinones, such as benzylisothiazolinone and methylisothiazolinone. Suitable antifreezes are, for example, glycerol, ethylene glycol and propylene glycol.

Similarly, it is also possible to produce veterinary medicine administration forms, especially rumen-stable forms, and also administration forms containing vitamins, carotenoids, trace elements, nutraceuticals, amino acids and food supplements. The latter can also serve as foods or supplements.

The invention is illustrated in detail by the examples described hereinafter. At the same time, the examples should not be regarded as a restriction of the invention.

### EXAMPLES

All the examples for production of a polymer composition P1) were created by the same general production method. The individually produced polymer compositions of the invention are referred to hereinafter as P1-1) to P1-6).

General Production Method for a Polymer Composition P1)

The initial charge was heated to 75° C. while stirring at 100 rpm. Then feeds 1, 2 and 3 were metered in within 4 h and the reaction mixture was polymerized for a further hour. The mixture was then allowed to cool down to room temperature. The polymer composition is obtained in the form of a transparent and viscous solution.

The weight-average molecular weight M_{w} of the polymer composition P1) obtained was determined by means of gel permeation chromatography (GPC) in aqueous solution using neutralized polyacrylic acid as polymer standard. In this type of molecular weight determination, the components of the polymer composition which comprise the aforementioned monomers M) in copolymerized form are ascertained.
Standard: neutralized polyacrylic acid. The calibration was carried out with narrow distribution Na-PAA standards from PSS (Polymer Standards Service GmbH) with molecular weights of M=1250 to M=1 100 000 g/mol. In addition, PAA standards from the American Polymer Standards Corporation with molecular weight M=1770 and M=900 g/mol were used. The values outside of this elution range were extrapolated.
Eluent: 0.01 mol/L phosphate buffer pH=7.4 in distilled water with 0.01 M NaN₃
Flow rate: 0.8 mL/min
Amount injected: 100 μL
Concentration: 1.5 mg/mL
The sample solutions were filtered through Millipore IC Millex-LG filters (0.2 μm).
Column type: TSKgel GMPWXL
Column set: 2 separation columns (length=each 30 cm), exclusion limit 1000-8 000 000 g/mol

Detector: DRI Agilent 1200 UV Agilent 1200 VWD [260 nm]

Production of polymer composition P1-1)

| | Feedstock | Amount (% by wt.) | Content (%) |
|---|---|---|---|
| Initial charge | Polyethylene glycol | 24.48 | 100.00 |
| | Mw 1000 g/mol | | |
| | Water^{a)} | 16.78 | 100.00 |
| Feed 1 | acrylic acid | 48.95 | 100.00 |
| Feed 2 | Initiator^{b)} | 0.35 | 100.00 |
| | Water^{a)} | 4.55 | 100.00 |
| Feed 3 | 2-Mercaptoethanol | 0.49 | 100.00 |
| | Sodium | 1.34 | 55.00 |
| | hypophosphite | | |
| | Water^{a)} | 3.07 | 100.00 |

^{a)}demineralized water
^{b)}2,2′-azobis(2-methylpropionamidine) dihydrochloride (CAS No. 2997-92-4)

The weight-average molecular weight Mw of the polymer composition P1-1) obtained was 11 800 g/mol.

Production of Polymer Composition P1-2)

| | | Amount (% by | |
|---|---|---|---|
| | Feedstock | wt.) | Content (%) |
| Initial charge | Polyethylene oxide | 24.48 | 100.00 |
| | having CₓH₂ₓ₊₁/C_{y}H_{2y+1} | | |
| | termination at either | | |
| | end and having a free | | |
| | OH group and x, y = 6 | | |
| | to 14 | | |
| | Water^{a)} | 16.78 | 100.00 |
| Feed 1 | acrylic acid | 48.95 | 100.00 |
| Feed 2 | Initiator^{b)} | 0.35 | 100.00 |
| | Water^{a)} | 4.55 | 100.00 |
| Feed 3 | 2-Mercaptoethanol | 0.49 | 100.00 |
| | Sodium | 1.34 | 55.00 |
| | hypophosphite | | |
| | Water^{a)} | 3.07 | 100.00 |

^{a)}demineralized water
^{b)}2,2′-azobis(2-methylpropionamidine) dihydrochloride (CAS No. 2997-92-4)

The weight-average molecular weight Mw of the polymer composition P1-2) obtained was 11 100 g/mol.

Production of Polymer Composition P1-3)

| | | Amount (% by | |
|---|---|---|---|
| | Feedstock | wt.) | Content (%) |
| Initial charge | C₁₃C₁₅ alcohol + 9 EO + | 24.08 | 100.00 |
| | 2 BuO | | |
| | Water^{a)} | 18.12 | 100.00 |
| Feed 1 | acrylic acid | 48.17 | 100.00 |
| Feed 2 | Initiator^{b)} | 0.34 | 100.00 |
| | Water^{a)} | 4.47 | 100.00 |
| Feed 3 | 2-Mercaptoethanol | 0.96 | 100.00 |
| | Sodium | 2.63 | 55.00 |
| | hypophosphite | | |
| | Water^{a)} | 1.23 | 100.00 |

^{a)}demineralized water
^{b)}2,2′-azobis(2-methylpropionamidine) dihydrochloride (CAS No. 2997-92-4)

The weight-average molecular weight Mw of the polymer composition P1-3) obtained was 6120 g/mol.

Production of Polymer Composition P1-4)

| | | | Content |
|---|---|---|---|
| | Feedstock | Amount (% by wt.) | (%) |
| Initial charge | C₁₃C₁₅ alcohol + 9 EO + | 17.98 | 100.00 |
| | 2 BuO | | |
| | Water^{a)} | 18.09 | 100.00 |
| Feed 1 | Acrylic acid | 53.94 | 100.00 |
| Feed 2 | Initiator^{b)} | 0.38 | 100.00 |
| | Water^{a)} | 4.61 | 100.00 |
| Feed 3 | 2-Mercaptoethanol | 1.08 | 100.00 |
| | Sodium | 2.94 | 55.00 |
| | hypophosphite | | |
| | Water^{a)} | 0.97 | 100.00 |

^{a)}demineralized water
^{b)}2,2′-azobis(2-methylpropionamidine) dihydrochloride (CAS No. 2997-92-4)

The weight-average molecular weight Mw of the polymer composition P1-4) obtained was 6270 g/mol.

Production of Polymer Composition P1-5)

| | | Amount (% by | |
|---|---|---|---|
| | Feedstock | wt.) | Content (%) |
| Initial charge | Polyethylene oxide | 24.48 | 100.00 |
| | having CXH2X + 1/ | | |
| | CyH2y + 1 termination | | |
| | at either end and | | |
| | having a free OH | | |
| | group and x, y = 6 to | | |
| | 14 | | |
| | Water^{a)} | 16.78 | 100.00 |
| Feed 1 | Acrylic acid | 32.38 | 100.00 |
| | Methacrylic acid | 16.58 | 100.00 |
| Feed 2 | Initiator^{b)} | 0.35 | 100.00 |
| | Water^{a)} | 4.55 | 100.00 |
| Feed 3 | 2-Mercaptoethanol | 0.49 | 100.00 |
| | Sodium | 1.34 | 55.00 |
| | hypophosphite | | |
| | Water^{a)} | 3.07 | 100.00 |

^{a)}demineralized water
^{b)}2,2′-azobis(2-methylpropionamidine) dihydrochloride (CAS No. 2997-92-4)

The weight-average molecular weight Mw of the polymer composition P1-5) obtained was 15 700 g/mol.

Production of Polymer Composition P1-6

| | Feedstock | Amount (% by wt.) | Content (%) |
|---|---|---|---|
| Initial | Polyethylene oxide | 24.48 | 100.00 |
| charge | having CXH2X + 1/ | | |
| | CyH2y + 1 termination at | | |
| | either end and having a | | |
| | free OH group and x, y = | | |
| | 6 to 14 | | |
| | Water^{a)} | 4.00 | 100.00 |
| Feed 1 | 2-Acrylamido-2- | 25.57 | 50.00 |
| | methylpropanesulfonic | | |
| | acid sodium salt | | |
| | Acrylic acid | 36.17 | 100.00 |
| Feed 2 | Initiator^{b)} | 0.35 | 100.00 |
| | Water^{a)} | 4.55 | 100.00 |
| Feed 3 | 2-Mercaptoethanol | 0.49 | 100.00 |
| | Sodium hypophosphite | 1.34 | 55.00 |
| | Water^{a)} | 3.07 | 100.00 |

^{a)}demineralized water
^{b)}2,2′-azobis(2-methylpropionamidine) dihydrochloride (CAS No. 2997-92-4)

The weight-average molecular weight Mw of the polymer composition P1-6) obtained was 13 000 g/mol.

Production of an Application Solution A1-A3 for Film Layers of Polyvinyl Alcohol (PVOH Films):

20 g of a solid polyvinyl alcohol were dissolved in 80 g of deionized water at 60° C. while stirring. 5.0 g of glycerol were added to 100 g of the polyvinyl alcohol solution thus prepared. The solution was heated to 80° C. Subsequently, by addition of deionized water, the polyvinyl alcohol concentration of the solution was adjusted to 18.0% by weight. The polyvinyl alcohol application solution was mixed well and heated at 80° C. until the air stirred in had escaped completely.
A1: polyvinyl alcohol=Poval® 26-88 from Kuraray, nonvolatile components: 97.5%
A2: polyvinyl alcohol=Poval® 40-88 from Kuraray, nonvolatile components: 97.5%
A3: polyvinyl alcohol=Poval® 8-88 from Kuraray, nonvolatile components: 97.5%

Production of an Application Solution A4 for Film Layers of Polyvinyl Alcohol (PVOH Films):

20 g of a solid polyvinyl alcohol (Poval® 26-88 from Kuraray, nonvolatile components: 97.5%) were dissolved in 80 g of deionized water at 60° C. while stirring. 2.0 g of glycerol and 0.20 g of a C₁₃C₁₅ oxo process alcohol with 7 EO were added to 100 g of the polyvinyl alcohol solution thus prepared. The solution was heated to 80° C. Subsequently, by addition of deionized water, the polyvinyl alcohol concentration of the solution was adjusted to 18.0% by weight. The polyvinyl alcohol application solution was mixed well and heated at 80° C. until the air stirred in had escaped completely.

Production of an Application Solution B1 for Film Layers of the Polymer Composition P1-1):

100 g of the polymer composition P1-1) were heated to 80° C. After addition of 4.2 g of glycerol, the concentration of the polymer composition was diluted to 65% by weight with deionized water. The application solution was mixed well and heated at 60° C. until the air stirred in had escaped completely.

Production of an Application Solution B2 for Film Layers of the Polymer Composition P1-2):

100 g of the polymer composition P1-2) were heated to 80° C. Thereafter, the concentration of the polymer composition was diluted to 73% by weight with deionized water. The application solution was mixed well and heated at 60° C. until the air stirred in had escaped completely.

Production of an Application Solution B3 for Film Layers of the Polymer Composition P1-3):

100 g of the polymer composition P1-3) were heated to 80° C. After addition of 4.2 g of glycerol, the concentration of the polymer composition was diluted to 65% by weight with deionized water. The application solution was mixed well and heated at 60° C. until the air stirred in had escaped completely.

Production of an Application Solution B4 for Film Layers of the Polymer Composition P1-4):

100 g of the polymer composition P1-4) were heated to 80° C. After addition of 7.0 g of glycerol, the concentration of the polymer composition was diluted to 65% by weight with deionized water. The application solution was mixed well and heated at 60° C. until the air stirred in had escaped completely.

Production of an Application Solution B5 for Film Layers of the Polymer Composition P1-5):

100 g of the polymer composition P1-5) were heated to 80° C. After addition of 7.0 g of glycerol, the concentration of the polymer composition was diluted to 65% by weight with deionized water. The application solution was mixed well and heated at 60° C. until the air stirred in had escaped completely.

Production of an Application Solution B6 for Film Layers of the Polymer Composition P1-6):

100 g of the polymer composition P1-6) were heated to 80° C. Thereafter, the concentration of the polymer composition was diluted to 73% by weight with deionized water. The application solution was mixed well and heated at 60° C. until the air stirred in had escaped completely.

Production of Multilayer Films

In the examples which follow for production of multilayer films, the coating was effected wet on dry.

### Examples 1a-c

2-Layer Film: 1st Layer of Polyvinyl Alcohol, 2nd Layer of Polymer Composition P1-1)

### Example 1a

For production of the multilayer film, an automatic film applicator and a universal applicator from Zehntner was used. The application solution A1 was applied to the surface of a previously ethanol-degreased metal carrier made of galvanized steel sheet. The gap width of the coating bar was chosen such that the layer, after drying at room temperature, has a thickness of 54 μm. After the polyvinyl alcohol layer had been dried, the application solution B1 heated to 60° C. was applied. The gap width of the coating bar was adjusted such that, after the drying at room temperature, the total layer thickness of the film is 184 μm.

Example 1b was conducted analogously to example 1a. Application solutions A2 and B1 were employed. Layer thickness of PVOH layer: 76 μm, total layer thickness 196 μm.

Example 1c was conducted analogously to example 1a. Application solutions A3 and B1 were employed. Layer thickness of PVOH layer: 47 μm, total layer thickness 197 μm.

### Examples 1d

2-Layer Film: 1st Layer of Polyvinyl Alcohol, 2nd Layer of Polymer Composition P1-2)

For production of the multilayer film, an automatic film applicator and a universal applicator from Zehntner was used. The application solution A1 was applied to the surface of a previously ethanol-degreased metal carrier made of galvanized steel sheet. The gap width of the coating bar was chosen such that the layer, after drying at room temperature, has a thickness of 48 μm. After the polyvinyl alcohol layer had been dried, the application solution B2 heated to 60° C. was applied. The gap width of the coating bar was adjusted such that, after the drying at room temperature, the total layer thickness of the film is 169 μm.

### Examples 1e

2-Layer Film: 1st Layer of Polyvinyl Alcohol, 2nd Layer of Polymer Composition P1-3)

For production of the multilayer film, an automatic film applicator and a universal applicator from Zehntner was used. The application solution A1 was applied to the surface of a previously ethanol-degreased metal carrier made of galvanized steel sheet. The gap width of the coating bar was chosen such that the layer, after drying at room temperature, has a thickness of 49 μm. After the polyvinyl alcohol layer had been dried, the application solution B3 heated to 60° C. was applied. The gap width of the coating bar was adjusted such that, after the drying at room temperature, the total layer thickness of the film is 185 μm.

### Examples 1f

2-Layer Film: 1st Layer of Polyvinyl Alcohol, 2nd Layer of Polymer Composition P1-4)

For production of the multilayer film, an automatic film applicator and a universal applicator from Zehntner was used. The application solution A1 was applied to the surface of a previously ethanol-degreased metal carrier made of galvanized steel sheet. The gap width of the coating bar was chosen such that the layer, after drying at room temperature, has a thickness of 46 μm. After the polyvinyl alcohol layer had been dried, the application solution B4 heated to 60° C. was applied. The gap width of the coating bar was adjusted such that, after the drying at room temperature, the total layer thickness of the film is 196 μm.

### Examples 1g

2-Layer Film: 1st Layer of Polyvinyl Alcohol, 2nd Layer of Polymer Composition P1-5)

For production of the multilayer film, an automatic film applicator and a universal applicator from Zehntner was used. The application solution A1 was applied to the surface of a previously ethanol-degreased metal carrier made of galvanized steel sheet. The gap width of the coating bar was chosen such that the layer, after drying at room temperature, has a thickness of 52 μm. After the polyvinyl alcohol layer had been dried, the application solution B5 heated to 60° C. was applied. The gap width of the coating bar was adjusted such that, after the drying at room temperature, the total layer thickness of the film is 299 μm.

### Examples 1h

2-Layer Film: 1st Layer of Polyvinyl Alcohol, 2nd Layer of Polymer Composition P1-6)

For production of the multilayer film, an automatic film applicator and a universal applicator from Zehntner was used. The application solution A1 was applied to the surface of a previously ethanol-degreased metal carrier made of galvanized steel sheet. The gap width of the coating bar was chosen such that the layer, after drying at room temperature, has a thickness of 50 μm. After the polyvinyl alcohol layer had been dried, the application solution B6 heated to 60° C. was applied. The gap width of the coating bar was adjusted such that, after the drying at room temperature, the total layer thickness of the film is 211 μm.

### Example 2

3-Layer Film: 1st Layer of Polyvinyl Alcohol, 2nd Layer of Polymer Composition P1-1), 3rd Layer of Polyvinyl Alcohol

For production of the multilayer film, an automatic film applicator and a universal applicator from Zehntner was used. The application solution A4 was applied to the surface of a previously ethanol-degreased metal carrier made of galvanized steel sheet. The gap width of the coating bar was chosen such that the layer, after drying at room temperature, has a thickness of 28 μm. After the polyvinyl alcohol layer had been dried, the application solution B1 heated to 60° C. was applied. The gap width of the coating bar was adjusted such that, after the drying at room temperature, the total layer thickness of the film is 192 μm. Subsequently, the application solution A4 was applied again. The gap width of the coating bar was adjusted such that, after the drying at room temperature, the total layer thickness of the film is 227 μm.

### Comparative Example a (Monolaminar Film)

For production of the monolaminar film, an automatic film applicator and a universal applicator from Zehntner is used. The application solution B1 heated to 60° C. is applied to the surface of a silicone paper. The gap width of the coating bar is adjusted such that, after the drying at room temperature, the total layer thickness of the film is 155 μm.

### Comparative Example B (Monolaminar Film)

For production of the monolaminar film, an automatic film applicator and a universal applicator from Zehntner is used. The application solution B3 heated to 60° C. is applied to the surface of a silicone paper. The gap width of the coating bar is adjusted such that, after the drying at room temperature, the total layer thickness of the film is 154 μm.

### Comparative Example C (Monolaminar Film)

For production of the monolaminar film, an automatic film applicator and a universal applicator from Zehntner is used. The application solution B4 heated to 60° C. is applied to the surface of a silicone paper. The gap width of the coating bar is adjusted such that, after the drying at room temperature, the total layer thickness of the film is 152 μm.

Thickness Measurement:

Film thicknesses were determined by means of a digital gauge (Mitutoyo Absolute Digimatic gauge, ID-H model) with a flat, circular stylus of diameter 5 mm. The thickness was measured over an average of at least 10 measurement positions per film. The layer thickness variations are within a range of ±10%.

Tensile Tests:

To examine the mechanical film properties, tensile tests on film strips were conducted in a universal tester (Zwick GmbH, model TMTC-FR2.5TN.D09). The aim was determination of the improved mechanical properties because of the layer structure of the multilaminar film. The films produced were in sorption equilibrium with the ambient humidity (35-40% relative humidity at 20-25° C.) after storage for several days. Strips of width 20 mm were cut out of the films and clamped into the tester at a clamp separation (=starting length L₀) of 30 mm. The tensile tests were conducted at a starting speed of 2.0 mm/min with force control under ambient conditions. For each film type, at least 3 independent tensile tests were conducted. The experiments can be used to ascertain characteristic parameters, for example the maximal force and elongation (change in length/starting length) for assessment of the mechanical properties. Further information relating to tensile tests can be found in the standards ISO 527-1 and ASTM D882-12.

Result

| | Tensile strength | | Max. tensile force |
|---|---|---|---|
| | [1 N/mm² = 1000 kPa] | Elongation [%] | [N] |
| Example 1a | 7.047 | 272 | 22.6 |
| Example 1b | 7.206 | 327 | 30.3 |
| Example 1c | 5.603 | 278 | 22.4 |
| Example 1d | 8.053 | 244 | 29.0 |
| Example 1e | 6.743 | 226 | 28.3 |
| Example 1f | 5.664 | 251 | 24.9 |
| Example 1g | 7.078 | 320 | 38.2 |
| Example 1h | 6.163 | 190 | 23.4 |
| Example 2 | 5.736 | 285 | 24.1 |
| Example A | 0.766 | 23 | 2.5 |
| Example B | 0.872 | 11 | 2.8 |
| Example C | 1.183 | 23 | 3.6 |

Dishwashing Machine Test:

The films of the invention were tested in the following phosphate-free dishwashing composition formulation:

Dishwashing Composition Formulation

| Constituent | % by wt. |
|---|---|
| Protease | 2.5 |
| Amylase | 1.0 |
| Nonionic surfactant | 3.5 |
| Film | 7.5 |
| Sodium percarbonate | 10.2 |
| Tetraacetylethylenediamine | 4 |
| Sodium disilicate | 2 |
| Sodium carbonate | 23.7 |
| Sodium citrate dihydrate | 35 |
| Methylglycinediacetic acid, | 10 |
| sodium salt | |
| Hydroxyethane-(1,1- | 0.6 |
| diphosphonic acid) | |

Values in % by weight based on the total amount of all components

The following experimental conditions were observed:

| | |
|---|---|
| Dishwasher | Miele G 1222 SCL |
| Program | 65° C. (with pre-rinse) |
| Dishes washed | 3 knives (Karina nickel chrome knives, Solex |
| | Germany GmbH, D-75239 Eisingen) |
| | 3 Amsterdam 0.2 L drinking glasses |
| | 3 “OCEAN BLUE” breakfast dishes (melamine) |
| | 3 porcelain plates: 19 cm flat-rimmed plates |
| Arrangement | knives in the cutlery drawer, |
| | glasses in the upper basket, |
| | plates sorted in the lower basket |
| Dishwashing | 18 g |
| compositions | |
| Addition of soil | 50 g of ballast soil metered in with the formulation |
| | after the pre-rinse, for composition see |
| | below |
| Rinse temperature | 65° C. |
| Water hardness | 21°GH (Ca/Mg):HCO3 (3:1):1.35 |
| Wash cycles | 15; break of 1 h between every two (door closed for |
| | 10 min, door open for 50 min) |
| Evaluation | Visually after 15 wash cycles |

The dishes washed were evaluated after 15 cycles in a darkened chamber with light behind an aperture plate using a grading scale from 10 (very good) to 1 (very poor). Marks of 1-10 were awarded for spotting (very many intense spots=1 to no spots=10) and for scaling (1=very intense film deposits, 10=no film deposits).

Composition of the Ballast Soil:
Starch: 0.5% potato starch, 2.5% gravy
Fat: 10.2% margarine
Protein: 5.1% egg yolk, 5.1% milk
Others: 2.5% tomato ketchup, 2.5% mustard, 0.1% benzoic acid, 71.5% water

Result:

The formulations comprising film of the invention were notable particularly for their very high film-inhibiting effect with respect to inorganic and organic deposits on glass and knives. Furthermore, they increased the cleaning power of the dishwashing composition and promoted the draining of water from the dishes washed, such that particularly clear glasses and shiny metal cutlery items were obtained.

The table below lists the cumulative marks for scale formation (B) and spotting (S) on knives and drinking glasses.

Test results for the dishwashing composition test formulation

| Polymer | Knives (B + S) | Glasses (B + S) |
|---|---|---|
| No film | 10.7 | 9.7 |
| Film from ex. 1d | 15.7 | 15.3 |
| Film from ex. 1e | 14.7 | 14.7 |
| Film from ex. 1f | 16.3 | 14.0 |

1. A multilayer film comprising at least one layer comprising a polymer composition P1) obtainable by free-radical polymerization of a monomer composition M1) comprising at least one monomer A) selected from α,β-ethylenically unsaturated mono- and dicarboxylic acids, salts of α,β-ethylenically unsaturated mono- and dicarboxylic acids, anhydrides of α,β-ethylenically unsaturated mono- and dicarboxylic acids and mixtures thereof, in the presence of at least one polyether component PE) selected from polyetherols having a number-average molecular weight of at least 200 g/mol, mono- and di(C₁-C₆-alkyl) ethers of such polyetherols, surfactants containing polyether groups, and mixtures thereof.

2. The multilayer film according to claim 1 comprising at least one further layer comprising at least one polymer P2) selected from
natural and modified polysaccharides,
homo- and copolymers comprising repeat units which derive from vinyl alcohol, vinyl esters, alkoxylated vinyl alcohols or mixtures thereof,
homo- and copolymers comprising at least one copolymerized monomer selected from N-vinylpyrrolidone, N-vinylcaprolactam, N-vinylimidazole, 2-vinylpyridine, 4-vinylpyridine, salts of the three latter monomers, vinylpyridine N-oxide, N-carboxymethyl-4-vinylpyridium halides and mixtures thereof,
homo- and copolymers of acrylic acid and/or methacrylic acid, and at least one copolymerized maleic monomer selected from maleic acid, maleic anhydride, maleic salts and mixtures thereof,
copolymers comprising at least one copolymerized (meth)acrylic monomer selected from acrylic acid, methacrylic acid, salts thereof and mixtures thereof and at least one copolymerized hydrophobic monomer selected from C₁-C₈-alkyl esters of (meth)acrylic acid, C₂-C₁₀ olefins, styrene and α-methylstyrene,
copolymers comprising at least one copolymerized maleic monomer selected from maleic acid, maleic anhydride, maleic salts and mixtures thereof and at least one copolymerized C₂-C₈ olefin,
homo- and copolymers of acrylamide and/or methacrylamide,
polyamino acids,
water-soluble or water-dispersible polyamides,
polyalkylene glycols, mono- or diethers of polyalkylene glycols, and
mixtures thereof.

3. The multilayer film according to claim 2, wherein the polymer P2) is selected from
cellulose ethers and cellulose esters,
homo- and copolymers comprising repeat units which derive from vinyl alcohol, vinyl esters, alkoxylated vinyl alcohols or mixtures thereof,
polymers selected from polyvinylpyrrolidone homopolymers, polyvinylimidazole homopolymers, copolymers comprising copolymerized vinylpyrrolidone and vinylimidazole, polyvinylpyridine N-oxide, poly-N-carboxymethyl-4-vinylpyridium halides, and
mixtures thereof.

4. The multilayer film according to claim 2, wherein the polymer P2) is selected from cellulose derivatives and mixtures of two or more cellulose derivatives.

5. The multilayer film according to claim 1, wherein the monomer composition M1) comprises, in addition to the at least one monomer A), at least one monomer B) selected from olefinically unsaturated sulfonic acids, salts of olefinically unsaturated sulfonic acids, olefinically unsaturated phosphonic acids, salts of olefinically unsaturated phosphonic acids and mixtures thereof.

6. The multilayer film according to claim 1, wherein the monomer composition M1) additionally comprises at least one comonomer C) selected from
C1) nitrogen heterocycles having a free-radically polymerizable α,β-ethylenically unsaturated double bond,
C2) compounds of general formulae (I.a) and (I.b) 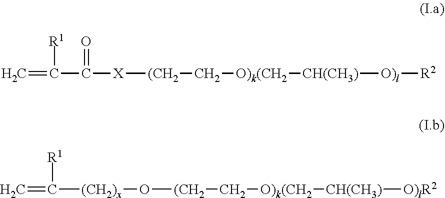
in which
the sequence of the alkylene oxide units is arbitrary,
x is 0, 1 or 2,
k and l are independently an integer from 0 to 100, wherein a sum of k and l is at least 2,
R¹ is hydrogen or C₁-C₈-alkyl,
R² is hydrogen, C₁-C₃₀-alkyl, C₂-C₃₀-alkenyl or C₅-C₈-cycloalkyl, and
X is O or a group of a formula NR³ in which R³ is H, alkyl, alkenyl, cycloalkyl, heterocycloalkyl, aryl or hetaryl;
C3) vinylaromatics,
C4) unsaturated hydrocarbons selected from C₂-C₁₀ monoolefins and nonaromatic hydrocarbons having at least two conjugated double bonds,
C5) esters of α,β-ethylenically unsaturated mono- and dicarboxylic acids with C₁-C₃₀-alkanols,
C6) compounds having one free-radically polymerizable α,β-ethylenically unsaturated double bond and at least one cationogenic and/or cationic group per molecule,
C7) esters of vinyl alcohol or allyl alcohol with C₁-C₃₀-monocarboxylic acids,
C8) esters of α,β-ethylenically unsaturated mono- and dicarboxylic acids with C₂-C₃₀-alkanediols, and amides of α,β-ethylenically unsaturated mono- and dicarboxylic acids with C₂-C₃₀ amino alcohols having a primary or secondary amino group,
C9) monomers containing amide groups other than I.a, C6) and C8);
C10) α,β-ethylenically unsaturated nitriles,
C11) vinyl halides, vinylidene halides,
C12) ethylenically unsaturated monomers having urea groups, and
mixtures of two or more than two of the aforementioned monomers C1) to C12).

7. The multilayer film according to claim 1, wherein the monomer composition M1) comprises acrylic acid and optionally at least one comonomer selected from α,β-ethylenically unsaturated mono- and dicarboxylic acids other than acrylic acid, salts, anhydrides, esters and amides of such α,β-ethylenically unsaturated mono- and dicarboxylic acids other than acrylic acid, olefinically unsaturated sulfonic acids, salts of olefinically unsaturated sulfonic acids, nitrogen heterocycles having a free-radically polymerizable α,β-ethylenically unsaturated double bond, C₂-C₁₀ monoolefins, nonaromatic hydrocarbons having at least two conjugated double bonds, vinyl aromatics, N-vinyllactams and mixtures thereof.

8. The multilayer film according to claim 1, wherein the monomer composition M1) comprises acrylic acid and at least one comonomer selected from isobutene, diisobutene, methacrylic acid, 2-acrylamido-2-methylpropanesulfonic acid, maleic acid, maleic anhydride, itaconic acid, N-vinylpyrrolidone, N-vinylcaprolactam, N-vinylimidazole, styrene and mixtures thereof.

9. The multilayer film according to claim 1, wherein the monomer composition M1), based on a total weight, comprises less than 0.1% by weight of crosslinking monomers having two or more than two free-radically polymerizable α,β-ethylenically unsaturated double bonds per molecule.

10. The multilayer film according to claim 1, wherein the monomer composition M1) does not comprise any crosslinking monomers having two or more than two free-radically polymerizable α,β-ethylenically unsaturated double bonds per molecule.

11. The multilayer film according to claim 1, wherein the monomer composition M1) consists to an extent of at least 80% by weight based on a total weight of the monomer composition M1), of acrylic acid.

12. The multilayer film according to claim 1, wherein the polyether component PE) comprises at least one polyetherol having a number-average molecular weight in a range from about 200 to 100 000 g/mol or a mono- or di-(C₁-C₂-alkyl) ether thereof.

13. The multilayer film according to claim 1, wherein the polyether component PE) comprises at least one polyetherol or one mono- or di-(C1-C2-alkyl) ether thereof incorporating exclusively ethylene oxide units as alkylene oxide units.

14. The multilayer film according to claim 1, wherein the polyether component PE) comprises at least one surfactant containing polyether groups, selected from alkyl polyoxyalkylene ethers, aryl polyoxyalkylene ethers, alkylaryl polyoxyalkylene ethers, alkoxylated animal and/or vegetable fats and/or oils, fatty amine alkoxylates, fatty acid amide alkoxylates, fatty acid diethanolamide alkoxylates, polyoxyethylene sorbitan fatty acid esters, alkyl polyether sulfates, aryl polyether sulfates, alkylaryl polyether sulfates, alkyl polyether sulfonates, aryl polyether sulfonates, alkylaryl polyether sulfonates, alkyl polyether phosphates, aryl polyether phosphates, alkylaryl polyether phosphates, glyceryl ether sulfonates, glyceryl ether sulfates, monoglyceride (ether) sulfates, fatty acid amide ether sulfates, polyoxyalkylene sorbitan fatty acid esters and mixtures thereof.

15. The multilayer film according to claim 1, wherein the polyether component PE) comprises at least one surfactant containing polyether groups, selected from:
alkyl polyoxyalkylene ethers of a general formula (VI)
R¹⁰—O—(CH₂CH₂O)ₓ—(CHR¹¹CH₂O)_{y}—R² (VI)
in which
R¹⁰ is a linear or branched alkyl radical having 8 to 22 carbon atoms,
R¹¹ and R¹² are independently hydrogen or a linear or branched alkyl radical having 1 to 10 carbon atoms, and
x and y are independently 0 to 300, wherein a sum of x and y is >0; and
surfactants which contain hydroxyl groups and are of a general formula (VII)
R¹³—O—(CH₂CH₂O)ₛ—(CH₂CH₂CH₂O)ₜ—(CH₂CH₂CH₂CH₂O)ᵤ—(CH₂CHR¹⁴O)ᵥ—CH₂CH(OH)R¹⁵ (VII)
wherein
the sequence of the alkylene oxide units in the compounds of the formula (VII) is arbitrary,
s, t, u and v are independently an integer from 0 to 500, wherein a sum of s, t, u and v is >0,
R¹³ and R¹⁵ are independently a straight-chain or branched saturated C₁-C₄₀-alkyl radical or a mono- or polyunsaturated C₂-C₄₀-alkenyl radical, and
R¹⁴ is selected from methyl, ethyl, n-propyl, isopropyl and n-butyl;
fatty alcohol polyoxyalkylene esters of a general formula (VIII)
R¹⁶—O—(CH₂CH₂O)ₚ—(CH₂CHR¹⁷O)_{q}—C(═O)R¹⁸ (VIII)
wherein
the sequence of the alkylene oxide units in the compounds of the formula (VIII) is arbitrary,
p and q are independently an integer from 0 to 500, wherein a sum of p and q is >0,
R¹⁶ and R¹⁸ are independently a straight-chain or branched saturated C₁-C₄₀-alkyl radical or a mono- or polyunsaturated C₂-C₄₀-alkenyl radical, and
R¹⁷ is selected from methyl, ethyl, n-propyl, isopropyl and n-butyl.

16. The multilayer film according to claim 1, wherein at least one of the layers comprises at least one additive and/or at least one additive is present between at least two layers.

17. A process for producing a multilayer film as defined in claim 1, in which
a1) a first free-flowing composition capable of film formation is applied to a carrier material to obtain a first layer,
a2) the first layer applied to the carrier material is optionally subjected to an increase in viscosity,
a3) a second free-flowing composition capable of film formation is applied to the first layer obtained in step a1) or in step a2) to obtain a second layer,
a4) the second layer is optionally subjected to an increase in viscosity,
a5) step a3) is optionally repeated with a further composition capable of film formation to obtain a further layer and step a4) is optionally then repeated, it being possible to repeat steps a3) and a4) once or more than once,
a6) the layers applied to the carrier material are optionally subjected to a further increase in viscosity,
a7) the multilayer film obtained is optionally detached from the carrier material,
with the proviso that the free-flowing compositions each comprise a component which is capable of film formation and is independently selected from at least one polymer composition P1), at least one polymer P2) or a mixture thereof, and with the proviso that at least one of the free-flowing compositions and/or the carrier material comprises the polymer composition P1) as defined in claim 1.

18. A method of using a multilayer film as defined in claim 1, the method comprising using the multilayer film
as a washing and cleaning composition,
for at least partial coating or ensheathing of washing and cleaning compositions,
as a dishwashing composition or as a rinse aid,
for at least partial coating or ensheathing of dishwashing compositions or for at least partial coating or ensheathing of rinse aids,
as hygiene products,
for at least partial coating or ensheathing of hygiene products,
as disinfectants,
for at least partial coating or ensheathing of disinfectants,
for at least partial coating or ensheathing of personal care compositions,
for at least partial coating or ensheathing of personal cleansing compositions,
for at least partial coating or ensheathing of cosmetic compositions,
as pharmaceutical compositions,
for at least partial coating or ensheathing of pharmaceutical compositions,
as crop protection compositions,
for at least partial coating or ensheathing of crop protection compositions,
for at least partial coating or ensheathing of bait traps,
as food or animal feed packaging,
as wetting agents,
for at least partial coating or ensheathing of wetting agents,
as packaging for textiles,
as lamination films, or
in composite systems (laminates) such as composite glass.

19. A sheath or coating for a washing composition portion, cleaning composition portion or dishwashing composition portion, comprising a multilayer film as defined in claim 1.

20. A washing or cleaning composition comprising:
A) at least one sheath and/or coating comprising a washing- and cleaning-active multilayer film as defined in claim 1,
B) at least one surfactant,
C) optionally at least one builder,
D) optionally at least one bleach system,
E) optionally at least one further additive, and
F) optionally water.

21. A dishwashing composition comprising:
Ga) at least one sheath and/or coating comprising a multilayer film as defined in claim 1,
Gb) optionally at least one complexing agent,
Gc) at least one builder and/or cobuilder,
Gd) at least one nonionic surfactant,
Ge) optionally at least one component selected from bleaches, bleach activators and bleach catalysts,
Gf) optionally at least one enzyme,
Gg) optionally at least one further additive, and
Gh) optionally water.
